(19) United States
(12) Patent Application Publication
(10) Pub. No.: US 2004/0085443 A1
(43) Pub. Date: May 6, 2004

(54) Method and system for processing regions of interest for objects comprising biological material

(76) Inventors: Olli P Kallioniemi, Turku (FI); Thomas J Pohida, Monrovia, MD (US); John Karareka, Rockville, MD (US); Ghadi Hamdi Salem, College Park, MD (US)

Correspondence Address: KLARQUIST SPARKMAN, LLP, 121 S.W. SALMON STREET, SUITE #1600, ONE WORLD TRADE CENTER, PORTLAND, OR, 97204-2988, US

(21) Appl. No.: 10/450,372

(22) PCT Filed: Jun. 12, 2001
(86) PCT No.: PCT/US01/19176

(30) Foreign Application Priority Data
Dec. 13, 2000 (WO) PCT/US00/34043

(51) Int. Cl. H04N 7/18

(52) U.S. Cl. 348/135; 348/142

(57) ABSTRACT

A method and apparatus are disclosed for processing regions of interest for objects comprising biological material. A region of interest can be denoted for a physical object and information indicating the region of interest can be stored in a computer-readable medium for later retrieval. Subsequently, when the object is retrieved, the information indicating the region of interest can be used to generate information specifying a physical location within the region of interest. An operation can then be performed on the physical location within the region of interest. Reference pints within the object can assist in regeneration of the region of interest, and the reference points can be arranged in such a fashion that processing can take rotation of the object into account. The invention includes various features advantageous for constructing tissue microarrays.

### RELATED APPLICATION DATA

This application claims priority from PCT Patent Application No. US00/34043, entitled “METHOD AND APPARATUS FOR CONSTRUCTING TISSUE MICROARRAYS,” filed Dec. 13, 2000, which claims priority from U.S. Provisional Patent Application No. 60/170,461, entitled “HIGH-THROUGHPUT, AUTOMATED TISSUE MICROARRAYS CONSTRUCTION, AND DIGITAL IMAGE ANALYSIS,” filed Dec. 13, 1999, and U.S. Provisional Patent Application No. 60/171,262, entitled “METHODS OF MAKING AND USING TISSUE MICROARRAYS,” filed Dec. 15, 1999, all of which are hereby incorporated herein by reference.

### TECHNICAL FIELD

The invention generally relates to the fields of computer software and automated processing of physical objects comprising biological material.

### BACKGROUND

Automated retrieval of objects has become commonplace in the field of manufacturing. For example, in the field of automated assembly, computers can direct robotic equipment to retrieve components and appropriately place them on a printed circuit board, resulting in automated assembly lines.

### SUMMARY OF THE DISCLOSURE

The techniques available in the field of manufacturing, however, fall short when applied to certain applications. For example, what is still lacking is a way to denote one or more regions of interest for an object so an operation can be performed on a physical location within the region of interest when the object is later retrieved. Other limitations of the prior art prevent efficient processing of regions of interest.

The shortcomings of available techniques are especially relevant in the field of tissue microarrays. Tissue microarrays can be constructed by taking biological tissue from blocks (called “donor blocks”) and placing the tissue into another block (called a “recipient block”). The process of constructing the recipient block can include retrieving the donor blocks, removing (i.e., punching) tissue from the donor blocks, and placing the tissue into a recipient block. In this way, a single recipient block may contain tissue from numerous donor blocks. Analyses performed on the recipient block or slices of the block can thus efficiently provide results for many tissue sources.

However, the techniques available in the field of automated assembly fail to provide a way to efficiently process donor and recipient blocks. Therefore, there is a need for new techniques.

A method and apparatus are disclosed for processing regions of interest for retrievable physical objects. In one embodiment, information about denoted regions of interest for a physical object is stored. For example, the location and extent of a region of interest can be stored by indicating the region's perimeter. When the physical object is subsequently retrieved, the stored information can be retrieved and an operation can be performed on a physical location within the region of interest.

The techniques described herein are particularly useful when automating tissue microarray construction. For example, a block of tissue might contain various types of tissue. Some of the tissue types might be desired for inclusion in a recipient block, and other tissue types (or non-tissue areas in the block) might not be. Information about the regions of interest, including their locations on the block can be stored in a database. The database can include information for a large number of blocks.

Automation of tissue microarray construction can then be achieved by submitting a list of desired tissue characteristics to an automated system, which produces a list of candidate regions of interest found on the blocks, retrieves each of the desired tissue blocks, removes tissue from within the desired regions of interest, and places the tissue in a recipient block.

An advantage of the described arrangements is that a region of interest can be denoted for an object, and the location and extent of the region can be subsequently regenerated while avoiding operator intervention to redefine the region of interest. A computer system can consult stored information to regenerate the region automatically or assist in regenerating it.

The regions of interest can be indicated with respect to reference points placed on the objects so that information indicating the regions of interest is independent of rotation of an object. A region of interest can then be reliably regenerated even if the object is rotated. In some arrangements, reference bars can be placed in a block object. As a result, when the block is sliced, the bars' ends serve as corresponding reference points both on the slice and the block.

In some cases, a slice is easier to observe and manipulate, so the region of interest can be indicated for the slice. Because the block object's reference points will appear in corresponding locations on the slice, the information indicating the region of interest for the slice can then be used to regenerate the region of interest for the block object.

It may be that one of the reference points is unavailable. In one feature of the invention, other related information can be used to regenerate the regions of interest even if a point is unavailable. Further, the reference points can be arranged so that the identity of the reference point can be determined, even if the object is rotated from its original orientation. Again, even if a reference point is missing, processing can continue because the identity of the reference points can be determined due to their placement.

Still further, system reference points at known locations can be provided when retrieving an object to provide additional scaling and known position information. The physical object can be placed adjacent to the system reference points, and an image can be captured of the physical object and the system reference points.

In some embodiments, information about distances between reference points can be used to determine various kinds of scaling information. Certain scaling information is useful when presenting a regenerated region superimposed on image because the image may be of a different scale than that used when the region of interest was denoted. Other scaling information can be used to compute the area of regions of interest.

Information about the objects can be stored in a database to assist in automated object processing. For example, the type of material in a region of interest can be kept in the database. Then, a list of desired material types can be constructed. Based on queries to the database, a collection of material types from the objects can be assembled into a composite object via automated means.

The information for the regions of interest can be stored in a system-independent format. Accordingly, one type of system can be used to store the information about the regions of interest, and a different type of system can be used when performing an operation for the regions of interest.

Particular embodiments of the technology as applied to the field of tissue microarrays are described. For example, the location and extent of a region of interest can be denoted for a tissue block. Subsequently, the block can be retrieved, the location and extent of the region of interest reconstructed, and tissue extracted therefrom.

Such an arrangement is particularly useful because a highly-skilled person such as a pathologist can denote the region of interest. The information indicating the region of interest is then stored. Subsequently, when the block is retrieved, the expertise of the pathologist is no longer required because an automated system can reconstruct the region of interest without aid from the pathologist. Thus, tissue microarrays can be constructed via the stored information without need for further participation by a pathologist. The pathologist might denote a block of tissue once, but the block can be used in numerous sessions to construct many microarrays.

Various other aspects of tissue microarray construction can be automated to provide greater throughput and flexibility. For example, characteristics can be denoted for regions of interest, so software can select appropriate regions of interest based on supplied criteria for a recipient block. Information for the block can be updated to indicate removed tissue is no longer available in the block. The software will thus reflect that the tissue has been removed in subsequent requests for tissue. For example, the database can be updated to reflect the amount and location of remaining material.

Other information about a tissue block can be stored to assist in selecting an appropriate region of interest. For example, a particular feature might be indicated at a location on a tissue block, and criteria for tissue selection might include that tissue be at least a certain distance from the feature.

The scaling information mentioned above can be helpful in the tissue block context because the scaling information can be used to assist in selection and implementation of tissue punch size and punch spacing.

As is apparent from the foregoing, the present invention includes many different advantages and permutations. The foregoing and other features and advantages of the invention will become more apparent from the following detailed description of disclosed embodiments which proceeds with respect to the accompanying drawings.

### BRIEF DESCRIPTION OF THE FIGURES

FIG. 1A is a view of a retrievable physical object.

FIG. 1B is a view of a retrievable physical object and related generated object information.

FIG. 2 is a view of a retrievable physical object and related object information used to regenerate a region of interest for the retrievable object.

FIG. 3 is a flowchart showing a method of generating region of interest information for a retrievable physical object.

FIG. 4 is a flowchart showing a method that includes performing an operation for a regenerated region of interest for a retrievable physical object.

FIG. 5 is a view of a physical object including a set of reference points on the object.

FIG. 6 is a view of a physical object including a set of reference points on the object arranged in a way to facilitate determining identity of the reference points if the object is rotated or inverted.

FIG. 7 is a flowchart showing a method for generating information describing a region of interest for a physical object.

FIG. 8 is a block diagram of a system for generating information describing a region of interest for a physical object.

FIG. 9 is a block diagram of an alternative system for generating information describing a region of interest for a physical object

FIG. 10 is a diagram illustrating a possible technique for describing a region of interest.

FIG. 11 is a table showing a database for storing information describing a region of interest.

FIG. 12 is a table showing a database for storing scaling information related to a physical object.

FIG. 13 is a flowchart showing a method for determining information indicating a physical location within a region of interest.

FIG. 14 is a flowchart showing a method for regenerating a region of interest for a physical object.

FIG. 15 is a block diagram showing a system for regenerating a region of interest for a physical object. The illustrated system can also perform an operation on the regenerated region of interest.

FIG. 16 is a block diagram showing a technique for regenerating a perimeter point using geometry.

FIG. 17 is a block diagram showing a technique for regenerating a perimeter for a region of interest via a series of points.

FIG. 18 is a block diagram showing a technique for determining and applying a translation.

FIG. 19 is a flowchart showing a method for performing an operation for a region of interest of a physical object.

FIG. 20 is a view of a physical object into which reference bars have been placed.

FIG. 21 is a view of slices taken from a physical object into which reference bars have been placed.

FIG. 22 is a flowchart of a method for processing physical objects.

FIG. 23 is a flowchart of a method for generating information indicating a region of interest for an object.

FIG. 24 is a flowchart of a method for performing an operation on a location within a region of interest for an object.

FIG. 25 is a flowchart of a method for automating processing of a set of regions of interest for objects.

FIG. 26 is a top view of two donor blocks, with a tissue specimen in each donor block, and showing locations from which tissue samples are punched from each of the tissue specimens.

FIG. 27 is a schematic view illustrating that multiple tissue samples are obtained from multiple tissue specimens (such as different tumors), and the samples from the different specimens are inserted into a recipient block in a three dimensional array. The array block is subsequently sectioned to produce multiple similar sections having samples from a particular specimen at a corresponding assigned location in all the array sections (as shown by the sample with diagonal hatch marks from the specimen of FIG. 26 in FIG. 27). Bach of the sections may subsequently be subjected to the same or a different bioanalysis.

FIG. 28 is a schematic view illustrating a particular example in which a set of 1000 tissues (such as tumors) are sampled to a set of tissue microarray blocks. Each original tumor (measuring 15×15 mm) can be punched 324 times to produce 324 different recipient tissue microarray blocks. Each of the 324 recipient array blocks contains one specimen from all 1000 tumors. The tissue microarray block can be cut into 300 replicate sections. Since there are 324 of these replicate blocks, one can obtain up to 97,200 replicate sections, each of which contains 1000 different tumor samples, and each of the sections can be subjected to a different bioanalysis.

FIG. 29 illustrates digital images of tissue microarrays that can be stored in databases. On the left is one tissue microarray cross-section stained with one antibody. On the right are multiple images from one tumor arrayed in a single tissue microarray. The consecutive sections of this microarray have been serially analyzed with different antibodies and images of this one tumor at different sections (different stains) are depicted.

FIGS. 30A, 30B, 30C, and 30D are schematic views illustrating an example of parallel analysis of arrays obtained by the method of the present invention.

FIG. 31 is an enlarged view of a portion of FIG. 30.

FIG. 32 is a top schematic view of a system for automated, high-speed fabrication of tissue microarrays in accordance with one embodiment of the present invention.

FIG. 33 is a perspective view of a portion of the system shown in FIG. 32, showing a storage station for tissue blocks.

FIG. 34 is a perspective view of a portion of the system shown in FIG. 32.

FIGS. 35A, 35B, and 35C are top, perspective and side views of a tissue donor block in a carrier, which also illustrates a computer readable bar code label on the carrier.

FIG. 36 is an enlarged front view of the storage station of FIG. 38, illustrating the carriers inserted in the storage station.

FIG. 37 is an enlarged, fragmentary side view of the carrier held by a transporter.

FIG. 38 is a schematic illustration of a subsystem for locating and marking donor blocks.

FIG. 39 is a schematic illustration of a digital camera and bar code marking device.

FIG. 40 is a schematic view of a system processor for an image processor subsystem.

FIGS. 41, 42, 43, 44, and 45 illustrate steps in the preparation of multiple tissue microarrays from the recipient block.

FIG. 46 is a schematic diagram of a computer system in which the method of the present invention can be implemented.

FIGS. 47A and 47B are schematic illustrations of the ability of the present invention to provide an entire pathology archive in a tissue microarray format that is readily available for molecular analyses.

FIGS. 48A and 48B schematically illustrate how the arrays can provide a comprehensive analysis of a molecular marker in a group of tissue specimens (such as different tumors) at the population level, instead of at the level of an individual tumor specimen.

FIG. 49 is a drawing which schematically illustrates use of the arrays as controls, for example in which the array contains normal tissues, positive controls, fixation controls, or tumors with known clinical outcomes. The inclusion of such controls in multiple different arrays that are constructed allows better comparison of results obtained at different time-points, for example by different investigators or centers.

FIG. 50 is a drawing which schematically illustrates the use of the arrays as quality control devices, in which different array sections are subjected to different procedures (for example by a different manufacturer) for subsequent comparison by other users of the procedure. This allows a determination as to whether different results obtained in the different centers are influenced by the reagents they use.

FIG. 51 is a drawing which schematically illustrates how the arrays can be used to improve quality control and enhance the pace of biological discovery by obtaining tissue specimens from multiple different researchers or centers, and combining the different specimens into a single array for simultaneous bioanalysis under substantially uniform conditions. This allows comparison of whether specimens from different centers produce identical results (different results may arise, e.g., from fixation differences).

FIG. 52 is a drawing which schematically illustrates how staining variability can be tested by having consecutive, essentially identical, sections of a single tissue microarray subjected to the same bioanalysis at different research centers. Variations in the stain (such as an IHC stain) can then be assigned to be dependent on the application of the bioanalysis or interpretation of the bioanalysis at these different centers.

FIG. 53 is a drawing which schematically illustrates that a tissue microarray which is prepared, sectioned, and stained at a single location, can be disseminated to multiple observers, so that observer interpretations are based on a single substantially uniform array. This enables one to test how much variability there is in the interpretation of the same staining results by different observers. This also indicates how different, essentially identical sections could be used to train users to interpret tissue microarray slides.

FIG. 54A is a drawing which schematically illustrates reference points embedded in a tissue donor block, and FIG. 54B illustrates the use of those reference points in finding a region of interest in a tissue sample.

FIG. 55 is a screen shot of a user interface presented to an operator for identifying reference points on a donor tissue block.

FIG. 56 is a screen shot of a user interface presented to an operator for tracing a region of interest on a donor tissue block.

FIG. 57 is a screen shot of a user interface presented to an operator for manipulating information about a tissue block.

FIG. 58 is a screen shot of a user interface presented to an operator for manipulating information about regions of interest for a tissue block.

FIG. 59 is a screen shot of a user interface presented to an operator for processing a query for locating regions of interest.

FIG. 60 is a flowchart showing a method for an error correction technique.

### DETAILED DESCRIPTION OF SEVERAL ILLUSTRATIVE EMBODIMENTS

### EXAMPLE 1

### Overview of Various Features

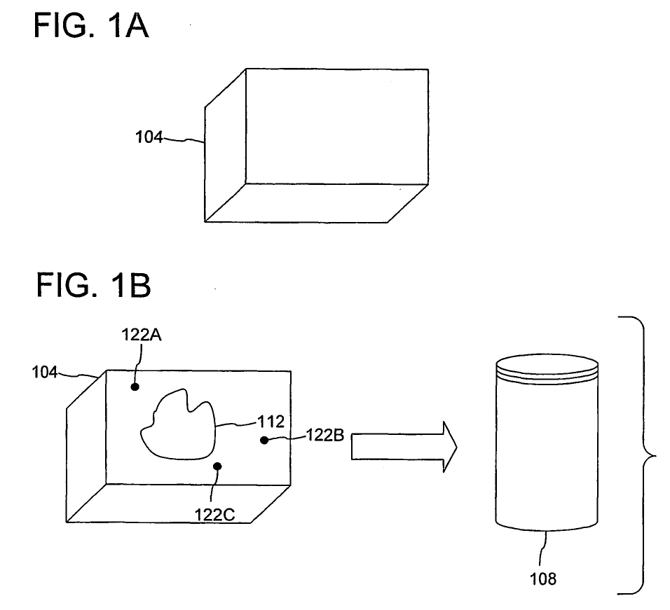

FIG. 1A shows an exemplary retrievable physical object 104. Typically the object 104 is retrievable in that it can be handled by a robotic mechanism or other automated object retriever, but manual retrieval is also possible. Although a rectangular block is shown, the physical object 104 may take other forms, such as another polygonal or polyhedral shape, a circular or cylindrical shape, or an irregular shape. In the examples described below, the physical block comprises biological material, such as biological tissue.

FIG. 1B shows the exemplary retrievable physical object 104 and related object information 108 indicating various characteristics of the retrievable physical object 104. Typically, the information 108 is generated via a computer system and stored in a computer-readable medium.

Although the object 104 is shown as featureless, it may have various features in or on it. For example, a portion of the object 104 may contain a removable resource, such as biological material. Thus, it may be desirable to indicate the presence of one or more regions of interest within or on the physical object 104. FIG. 1B shows one such region of interest as the region of interest 112. In the examples describe below, the region of interest typically comprises biological material. In some cases, a region of interest is indicated via a physical object representative of the physical object, such as a slice of the physical object.

The location and extent of the region of interest 112 may or may not be physically indicated on the physical object 104 or the physical object representative of the physical object. For example, in some cases, a perimeter of the region of interest 112 may be indicated by physically marking the physical object 104. In other cases, the location and extent of the region of interest may be indicated by the information 108; in such a case, a physical outline of the region 112 need not appear on the physical object 104.

To facilitate regenerating the location and extent of the region of interest 112, the object can include various reference points 122A, 122B, and 122C. In the example, the reference points 122A, 122B, and 122C are physically present in the physical object 104 and can be placed or implemented in a variety of ways. For example, a visible marker can be applied to the surface of the object 104, or some other perceptible (e.g., magnetic, radioactive, or the like) mechanism can be used. In the case of an object 104 having depth, bars of a material may be placed in the object, the ends of the bars appearing as the reference points 122. A slice can be removed from the object 104, and the ends of the bars serve as corresponding reference points in the slice and the remaining portion of the object. In some cases, the reference points are placed at known distances (e.g., in millimeters) apart to facilitate calibration functions.

In addition to information indicating the presence of one or more regions of interest, the object information 108 can contain a variety of other information. For example, distances between the reference points 122 can be stored. The object information 108 may also include information about the physical object 104 itself, such as cataloging or other identifying data (e.g., the source or origin of the object).

The information indicating the presence of the region of interest 112 can be stored in a system-independent format so that the location and extent of a region of interest can be regenerated on a system different from the system that stored the information. For example, the location and extent of the region of interest 112 can be indicated with respect to the reference points 122, which may be available for inspection when the object is later retrieved on a different system.

An automated system can process the object 112 to generate appropriate associated object information 108. In some cases, a computer system can generate information automatically, avoiding operator involvement; other cases may involve operator intervention (e.g., by observing an image of the object 104 and denoting the location and extent of the region of interest 112).

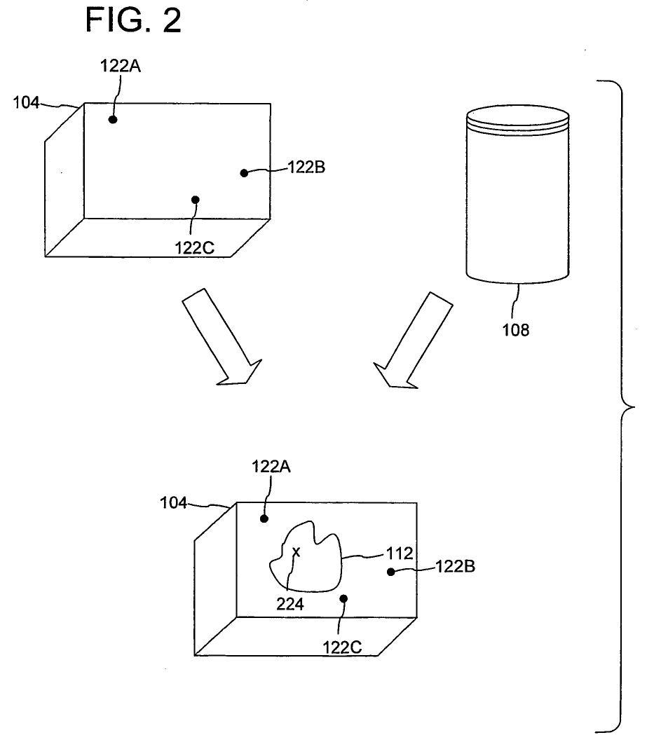

FIG. 2 shows that a retrievable object 104 and related object information 108 (e.g., including information indicating the presence of a region of interest) can be used in conjunction to regenerate the location and extent of a region of interest 112 for the retrievable object. The extent of the region of interest 112 can include one or more perimeters, and regions within the region can be designated as to be excluded. Other information, such as scaling and known location information can be used to determine the location of the region of interest 112 and perform an operation for it.

For example, based at least in part on the object information 108, information specifying a physical location 224 within the extent of a region of interest 112 can be determined. With the information specifying the physical location 224, an operation can be performed on the physical location 224. Example operations include sampling, measuring, or extracting material within the region of interest.

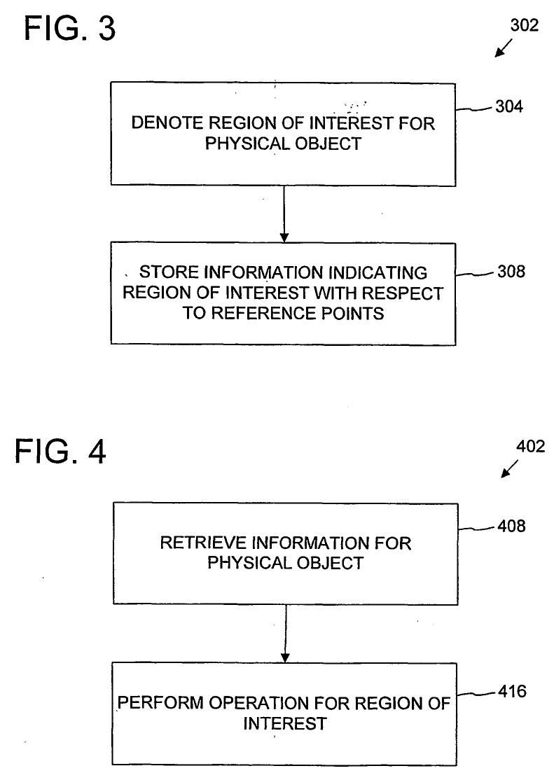

FIG. 3 shows a flowchart for a method 302 of generating information indicating a region of interest for a retrievable physical object, such as the physical object 104 shown in FIG. 1. At 304, the location and extent of a region of interest is denoted for the physical object. Such denotation can be performed by reading an outline (i.e., perimeter) of a region of interest physically indicated on the block (e.g., by pen markings) or by providing a user interface by which an operator can indicate a region of interest on an image depicting the block (e.g., by tracing a perimeter with a mouse pointer or selecting polygons), whether or not a region of interest is physically indicated on the block. Typically, the image depicts at least one of the reference points, and the location of the reference points on the image can be used to generate the information indicating the region of interest with respect to the reference points.

At 308, the information indicating the region of interest can then be stored with respect to reference points on the physical object (e.g., reference points 122 shown in FIG. 1). Instead of reference points, another mechanism could be used. For example, the edges or vertices of the object could be used for reference. Any distinguishable feature can be used for reference. In some cases, an actual feature is unnecessary, as the corners of an image depicting the object can be used as reference if the location of the camera capturing the image remains fixed or varies in some known way.

FIG. 4 shows a method 402 that includes performing an operation for a region of interest for a retrievable object, such as the physical object 104 shown in FIG. 1. The method 402 can use information generated via the method 302 of FIG. 3.

At 408, information for an object is retrieved. For example, information indicating the location and extent of one or more regions of interest for the physical object can be retrieved from a database.

Then, at 416, an operation can be performed on a physical location within the region of interest. For example, material can be extracted from the region of interest. To perform the operation, information specifying a physical location within the region of interest can be determined. For example, for a particular location chosen with respect to a perimeter of the region of interest, an appropriate translation mechanism can be determined and applied to generate information for sending to a controller to position an automated positioning device appropriate for performing the operation at the physical location corresponding to the chosen location. The information specifying a physical location can be determined at least in part based on the information specifying the location and extent of the region of interest.

### EXAMPLE 2

### Physical Object

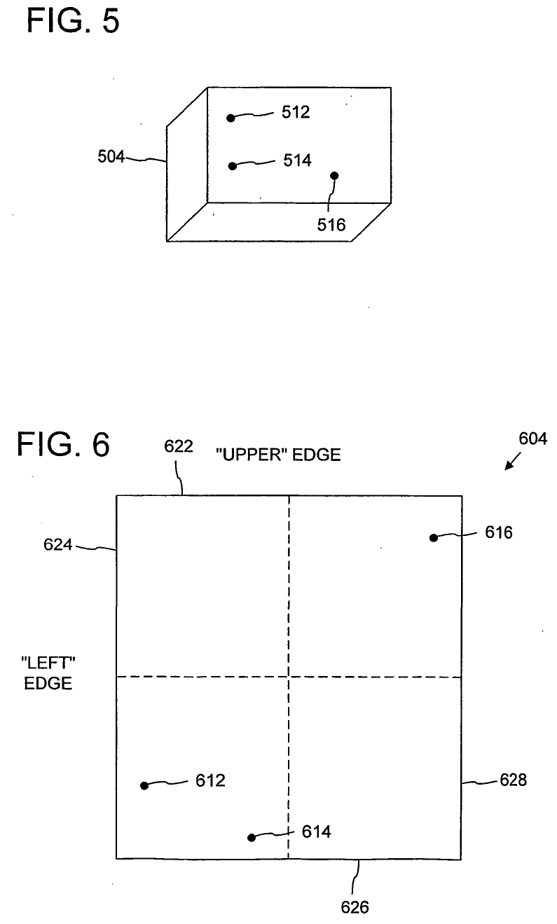

FIG. 5 shows a physical object 504 including a set of reference points 512, 514, and 516 on the object. In the example, the reference points can be identified because they are of different colors (e.g., red, green, and blue). However, a variety of other techniques can be used. For example, different shapes or sizes can be used. The advantage of such an arrangement is that the identity of the reference points can be determined if the object is rotated or a mirror image or some other distortion of the physical object is obtained. For convenience, a representation of the reference points stored in a computer-readable medium might indicate an identifier (e.g., “2”).

FIG. 6 shows a physical object 604 including a set of reference points 612, 614, and 616 on the object are placed at locations with respect to the edges to facilitate determining identity of the reference points. In the example, the physical object 604 is rectangular in shape and thus has 4 edges. For the sake of convenience, these edges can be referred to as the “top” edge 622, the “left” edge 624, the “bottom” edge 626, and the “right” edge 628. One set of rules that can be followed to assist in properly identifying the reference points is shown in Table 1 below. Although the example shows the points placed at locations with respect to the object's edges, other arrangements could be used. For example, the sides of a rectangle drawn around features (e.g., tissue) appearing on the object could be used instead of edges of the object.

It is possible that the object will be subsequently presented in an orientation rotated or inverted (e.g., flipped over) from the original orientation; therefore, designations such as “left” or “upper” can be used to describe the reference points with respect to the original orientation of the object (e.g., when the region of interest is denoted). In the example, the “left” and “right” edges are the longer edges of the rectangle defining the perimeter of the object 604.

TABLE 1
Placement of Reference Points

| Point | Placement |
|---|---|
| Point “1” | A. Closer to “left” edge than any other edge |
| | B. Closer to “bottom” than “top” |
| | C. To the “left” of points 2 and 3 |
| Point “2” | A. Closer to “bottom” edge than any other edge |
| | B. “Below” both other points |
| Point “3” | A. Closer to “upper” edge than “bottom” |
| | B. Closer to “right” edge than “left” |
| | C. To the “right” of both other points |
| | D. Distance to “upper” edge is shorter than point 1's distance |
| | to “lower” edge |
| | E. Distance to “upper” edge is greater than point 2's distance |
| | to “bottom” edge |

If the reference points are arranged in such a manner, the identity of the reference points (e.g., which of the reference points on the object is point “1”) can be conclusively determined, even if the object becomes rotated or flipped. For example, given only an image of the object and knowledge that the reference points were arranged via such a manner, it can be determined which reference point on the image is point “1.” Of course, if the object has been rotated, the “left” edge may no longer be on the left side of the image.

In some instances, it may be possible to determine the identity of the reference points even if a reference point is lost. For example, it can happen that only two of three reference points remain on the object. The above scheme allows such identification of the remaining reference points.

There are many other possible techniques for designating reference points. For example, a different number of reference points could be used (e.g., for economy or redundancy), or the edges or vertices of an object might be used for reference points or as other reference. Finally, in addition to the reference points above, others may be included simply for the purpose of scaling information. For example, a set of two reference points may be placed in the object so that they are a known (and stored) distance apart, or system reference points outside the object may be placed at a known distance apart.

### EXAMPLE 3

### Region of Interest

Although some examples show a single region of interest for an object, there may be one or more regions of interest on an object. Information indicating the location and extent of a region of interest can be stored in computer-readable media for retrieval at a later time. The regions of interest can take a variety of shapes and sizes. In addition, it may be advantageous to define certain regions inside a region of interest as not being part of the region of interest.

In some cases, the region of interest may contain a removable resource. In such a scenario it may be advantageous to track removal of the resource to determine how much, if any, of the resource remains for a set of regions, a region, a set of objects, or an object. Such an arrangement can be accomplished by maintaining a database identifying the regions, the objects, and the amount of resource remaining. When a resource is removed, the database can be updated to so reflect.

### EXAMPLE 4

### Generating Information Indicating a Region of Interest

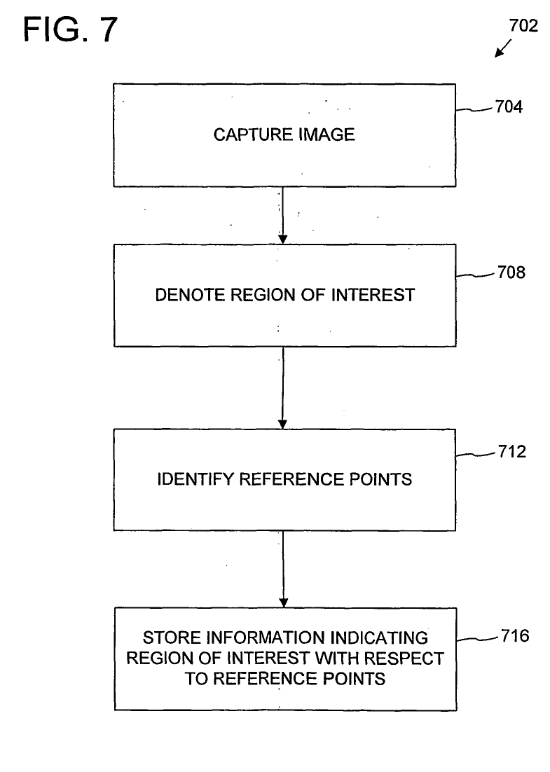

FIG. 7 shows an exemplary method 702 for generating information indicating the location and extent of a region of interest for a physical object. In the example, the information is indicated with respect to reference points of the object. At 704, an image representative of the physical object is captured. At 708, a region of interest for the physical object is denoted. As described in more detail below, such denotation can be achieved by physically marking the physical object, but physical marking is not required. Also, such denotation can be achieved by tracing a region of interest on an image representing the physical object, whether or not the object has been physically marked. At 712, reference points for the physical object are found. Given the reference points and the denoted region of interest for the image representing the physical object, a computer system can store information indicating the location and extent of the region of interest with respect to the reference points at 716.

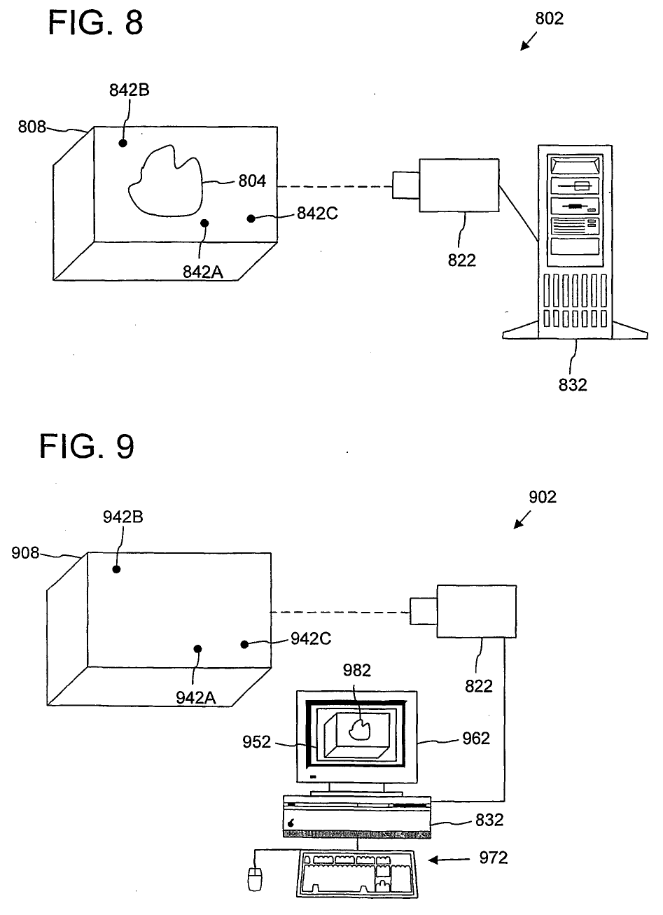

FIG. 8 shows a system 802 for generating information indicating a region of interest 804 that has been physically outlined by marking (e.g., with a pen) on a physical object 808. In some cases, a physical object representative of the physical object 808 (e.g., a slice of the physical object 808) can be used.

The system 802 includes an image capturing device 822 that captures an image of the physical object 808 and sends it to a computer system 832. The image capturing device can take many forms, including commercially-available CCD cameras. In one embodiment, a Professional PVC 100C camera from Pixera Corporation of Los Gatos, Calif. is used as the image capturing device 822. The PVC 100C camera can produce an image having 1280×1024 resolution. Some cameras, lenses, or other optics support variable magnification (e.g., up to 10×), which can be supported by the system. In some cases, a different device might be used, such as a scanner or other image capturing device.

The computer system 832 can be any of a variety of systems, including commercially-available systems that support any of a variety of computer-readable media (e.g., RAM, a hard disk, a computer-readable CD, and the like) for storing information. Typically, capture software is supplied with the camera 822, but other software can be used. After the image is captured by the camera 822, the computer system 832 can analyze the image to determine the location and extent of the region of interest 804 (e.g., by locating the pen markings) and identify the reference points 842a, 842b, and 842c. Instead of automatically locating the pen markings, the software can accept input from an operator who traces the pen markings as appearing on the image using an arrangement similar to that described below with reference to FIG. 9.

In an alternative arrangement 902 shown in FIG. 9, the system additionally includes a user interface 952 shown on a display 962 interfaced to the computer system 832. An operator of the computer system 832 can manipulate the input devices 972 (e.g., a mouse, mouse tablet, touchscreen, or trackball) to provide operator input. The computer system 832 can thus accept input to trace a region of interest marked on a physical object, accept input to indicate a region of interest not marked, accept input identifying or finding reference points, or some combination thereof.

For example, an image of a physical object 908 (e.g., having reference points 942A, 942B, and 942C) can be portrayed on the user interface 952, and the operator can select from various shapes (e.g., polygons) or trace a representation 982 of a region of interest on the image by dragging a mouse pointer around the area or by using a mouse tablet. The representation 982 of the region of interest can be stored (e.g., as a set of pixel or image locations) and processed as described in more detail below. For example, the representation 982 of the region of interest can be stored with respect to the reference points.

Although not shown in the example, reference points typically appear on the user interface 952. Also, the object 908 is shown as featureless. In practice, the object may have various visible features that a trained operator can identify when determining how to denote the region of interest.

Additionally, the computer system 832 can present a proposed processing of the region(s) of interest and reference points shown on the image captured by the camera 822, which the operator can confirm or modify. Such an arrangement is useful if the computer system 832 is able to identify candidate regions of interest based on the image (e.g., based on the color, density, shape, or some other characteristic).

Various techniques can be used to identify the reference points so they can be distinguished. For example, different colors or shapes can be used, or placement of the reference points (e.g., according to a particular arrangement scheme) might denote identifiers for the points as reference points “A,” “B,” and “C,” or the like.

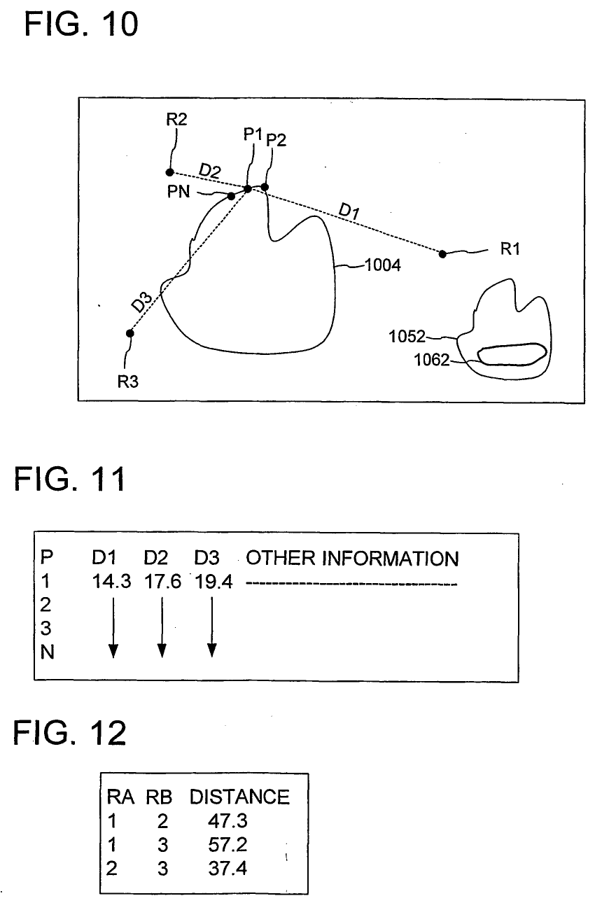

Given the reference points and the region of interest or a representation of the region of interest, the computer system 832 (or a different computer system) can generate information indicating the region of interest so the location and extent of the region of interest can be subsequently regenerated. FIG. 10 illustrates a possible technique for indicating the region of interest. In the example, the region of interest and reference points appear in a captured image.

FIG. 10 shows a perimeter of a region of interest 1004, which is indicated by specifying a plurality of perimeter points for the region. In the example, three reference points, R₁, R₂, and R₃ have been identified. The level of resolution employed to describe the region of interest 1004 can vary depending on the implementation of the technology. In some cases, it may be advantageous to employ single pixel resolution; thus, pixels in an image are perimeter points. In other cases, every nth pixel point can be chosen.

The location of a perimeter point (e.g., P₁) with respect to the reference points can be described as a set of distances (e.g., D₁, D₂, and D₃) from the reference points. Therefore, to describe the location and extent of the region of interest 1004 according to the example, the computer system performs the following for the perimeter points in the region of interest 1004: the software calculates the distances between the point and the reference points and stores the distances in a computer-readable medium so the information can be retrieved later and be used to reconstruct the location and extent of the region of interest 1004.

A similar technique can be used to describe additional regions of interest, such as 1052. The technique can also be used to describe regions inside a region of interest that are designated as not part of the region of interest (e.g., the excluded region 1062).

If a reference point somehow becomes lost (e.g., only two remain), the remaining information may be ambiguous. Accordingly, additional information can be used to further describe the points. For example, sides of an image can be designated as “top,” “left,” “right,” and “bottom.” In addition to the distance information, the computer system can, for example, determine whether the point is “above” a reference point or appears on the “top” part of the image. The information can be saved to improve robustness of a process that regenerates the region of interest if a reference point becomes lost or missing.

For instance, to facilitate such a technique for three reference points, the location of the perimeter point can be specified with respect to a line intersecting sets of two of the reference points. For example, the information can indicate whether the perimeter point is above or below the line intersecting reference points R₁ and R₂; whether the perimeter point is above or below the line intersecting the reference points R₁ and R₃; and whether the perimeter point is above or below the line intersecting the reference points R₂ and R₃. If the three reference points are found, the additional information is unnecessary, but the additional information can be used to resolve ambiguity if a reference point becomes lost or missing.

Alternatively, the reference points can be placed at uniform locations with respect to the region of interest (e.g., on “top” of the region of interest). Such an arrangement ensures that the perimeter points can be assumed to be “above” a reference point.

FIG. 11 shows a possible arrangement for storing the information describing a region of interest. For each of the perimeter points, P (i.e., P₁-Pₙ), the distances (e.g., D₁-Dₙ) to each of the reference points is stored in a database. The distances can be physical distances or image (e.g., pixel) distances. As described above, additional information can be stored (e.g., whether the perimeter point is above a line intersecting two reference points).

To facilitate scaling the region of interest, various other information can be stored to describe the region of interest. For example, physical distances between the reference points on the object may be known because they have been measured or otherwise determined. Such information can be stored as scaling information for a variety of purposes. Alternatively, pixel distances can be stored. Later, when the object is retrieved, the pixel distances can be scaled to physical distances.

FIG. 12 shows one way scaling information can be stored. For each of the distances, a distance (e.g., in millimeters) is stored. In the first line of the table, the distance between reference point R₁ and reference point R₂ is shown as 47.3 mm. Subsequently, if an image of the physical object is captured on a different system, the scale may be different. Using the physical distances, it is possible to determine how to scale the region of interest for the image. Alternatively, the distances can be stored in terms of pixels or other image units, and a pixel scale (e.g., equivalent physical size of a pixel or distance between pixels) can be stored as well.

Alternatively, additional, separate reference points can be used for scaling information. For example, two reference points can be placed a known distance apart and be specially designated by color, location, or the like.

An advantage of having the physical distances is that the software can then determine an area of the region of interest. Such information can be particularly useful, for example, when the region of interest contains an expendable or removable resource. Calculating the area of the region enables tracking an amount of available resource; the tracked amount can be updated if a portion of the resource is removed from the region.

Scaling information is also useful in that it can be used to reconstruct the proper size of the region when subsequently presenting or analyzing it. For example, another image might be captured to subsequently process the object, and the region of interest can be superimposed on the image for presentation.

However, the subsequent image might be of a different scale than the image used when the region of interest was denoted. In such a case, the units used to measure the distances need not necessarily be known to appropriately scale the region of interest. For example, if two reference points are n units apart when a region of interest is denoted and subsequently appear 2n units apart, the region of interest can be scaled appropriately (e.g., expanded by a factor of 2). Such scaling can be done regardless of whether the size of the units are known. For example, pixel distances can be used.

Additional information relating to the regions of interest can be specified. For example, a resource type, characteristics, or instructions can be stored as an annotation for a region of interest. Further, information identifying the physical object can be stored as well. For example, a database can indicate the source of the physical object, the date the information was stored, and when the physical object has been accessed. Alternatively, the information can be stored in a standalone file or via a variety of other techniques.

### EXAMPLE 5

### Determining Information Indicating a Physical Location within a Region of Interest

After retrieving information indicating one or more regions of interest for a physical object, it may be desirable to determine information indicating a physical location within one of the regions of interest. Using such information, an operation can then be performed on the physical location within the region of interest.

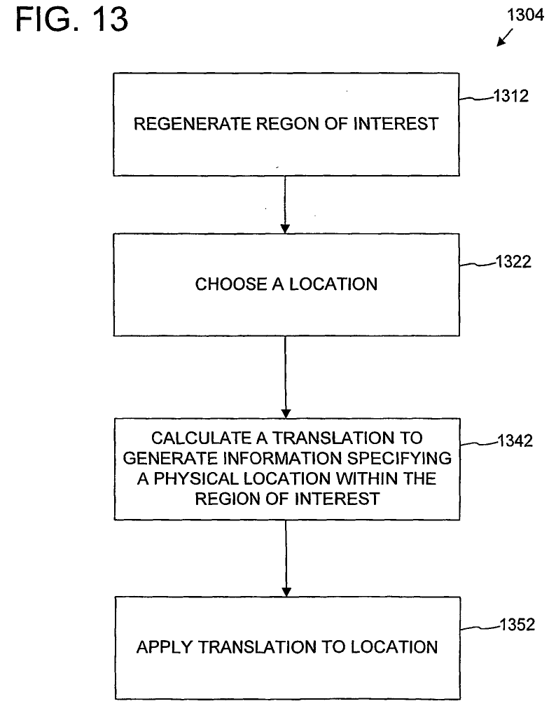

A wide variety of methods are possible for determining such information. FIG. 13 shows one such method 1304. At 1312, the region of interest is regenerated. Regeneration can re-establish the location and extent for the region of interest. Regeneration can be done as described in further detail below.

At 1322, a location within the region of interest is chosen. Such a location can be chosen automatically by the computer based on a variety of schemes, or an operator can select a location in a variety of ways. For example, the operator might select a location shown on a captured image of the object, choose from a list of candidate locations shown on a capture image, or choose from a list of candidate locations depicted in text form.

At 1342, a translation is calculated. The translation can generate information specifying a physical location within the region of interest. Such a translation typically takes the form of a set of values that account for scaling, dislocation, and rotation of coordinate systems. For example, a translation can be calculated to translate the position of a pixel on a captured image to a point that can be sent to a controller to position an automated device at a particular physical location or at a location appropriate for performing an operation on the physical location. Sometimes such a point is called an “absolute” location because it can unambiguously specify a physical location for the system.

In effect, the location of the physical object in physical space is determined to generate an appropriate translation that will convert a location relative to the information indicating the region of interest (or a location on an image) into a physical location. In some examples, the absolute location is specified in terms of coordinates for a controller that directs a motor to position the object appropriately.

At 1352, the translation is applied to the chosen location to generate information specifying the physical location of the chosen location. The physical location thus corresponds to the chosen location. An operation can then be performed on the physical object via the information specifying the physical location.

The various steps can be commingled or omitted as needed. For example, the translation can be done such that the location chosen is already translated, rather than choosing a location and then applying the translation.

### EXAMPLE 6

### Regenerating a Region of Interest

As pointed out above, it may be desirable to regenerate the extent of a region of interest after information indicating the region of interest has been stored. For example, if the information indicating a region of interest has been stored with respect to reference points, it may be desirable to regenerate the perimeter of a region so a location within the perimeter can be selected.

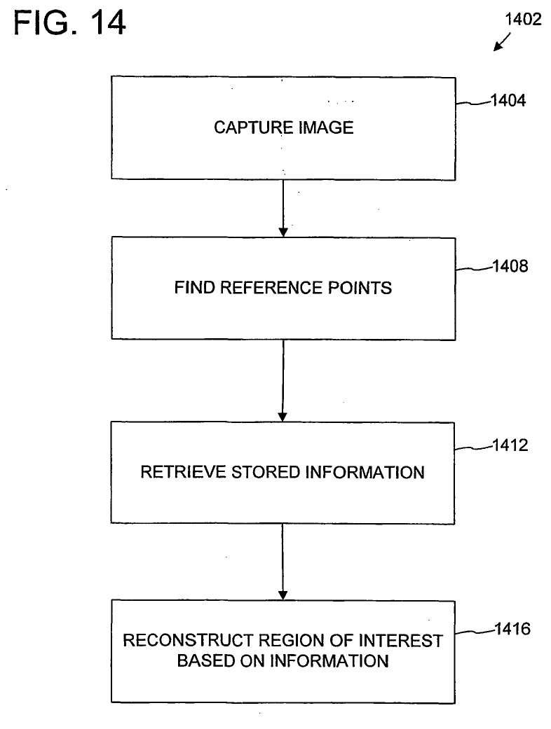

FIG. 14 shows an exemplary method 1402 for regenerating a region of interest for a physical object. Such a method can be performed, for example, after retrieving a physical object from a set of physical objects. For the retrieved physical object, an image is captured for the physical object at 1404.

The reference points are found in the image at 1408. As described above, the software can determine the location of the reference points on the image, or an operator can specify where they appear. If desired, the operator can confirm proposed reference point locations found by the software.

At 1412, stored information for the physical object is retrieved. At 1416, a region of interest is regenerated for the object, based on the stored information. In some cases, it may be advantageous to include on the physical object an object identifier such as a barcode so that information related to the object can be matched with the object. An operation can then be performed on the physical object based on the reconstructed region of interest.

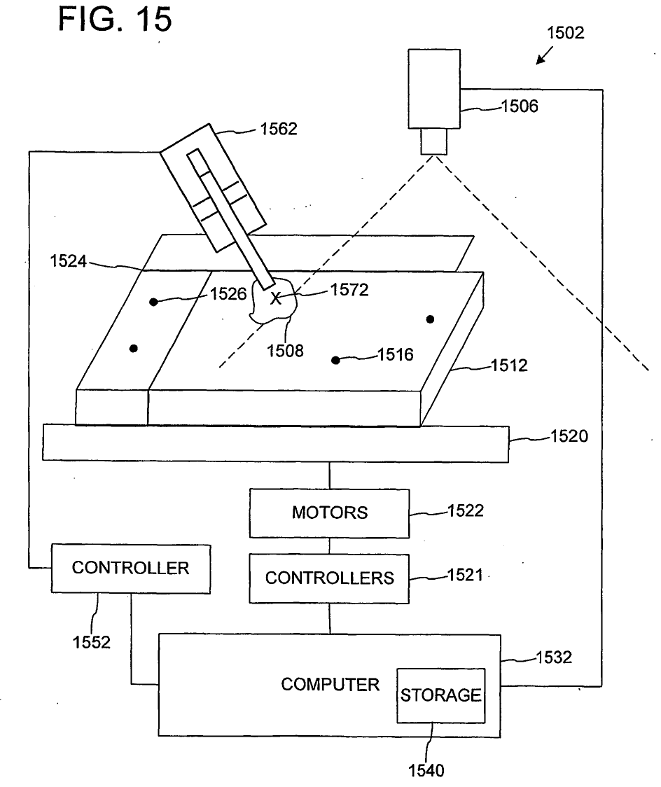

FIG. 15 shows an exemplary system 1502 for carrying out a method such as that shown in FIG. 14. In the example, the platform 1520 moves, and the other items (e.g., the camera 1506) typically remain anchored at particular locations. However, a system could be constructed in which the platform 1520 remains stationary and the other items move.

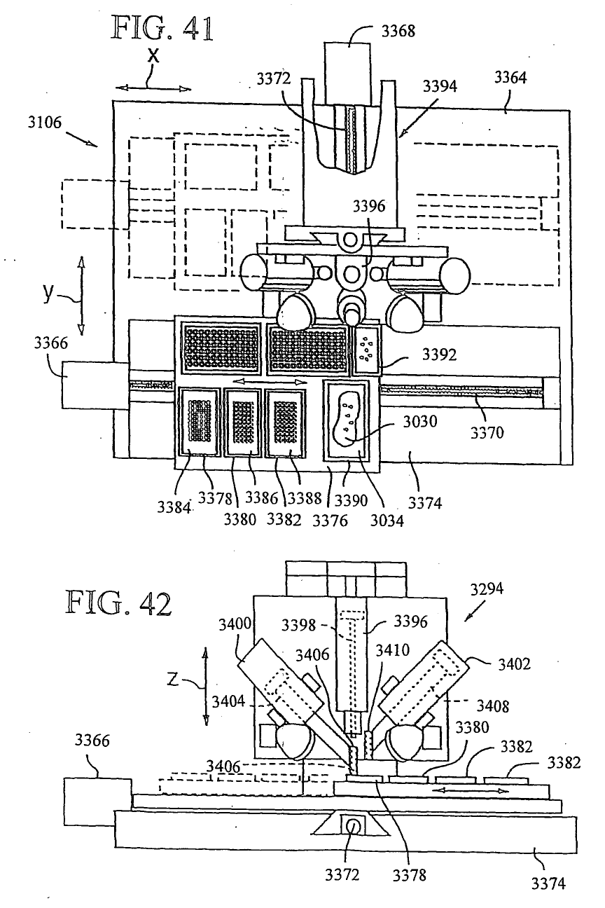

The physical object 1512 for which a region of interest is to be regenerated rests on a platform 1520. In the example, the platform 1520 is an automated positioning device and is moveable via motors 1522, which are controlled by controllers 1521. Typically, the motors 1522 are arranged so that one motor controls movement in one direction (e.g., “x”), and another motor controls movement in a perpendicular direction (e.g., “y”). Another example of such an arrangement is shown at FIG. 41.

The motors can be any of a variety of types, including commercially-available products. For example, one embodiment uses an S2x Stepper Motor from Industrial Devices Corporation of Petaluma, Calif. for the motors 1522, and a combination of a NextStep MicroStepping Drive from Industrial Devices Corporation and an AT6400 Indexer from Parker Hannifin Corporation (Compumotor Division) of Rohnert Park, Calif. for the controllers 1521.

The controllers 1521 send pulses to the motors 1522 as directed by the computer. In the embodiment described above, the indexer accepts commands from the computer system and translates the information to pulses to be sent to the drive, which amplifies the pulses before sending them to the stepper motors.

A variety of controllers are available and typically support specifying movement according to a coordinate system. These coordinates are sometimes called “absolute” coordinates because they unambiguously (i.e., not with respect to a particular image) specify placement of the platform 1520 at a particular position. The controllers typically support a built-in calibration feature, such as simply specifying that the present position is to be considered the origin for purposes of absolute coordinates.

In the example, a camera 1506 is positioned so that it can capture an image of the physical object 1512 when the platform 1520 is appropriately positioned. The camera 1506 may be the same type as the camera 822 described above with reference to FIG. 8 or another camera capable of capturing an image. In some implementations, the camera 1506 need not capture an image, as long as it can assist in determining the location of reference points. For example, instead of a conventional camera, a device that can detect the conductivity, magnetic, electromagnetic (e.g., pulsing radio frequency signals), or other distinguishable characteristics of the reference points can be used to assist in determining the location of reference points. A camera calibration technique can be performed to determine where the platform 1520 should be positioned so that the camera 1506 captures an image of the physical object 1512.

The camera 1506 is controlled by the computer 1532, which includes storage 1540. Storage 1540 can be implemented via any of a variety of computer-readable media Captured images and information related to the object 1512 may both be stored on the storage 1540 or stored separately. Alternatively, the storage 1540 can be located outside of the computer 1532 (e.g., accessible via a local network connection or the Internet).

The computer 1532 can retrieve digital image data from the camera 1506 or an interface thereto and store the image data for processing. The digital image data from the camera 1506 comprises a representation of the object 1512.

In the example, the physical object 1512 has various reference points thereon, such as the reference point 1516. When reconstructing a region of interest, stored information indicating the region of interest is retrieved and processed. One way the region of interest can be indicated is by indicating a set of points on the region's perimeter. Each of the points can be represented as a set of distances from the reference points (e.g., as shown in FIG. 10).

An example of such an arrangement is shown below in Table 3. The information can be stored as a data structure in a computer-readable medium, such as the storage 1540. For multiple regions of interest, more than one definition can be stored.

TABLE 2
Region of Intrest Definition

| | Distances | | |
|---|---|---|---|
| Point | From R₁ | From R₂ | From R₃ |
| 1 | 32.2 mm | 12.6 mm | 40.3 mm |
| 2 | 32.1 mm | 12.8 mm | 40.4 mm |
| . . . | . . . | . . . | . . . |
| 198 | 32.4 mm | 12.4 mm | 40.1 mm |

The units (mm) are provided for example only and may be varied or be defined with different precision (e.g., more significant digits) depending on system requirements. Typically, a data structure need not indicate the units repeatedly throughout the structure, and in some cases the units are implied. Similarly, the point identifier and reference point identifiers can be implied by virtue of the data's location in the data structure. Instead of actual physical distances, image unit (e.g., pixel) differences can be used and a scaling factor stored so the size of a pixel or distance between pixels can be determined. The scaling factor can be computed via stored information about the distance (e.g., in image units) between two of the reference points. The scaling factor can be applied to distances (e.g., as a multiplier) so that a regenerated region of interest is of proper size when portrayed graphically. Instead, the scaling factor can be computed by comparing magnifications (e.g., magnification used for one image compared to magnification used for another).

Many alternative arrangements are possible using various principles of geometry. For example, two distances can be used instead of three. In such an arrangement, a line can be drawn between two reference points. The first distance indicates how far away an intermediate point is from one of the reference points. The second distance indicates how far away from the intermediate point (e.g., in a direction perpendicular from the line) the perimeter point is located.

To regenerate the region of interest, correspondence between the reference points and the reference points on the captured image is resolved. In other words, out of the plural reference points represented on the captured image, R₁ is identified; thus, the identity of the reference points is determined. Such identification can account for rotation or flipping of the physical object 1512 that may have occurred between when the region of interest definition was previously generated and subsequent image capture.

To identify the reference points as reference points, a human operator can view the captured image and indicate where the reference points appear (e.g., by clicking on a location on the screen). Alternatively, software can identify the reference points by finding distinctive portions of the captured image.

To identify the identity of the reference points, again a human operator can view the image and select which reference point in the image corresponds to each of the reference points in the region of interest definition. For example, a distinctive shape or color can be used to differentiate the reference points. Alternatively, software can determine the identity of the reference points by finding which of the reference points have the distinctive shape or color (e.g., by convention, reference point R₁ is green).

In yet another arrangement, as described above with reference to FIG. 6, the identity of the reference points can be determined by virtue of their placement on the object 1512. The placement scheme described above can determine the identity of the reference points even if the object 1512 is rotated or flipped (e.g., appears as a mirror image).

Having identified the reference points and their identities, the region of interest can then be regenerated perimeter point by perimeter point. For example, if the perimeter points have been indicated as those shown in FIG. 10 or Table 3 above, it may be beneficial to define a perimeter point in terms of a problem in geometry. Perimeter points can be defined as the intersection of three circles, each circle defined as centered about a reference point and having a radius equal to the defined distance. An example of such a technique is shown in FIG. 16. For three reference points R₁, R₂, and R₃, circles 1622, 1623, and 1624 have been constructed, and the circles intersect at the perimeter point 1630.

Note also that if a reference point (e.g., R₂) were lost, the circles for the remaining reference points intersect at two points (e.g., 1630 and 1632) and therefore ambiguously indicate a point. Information defining the region of interest can indicate which of the two points (e.g., the “top” one with respect to the line intersecting R₁ and R₃.) is the proper perimeter point. Such an indication can be stored in the data structure defining a region of interest so that the region of interest can be reconstructed even if a reference point is somehow missing or lost.

Similarly, additional reference points (e.g., a total of four or more) can be employed so that even if one or two reference points were somehow lost, the region of interest could still be regenerated. Alternatively, two reference points could be employed from the start.

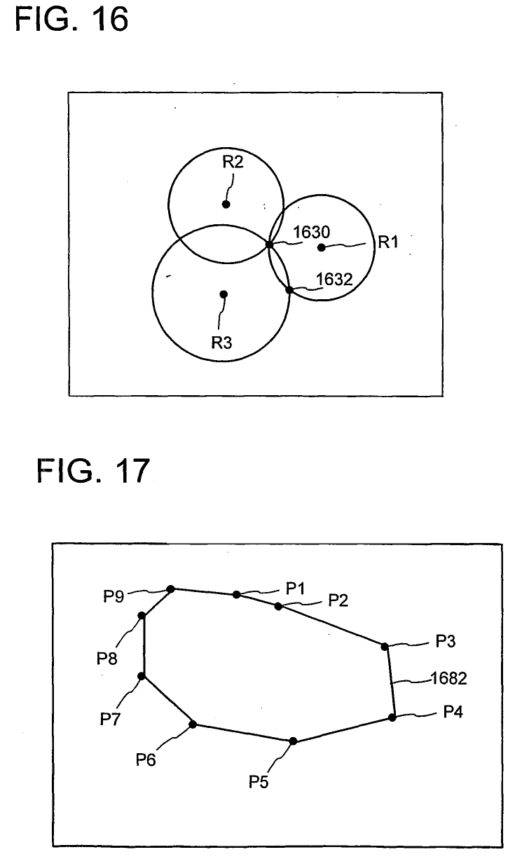

FIG. 17 shows a technique for assembling perimeter points (e.g., such as those defined via the above techniques). The region of interest 1682 is defined as a series of perimeter points, P₁-P₉. Such points can specify a perimeter for a region of interest. In the example, the series of perimeter points indicate a region of interest, but the technique can also be used to exclude a sub region from a region of interest. For example, a first series of perimeter points can indicate the region, and a second series of perimeter points can indicate a region within the first region that is to be designated as not part of the region of interest (e.g., even though the second region is “inside” the first). Further, it may be advantageous to define nested regions of interest (e.g., one region inside of another).

Still further, it may be desirable to prioritize material within the region of interest. For example, a region of interest may include sub-regions designated as having material that is to be used before the remaining parts of the region. Such an arrangement can be accomplished via nested regions of interest.

The resolution and number of perimeter points chosen to define the region of interest 1682 can be varied to accommodate system requirements. Also, alternative techniques can be used, such as defining shapes (circles, ellipses, squares, and the like) via indication of a center, locus, vertex, or other significant location and another number (e.g., indicating size).

A technique could be employed without using the illustrated reference points. For example, edges or vertices of the physical object could be used as a reference. Also, if the camera is of known magnification and at a fixed position (or varies in some known way), such information can be used to accurately regenerate the region of interest.

In addition to the information described above, additional information about an object can be determined and may be useful for subsequent processing. For example, it may be useful to determine whether and how an object has been rotated with respect to the original orientation when the region of interest was specified. Such a determination can be made by comparing the orientation of the reference points in a captured image and the orientation of reference points when the region of interest was specified.

### EXAMPLE 7

### Choosing a Location

Although an operation could be performed on an entire region of interest, it is typically desirable to select a location within the region of interest on which the operation will be performed. Selection of a location can be automatically done by software based on specified criteria (e.g., a location that permits removal of a specified amount of available resource or a first available location with remaining resource) or with the assistance of an operator, who indicates a location on an image depicting the region of interest. A database can assist in selection of locations; queries to the database will result in a result set indicating a possible location or locations. If a resource is removed, the database can be updated so that subsequent queries to the database will reflect that that the resource is no longer available.

The software can accept parameters to assist in selection of plural locations for a region of interest. For example, an operator might specify that a particular set of locations be chosen based on an amount of material to be extracted for each location, and a minimum distance between each location. The software can respond by choosing the locations within the region of interest without operator input or presenting a set of candidate locations, which the operator can modify by adding, moving, or deleting locations.

### EXAMPLE 8

### Determining a Translation

In addition to regenerating the region of interest, the system further supports determining a translation to map coordinates to a physical location within the system. As a practical matter, values indicating a location within a region of interest typically take the form of a set of coordinates; however, the coordinates may be relative to an image or the region of interest itself. For example, if a region of interest is depicted as superimposed on an image representing a physical object, one way of specifying a location within the region of interest is via coordinates (e.g., x and y values) of a pixel within the image. However, such coordinate values are relative to the image. If information indicating the region of interest is based on a different image or generated by a different system, the coordinates may need to be adjusted to specify a physical location. Additionally, the image may depict the object as rotated with respect to the system's physical coordinates.

Accordingly, a conversion can be made to account for adjustments to the coordinates. Similarly, it is often desirable to specify the coordinates in terms of actual physical location, rather than pixel location. Then, an instrument such as an automated device 1562 (FIG. 15) can be positioned to perform an operation at the physical location. Such conversions or adjustments are sometimes called a translation.

A translation can take a simple form by simply adjusting for scale; other translations are more complex and account for rotations or incorporate physical location information. The translation typically takes the form of a set of values that are applied (e.g., multiplied and added to) to one set of coordinates to produce a second set of coordinates.

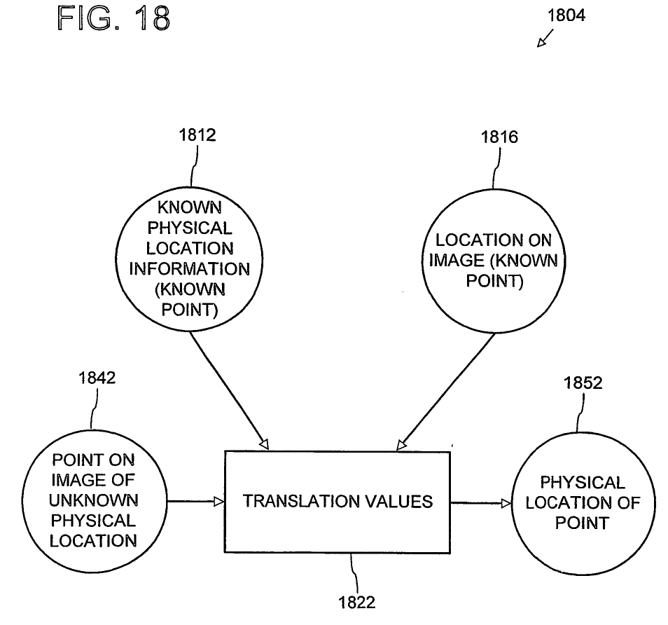

FIG. 18 generally shows data flow 1804 for an exemplary translation technique. Known physical location information 1812 for a known point and the location of the known point on an image 1816 can be combined to generate translation values 1822. In addition, the translation values 1822 can be based on scaling information, such as the known physical distance between two points on the image (e.g., system reference points or reference points appearing in an image of a physical object). Multiple points can be used to better verify the translation values 1822.

Also, in some systems, it may be that the image is captured at a view not perpendicular to the surface. In such a case, a minor adjustment may need to be made because physical units are not uniformly distributed in the image.

Although the translation values 1822 can be calculated by determining whether and how an object has been rotated, the information indicating the region of interest can be stored in a format that is independent of the object's rotation. For example, some of the reference point techniques described above can reconstruct the region of interest without explicitly determining how the object has been rotated since the region of interest was denoted. The information is thus rotation independent.

However, rotation of the image with respect to x- and y-axes of the system can be used to determine an appropriate translation. Such rotation can be determined by observing system reference points at a known angle to the system's physical coordinate's axes when the system reference points appear in the image.

Having determined appropriate translation values 1822, a point of unknown location 1842 (e.g., a point appearing on an image or a point in a region of interest) can be translated into information indicating a physical location for the point 1852. By applying the translation, entire regions of interest or sub-regions thereof can be translated into information indicating physical locations with respect to the system.

When regenerating a region of interest, it may be desirable to regenerate the region in terms of physical locations and then translate into image coordinates. Or, the region of interest can be regenerated in terms of image coordinates and translated to physical locations. In some cases, regeneration and translation can be combined into a single process, avoiding intermediate processing.

The information indicating physical locations can take a variety of formats, such as a value appropriate for input to a controller that positions an automated positioning device. The information indicating a physical location is sometimes called “absolute” because it can unambiguously identify a physical location for a controller. For example, in the system shown in FIG. 15 (described in more detail below), the information indicating a physical location takes the form of information that can be used to position the platform 1520 so that the automated device 1562 will operate on the physical location when activated.

For purposes of convenience, it may be advantageous to designate a particular fixed point in free space as the reference origin. Whether an item is at the reference origin (or a known offset from the reference origin) can be determined by using calibration techniques. A moveable component of the system can then be aligned with the reference origin to designate an origin for the moveable component. In the following example, the location in free space at which the stationary automated device 1562 performs its operation is considered to be the reference origin.

Returning now to FIG. 15, a platform guide 1524 is attached to the platform for assisting in calibration and translation. The physical object 1512 is shown adjacent to the platform guide 1524, which itself includes system reference points, such as the system reference point 1526. The physical object 1512 could instead be some distance away from the platform guide 1524.

A useful calibration technique for aligning the platform 1520 with the reference origin is to move one of the system reference points (or some other designated point) to the reference origin (e.g., by moving the platform); then the system can be calibrated by specifying that the point on the platform is at the reference origin. Typically, controllers for positioning the platform accept a command to set the current location of the platform to be the platform's origin. The platform's origin is thus aligned with the reference origin, but there may be an offset between the two.

When an arbitrary designated location on the platform 1520 (e.g., a hole in stationary piece of plastic) is in line with the reference origin, the platform is considered to be at its origin.

To reliably achieve such calibration via automated means, it is helpful to use a pair of laser beams, one each of the x- and y axes. Although the laser beams need not actually intersect, they correspond to x- and y-axes that may intersect at a location considered to be the platform's origin or some known distance from the platform's origin. Additionally, the distance from the platform's origin to the system reference points (e.g., 1526) is measured. Measurement can be achieved by determining how far the platform 1520 must be moved to cause a stationary object to travel from the platform's origin to a reference point.

To calibrate the system 1502, the platform 1520 is positioned so that the actuated automated device 1562 breaks a laser beam (e.g., for the x-axis). It is then known that the platform is at a location corresponding to a zero location for the x-axis (or some known distance therefrom). Appropriate controllers for the platform can then be calibrated by sending information indicating that the platform is currently positioned at a zero location for the x-axis (or some known distance therefrom).

The technique can then be performed for the y-axis. The location of any system reference points is then also effectively known. To permit automated detection of when a laser beam is broken, a laser sensor can be used, such as the OHDK 10P5101 Laser Sensor available from Baumer Electric of Frauenfeld, Switzerland.

To calibrate the location of the camera, a system reference point (e.g., 1526) can be positioned so that it shows up at a particular location on an image captured by the camera 1506 (e.g., within displayed crosshairs during a real-time display of the reference point). An offset can then be calculated. Although not necessary for use when translating locations, the offset can be useful when determining where to position the platform so an image of the object 1512 will be properly captured.

For purposes of determining the translation, the digital image data from the camera 1506 comprises a representation of the platform guide 1524, so that the location of system reference points can be identified on captured images.

Preferably, the object 1512 avoids movement during image capture and subsequent processing. In the example, the object 1512 is shown adjacent to the platform guide 1524. Although such a position is not essential, proximate positioning can be helpful because improved resolution is available. In some cases, multiple objects may be present on the platform, so some of them will be further away from the platform guide 1524 than others.

When the object 1512 and the system reference points appear in a captured image, the presence of the system reference points can assist in generating an appropriate translation for determining the physical location of regions of interest of the physical object 1512. Thus, an operation can be performed on a physical location associated with a region of interest of the physical object 1512. For example, the platform 1520 can be moved to a position so that an operation can be performed on a particular point within a region of interest.

### EXAMPLE 9

### Performing an Operation for a Region of Interest

After the region of interest has been regenerated and an appropriate translation has been determined, an operation can be performed for a region of interest. For example, an operation can be performed on a physical location within the region of interest.

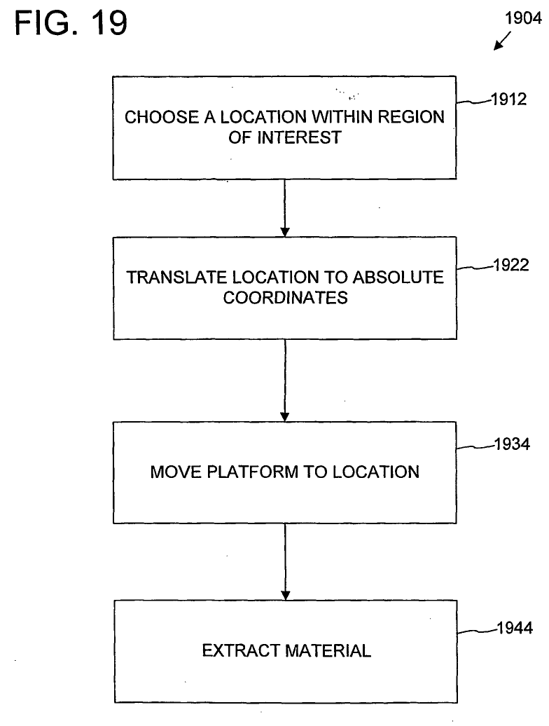

As shown in the exemplary method 1904 of FIG. 19, one possible operation involves extracting a removable resource from an object. At 1912, a location within a region of interest is chosen. The location within the region of interest can be chosen with operator assistance or automatically by software, based on various specified criteria (e.g., near the center, near an edge, or according to another scheme). For example, a database can track whether a resource remains at a particular location.

At 1922, the location is translated to absolute coordinates unambiguously specifying a physical location. Such a translation can be accomplished using translation values applied to a location within a region of interest. Alternatively, the translation may take place concurrently with regeneration of a region of interest.

At 1934, the absolute coordinates are sent to motor controllers to move the platform so that an automated device will be positioned to operate on the absolute coordinates. Additional adjustments to the coordinates may be appropriate to place them in a format appropriate for the controller.

Then, at 1944, material is extracted from the physical object at the chosen location within the region of interest. Extraction can be accomplished by sending appropriate commands to the automated device (e.g., an automated punch) so that it performs extraction.

Typically, after removing the material, a database storing information about the physical object is updated to reflect that the material has been removed and may additionally include other information, such as the date of removal, an operator name, purpose of the removal, and the material's intended destination.

Subsequently, it may be desirable to fill the vacant area left by material removal with a filler material to prevent degradation of the physical object's structure. Such an operation can be accomplished by directing the automated device with filler material to a location to be filled and then directing the automated device to eject the material.

The system 1502 shown in FIG. 15 can be used for performing an operation for a region of interest 1508 of a physical object 1512. In practice, the region of interest 1508 may or may not be physically indicated on the physical object 1512.

The system 1502 includes a computer 1532 with storage 1540, which can be used to store translation values and other information. The computer 1532 can determine an appropriate location on the physical object 1512 and send commands to the controller 1552, which controls the automated device 1562. In some cases, the storage 1540 can be located outside the computer 1532 (e.g., at a remote location).

Typically, the object 1512 is placed on the platform 1520 by an automated object retriever; however, the object 1512 could be placed on the platform 1520 manually by a human operator. The object 1512 is then positioned (e.g., by moving the platform 1520) so that an image of the object 1512 can be captured by the camera 1506. Based on analysis of the image, the object 1512 is then positioned (e.g., by moving the platform 1520) so that the automated device 1562 can perform an operation on the object 1512 at a selected location 1572. Subsequently, the object 1512 can be returned to its original location (e.g., in a collection of objects in an object library), other objects can be retrieved, and the system can perform operations on the other objects seriatim.

In one example, the automated device 1562 is an automated extractor (e.g., a tissue punch) for extracting material. Commands can be sent to the controller 1552 so that the extractor 1562 extracts material from the physical object 1512. In the drawing, the size of the extraction mechanism of the extractor 1562 is exaggerated. Typically, small amounts of tissue are extracted from the object 1512.

A useful calibration technique can be achieved in conjunction with the laser beam technique set forth in the description of FIG. 15. The platform 1520 can be relocated until the automated device 1562 breaks both laser beams. In the case of an automated punch, the punch can be extended to punch a location (e.g., empty space). When the punch breaks both laser beams, the location of the punch is known, and it is secured to maintain a stationary position. Then, the platform 1520 can be positioned so that the automated punch will punch the selected location within a region of interest.

In the example, the camera 1506 and the automated device 1562 are stationary, but the platform 1520 moves. Alternative arrangements are possible, where the camera 1506 or the automated device 1562 move.

Instead of extracting material, it may be instead desirable to measure the material, mark the material, or perform some other operation on the physical object. The operation can modify the object 1512, and the modification can be reflected in a database.

### EXAMPLE 10

### Object Slicing

It may be desirable to section an object to produce a slice. For example, a region of interest might be more easily or efficiently denoted for a slice. In such a case, reference bars can be used to more efficiently process regions of interest. For example, the slice might be placed on a slide and observed under magnification; denotation of a region of interest for the block can be achieved by denoting a region of interest for the slide.

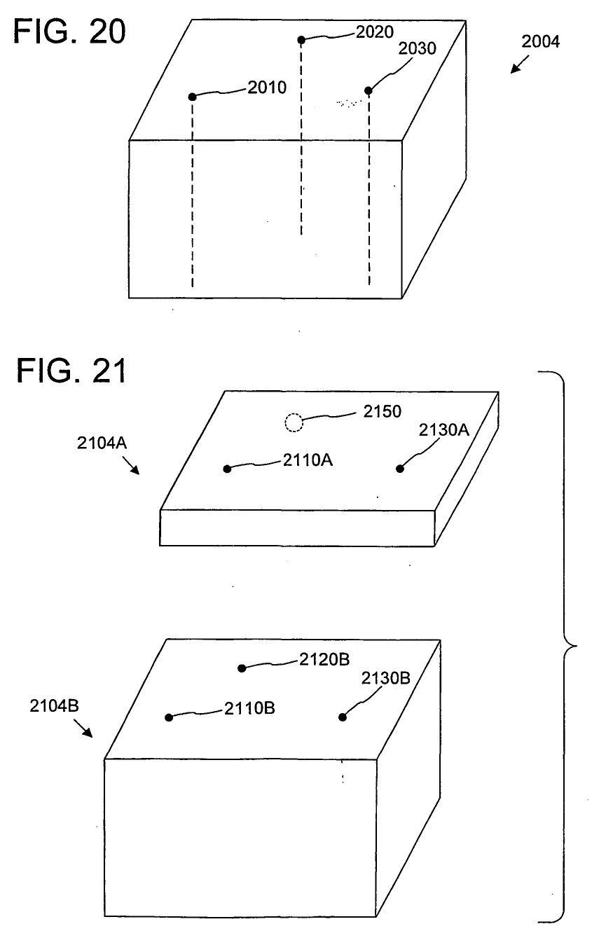

FIG. 20 shows an example of a physical object 2004 into which reference bars 2010, 2020, and 2030 have been placed. The reference bars are constructed of a material that can be sliced and is distinguishable from the material of the object 2004. The ends of the bars are visible when viewing the object 2004 and thus can be used as reference points.

FIG. 21 shows a slice 2104A and a remaining portion of the object 2104B produced via sectioning. Although one slice is shown, more or less slices may be desirable. As shown, the reference bars have been sliced as well, and the ends of the reference bars are visible and can be used as reference points. Thus, reference points for the bars 2110A and 2110B are related to the reference point for the bar 2010. The reference point for the bar 2120B is related to the reference point for the bar 2020. Reference points for the bars 2130A and 2130B are related to the reference point for the bar 2030.

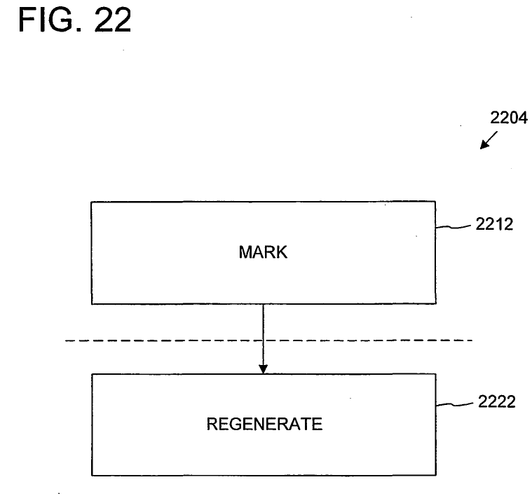

One useful scenario involves denoting regions of interest for the slice 2104A with respect to the visible reference points and storing the information as associated with the object 2104B. Subsequently, when the object 2104B is presented, the regions of interest can be reconstructed based on the stored information. Such a scenario is sometimes desirable because a region of interest can be more easily denoted for a slice 2104A. For example, denotation may be better achieved when slice 2104A is placed under a microscope for observation. Denotation might be performed at a first magnification. Subsequently, when an image is captured of the object 2104B for removing material from the object, a different magnification might be used. Thus, the slice 2104A can be used in place of an object in any of the herein described techniques related to denoting the region of interest for the object (e.g., the marking stage of FIG. 22).

Instead of a slice, another object representative of the object can be used. For example, a clear transparency could be used instead of the slice 2104A. In such a case, the transparency might be held over an object, whether or not a region of interest is already physically marked on the object. The perimeter of the region of interest and the reference points can then be traced on the transparency and the transparency can be scanned (e.g., in a flatbed scanner). As a practical matter, such an arrangement allows more efficient determination of the perimeter by the software.

Similarly, the slice 2104A might be scanned instead of being captured by a camera. The region of interest can then be denoted based on the captured scanned image, whether or not the region of interest has been physically marked on the slice 2104A.

In some cases, the regions of interest may need to be adjusted (e.g., if the region of interest is not uniformly vertically distributed in the object 2004). Similarly, adjustments may need to be made if a slice is not made perpendicular to the bars.

Although the bar 2120A (not shown) may be present in the slice 2104A, it is not visible in the example; it would be expected to appear at a location 2150. Using the features described above in which additional information indicating a region of interest is stored, it is nonetheless possible to reconstruct the location and extent of a region of interest for the object 2104B, based on information generated from marking the slice 2104A.

In some cases, slight adjusting may be needed based on movement during slicing and subsequent handling. Thus, the system supports a feature for adjusting the stored location of the reference points based on where they actually appear (e.g., as shown in an image of the object) via a user interface. The adjustment feature can also be useful even when not slicing an object, such as in a case in which handling results in slight movement of a reference point.

### EXAMPLE 11

### Combinations of the Features

The various features above can be combined into software systems to automate object processing. For example, as shown in the example method 2204 of FIG. 22, some implementations divide processing into two basic stages: marking 2212 and regenerating 2222. Marking can be done during a different session than regenerating. Further, marking can be done by different persons or different teams than regenerating. Also, marking can be done on a different system than the regenerating. In some cases, it may be desirable for marking and regenerating to be done during the same session, by the same person, or on the same system.

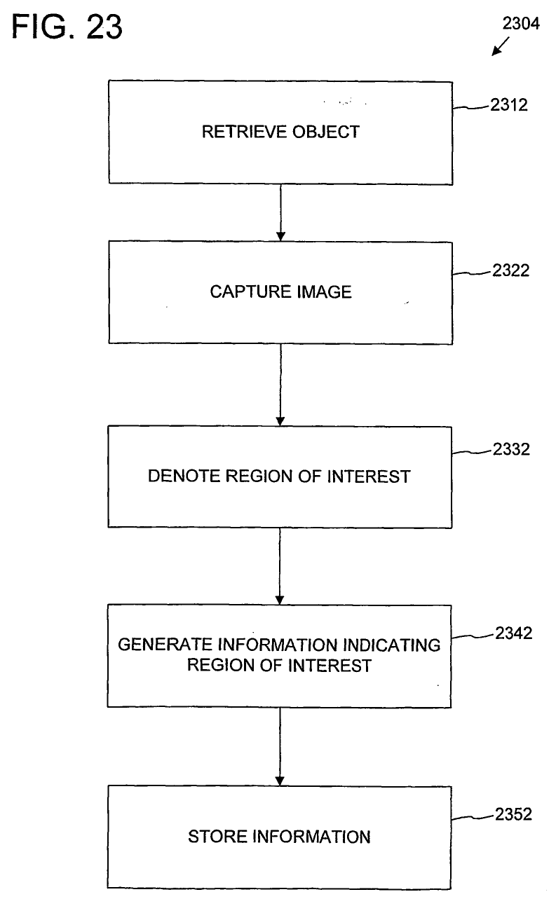

Processing done during marking 2212 is shown in the example method 2304 of FIG. 23. At 2312, an object is retrieved. An image is captured at 2322, and one or more regions of interest are denoted for the object at 2332. Information indicating the location and extent of the region of interest is generated at 2342. The information is of a format that can be used to reconstruct the location and extent of the region given the object and the information. The information is stored at 2352.

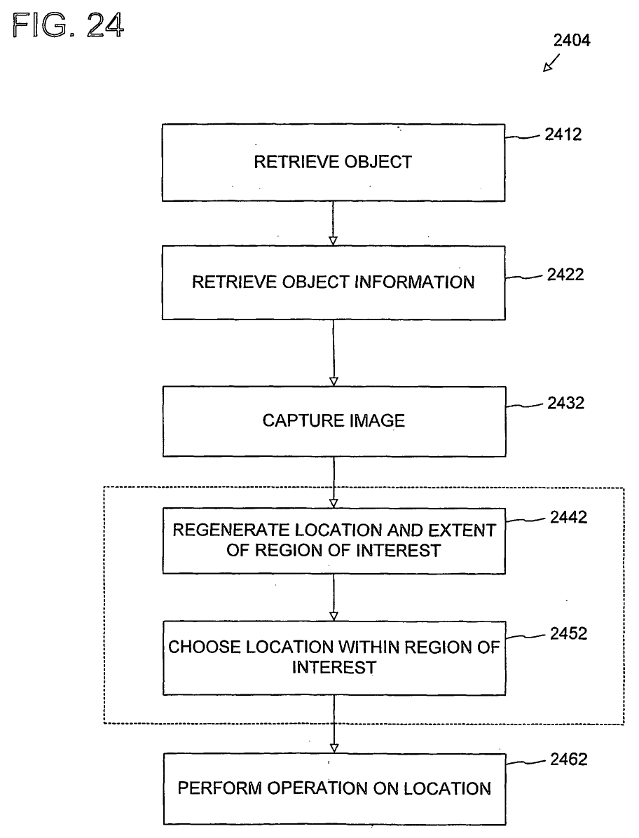

Processing done during regenerating 2222 (FIG. 22) is shown in the example method 2404 of FIG. 24. At 2412, an object is retrieved, and at 2422 information for the object is retrieved (e.g., the information generated in 2342, above). An image of the object is captured at 2432, and the location and extent of a region of interest is regenerated at 2442. Such processing may include calculating scaling information based on the image. Instead of capturing an image of the object itself, an image can be captured of another object representing the object (e.g., a clear transparency on which a region of interest has been marked or a slice from the object).

A location within the region of interest is chosen at 2452. Location choice can be performed before the image is captured and can be combined into other processing (e.g., when regenerating a region of interest in 2442). Then, an operation is performed on the location at 2462. The operation is performed based at least in part on where in physical space the object is positioned with respect to a known position (e.g., a system reference point).

The magnification used to capture the image in 2322 (FIG. 23) may be different than that used to capture the image in 2432. For example, different cameras may be used, or the same camera with a different magnification setting may be used. Scaling information can be stored with the information indicating a region of interest so that size of the region of interest can be appropriately adjusted.

Object retrieval at any stage can be automated. For example, an object identifier can be specified to an automated system that directs an automated object retriever (e.g., a robotic arm) to retrieve the object from a set of objects.

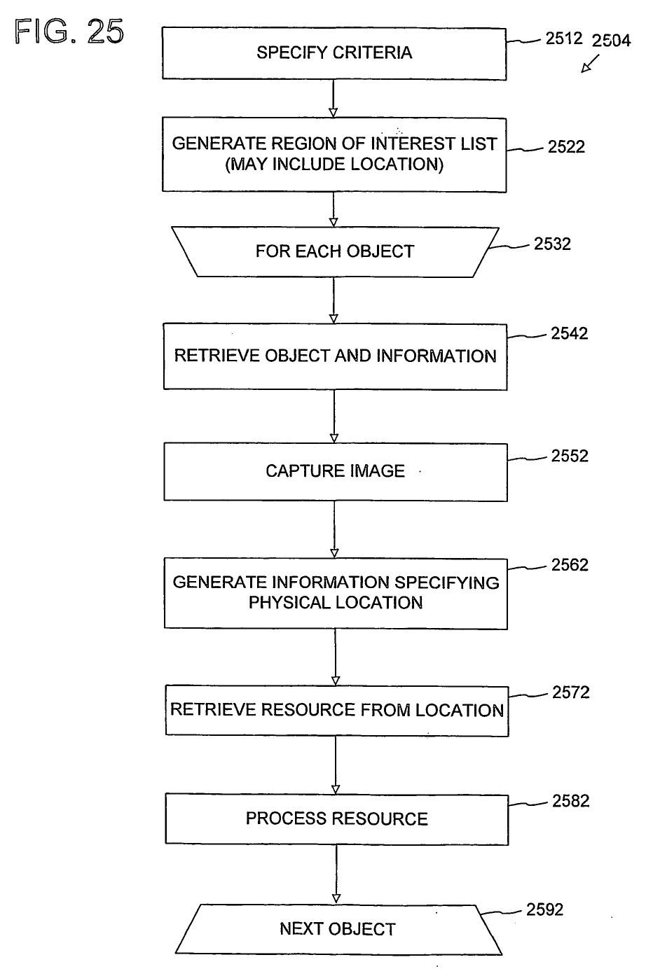

Another combination of features is shown in the method 2504 depicted in FIG. 25. In the example, criteria are specified at 2512. For example, an operator might specify that she wishes to process certain regions of interest having particular characteristics (e.g., size). A query is run on a database storing information for the regions of interest that indicate the various characteristics and the object on which the region of interest resides.

Based on the query, a region of interest list is generated at 2522. The database may further indicate the locations from which material has been removed from the regions and provide a suggested location with respect to the region of interest from which material can be removed. The operator can edit the region of interest list if desired, and list of physical objects related to the regions of interest can be generated.

Then, for each of the objects 2532, the object and associated information is retrieved at 2542. An image is captured for the object at 2552. Then, information specifying a physical location within the region of interest (e.g., from the above list) is generated at 2562. The information can be based on a location already chosen; alternatively, a location can be chosen after capturing the image. Then, a resource is retrieved from the location at 2572, and the resource is processed at 2582. Then, the next object 2592 is processed.

In this way, an operator can retrieve resources from a large number of regions of interest within a large number of physical objects. Operator input can be used to guide the processing, but various operations can be performed automatically without operator input if desired.

### EXAMPLE 12

### Tissue Microarray Technologies

The following describes technology related to tissue microarrays. Any of the features described above can be advantageously used when constructing or processing tissue microarrays. In such a case, the physical object can be a tissue block, and the resource within the block can be tissue within the block.

These technologies generally relate to the microscopic, histologic and/or molecular analysis of tissue or cellular specimens and, more particularly, to the construction of tissue microarrays for holding multiple tissue specimens and the use of such tissue microarrays for high-throughput molecular analyses, as well as didactic and quality control purposes.

### Background of Technologies

Microscopic examination of tissue specimens has helped clarify biological disease mechanisms. In standard histopathology, a diagnosis is made on the basis of cellular morphology and staining characteristics. This approach has improved disease diagnosis and classification, and promoted development of effective medical treatments for a variety of illnesses, such as cancer. However, cellular morphology reveals only a limited amount of information regarding the molecular mechanisms of disease.

Recently, several techniques have evolved to explore molecular and cellular disease mechanisms. For example, the biological behavior of some cancers may be predicted by certain genetic abnormalities (such as mutations in certain oncogenes; Faderl et al., N. Engl. J. Med. 341: 164-172 (1999)), expression of hormonal receptors (such as estrogen receptor expression in breast cancer; Eisen and Weber, Current Opinion in Oncology 10 :486-91 (1998)), or the abnormal expression of tumor-associated cell surface proteins (such as neural cell adhesion molecule expression in neuroendocrine lung tumors; Lantuejoul et al., Am. J. Surg. Pathol. 22:1267-1276 (1998)). These abnormalities may be assessed by examining tissue specimens with techniques such as immunohistochemistry, in situ hybridization, and DNA amplification using the polymerase chain reaction (PCR). The information thus gained may be used to determine an individual's prognosis and likelihood of response to therapy. It is also useful for understanding the fundamental molecular and cellular mechanisms of human disease.

New and important molecular disease markers, and a better understanding of human disease processes, may result from improved methods for evaluating histopathology, genetic abnormalities, and gene expression in large numbers of tissue specimens. However, there has been only limited development of such methods. The lack of progress can be attributed in part to the difficulties involved in preparing multiple tissue specimens for analysis. Multiple tissue specimens have been assembled using manual methods, but these methods are labor-intensive, time-consuming, and inefficient. See, e.g., Wan et al., Journal of Immunological Methods 103:121-129 (1987); Furmanski et al., U.S. Pat. No. 4,914,022; Battifora and Mehta, Lab. Invest. 63:722-724 (1990), and U.S. Pat. No. 5,002,377. Such limitations render existing assembly methods inadequate for rapid parallel analysis of a variety molecular markers in a large number of different tissues.

High throughput methods are now being developed for analysis of gene expression in tissue extracts. Microarrays of DNA sequences are printed on a solid support surface using computer-controlled, high-speed robotics. These DNA microarrays typically include representative sequences from genes of interest. Total mRNA is isolated from a tissue sample using standard techniques, and reverse transcribed in the presence of a fluorescence-tagged deoxyribonucleotide. The fluorescent mixture of total cellular eDNA is then hybridized to the microarray, and fluorescence intensity quantified by laser confocal scanning microscopy and image analysis. See Schena et al., Science 270: 467-470, 1995; Schena, BioEssays 18: 427-431, 1996; Soares, Current Opinion in Biotechnology 8:542-546, 1997; Ramsay, Nature Biotechnology 16: 14-44, 1998; Service, Science 282: 396-399, 1998; U.S. Pat. No. 5,700,637. Alternatively, the microarray may be constructed using genomic DNA or cDNA from one or more tissues, and detection accomplished using fluorescence-tagged oligonucleotides containing representative sequences from genes of interest. See Schena et al., BioEssays 18: 427-431, 1996.

An important medical goal is to validate, prioritize and further study genes and proteins discovered in large-scale molecular surveys as well as to establish the diagnostic, prognostic and therapeutic importance of a rapidly increasing number of disease candidate genes. This in turn will require rapid analysis of hundreds or thousands of specimens from patients in different stages of disease, with minimal requirement for operator intervention. To date, however, there has been limited progress in automating analysis of tissue samples. As noted, available manual methods for assembly of tissue specimens (such as those described by Wan et al., Furmanski et al., and Battifora and Mehta) are labor-intensive and inefficient. Bolles, U.S. Pat. No. 5,746,855, teaches an apparatus and method for automatic archival storage of tissue sections after they are cut from a sample block. A section of adhesive tape is applied to the sample block prior to cutting a section with a microtome; after the section is cut, the adhesive tape is automatically lifted, advanced, and pressed to a microscope slide containing a stronger adhesive material. Bernstein et al., U.S. Pat. No. 5,355,439 and 5,930,461 teach a method and apparatus for automated tissue assay, wherein a processor directs a robotic arm to move tissue samples between multiple workstations. Each workstation performs a different step in a biological test or analysis, e.g., tissue fixation, binding of a particular antibody, washing, with the processor ensuring that the step is appropriately timed. While the Bolles and Bernstein et al. teachings reduce the amount of operator intervention necessary for tissue sectioning and staining, they do not address the many other problems associated with high-throughput analysis of large numbers of tissue samples.

Achieving the goal of establishing the diagnostic, prognostic and therapeutic importance of disease candidate genes has also been slowed by inconsistencies in analysis. Up until the present time, analysis has been performed by many different researchers, at different locations. This approach has produced discordant results, that have slowed the progress of medical research. These discordant results are influenced by the presence of many different variables, such as differences in the biological material (such as tumor samples) that are obtained from different patients, the length of time before fixation, varying techniques used for fixation and antigen retrieval, differences in antibodies/probes which are selected by different researchers, variations in staining or hybridization, and interpretation of the results of such bioanalyses by different observers. Because of these multiple variables, numerous confirmatory studies are often required to obtain a sufficiently large number of results to compensate for these variables. Meta-analyses of multiple different studies can average out such variabilities, but the requirement for such studies is expensive and time-consuming, and slows the progress of medical research.

The second problem is that using conventional sectioning of tissue specimens, only a very limited number of molecular analyses can be performed per tissue. Typically, using 5 micrometer sections, one can only cut about 300 sections from each tissue block, and thereby carry out 300 different molecular analyses. There are over 60,000 genes in the human genome, and for each gene or gene product, multiple probes and antibodies can be generated. Therefore, only a very small fraction of all interesting genes/proteins can be analyzed from a set of valuable clinical specimens.

A related problem with tissue examination is that it is often subject to variable interpretation by different examiners. Pathologic examination (including molecular analysis) is usually accomplished by microscopic examination of biological material by a clinician or researcher. When the clinician is a pathologist, important clinical decisions are often made based on an interpretation of the biological material. For example, if a bladder cancer specimen is judged to show a grade 3 (poorly differentiated) bladder tumor, the patient's bladder is often removed (cystectomy) because large scale studies have shown such surgery to be required to provide the greatest chance of survival. However, if the tissue is judged to show a grade 2 tumor (moderately differentiated) more conservative measures are adopted which would be inappropriate for more advanced disease. Since the selection of an appropriate treatment requires that pathologic diagnoses be made in accordance with uniform standards, methods are needed to help ensure that clinicians in different localities have uniform standards of histologic diagnosis.

Advances in molecular medicine have further demonstrated the drawbacks of an absence of uniform standards for diagnosis. For example, Her-2 immunostaining results may determine whether a patient will undergo HERCEPTIN treatment. Despite the importance of a correct determination about the presence or absence of Her-2 immunostaining, there is still substantial inter-observer variation about the results of this test, and other molecular diagnostic assays. Since each molecular analysis is carried out on a different slide, multiple reasons may cause the variability. Often it remains impossible to identify the sources of this variability.

A related problem is that the training of pathologists and other trainees usually requires examination of a large number of many different tissue specimens, showing a spectrum of normal and diseased tissue. This has traditionally been accomplished by providing many mounted tissue sections which are examined through a microscope by the trainee. The trainee makes a histologic diagnosis, which is then compared to a histologic diagnosis made by a more experienced person (such as an expert pathologist).

The administration of examinations to large numbers of trainees (such as medical students and pathology residents) would also be facilitated by the availability of large numbers of specimens that have been subjected to analysis by a single expert, or a panel of experts whose results could be combined to provide a definitive diagnosis.

### Summary of the Technologies

A method and apparatus are disclosed for a high-throughput, large-scale molecular profiling of tissue specimens by retrieving a donor tissue specimen from an array of donor specimens, placing a sample of the donor specimen in an assigned location in a recipient array, providing substantial copies of the array, performing the same or a different biological analysis of each copy, and storing and analyzing the results. In one embodiment, the substantial copies are formed by placing elongated sample cores from different donor specimens in a three-dimensional matrix, and cutting sections from the matrix to form multiple copies of a two-dimensional array mounted on a solid support such as a microscope slide. The copies can then be prepared or processed independently and subjected to different biological analyses. Preparation of the copies for biological analysis, and the biological analysis itself, may be done by automated, computer implemented means. The results of the different biological analyses may be stored in a database and compared to determine if there are correlations or discrepancies between the results of different biological analyses at each assigned location, and also compared to clinical information about the human patient from which the tissue was obtained.

The arrays can be used to make large numbers of tissue samples from pathology archives readily available for molecular analyses. One can also rapidly obtain information about the biological significance of biological markers (such as immunohistochemical markers and/or gene alterations) in a large number of specimens. One can acquire information about the localization of the biomolecule in different tissue and cell types (e.g. nuclear, cytoplasmic, membranous etc.). The results of similar analyses on corresponding sections from a set of reference/test/quality control specimens can be used as quality control devices, for example by subjecting all these arrays to a single simultaneous investigative procedure. This may help to substantially standardize molecular analyses, including uniform interpretation of the array data by different observers.

As is apparent from the foregoing, the present invention includes many different advantages and permutations. The foregoing and other features and advantages of the invention will become more apparent from the following detailed description of disclosed embodiments which proceeds with respect to the accompanying drawings.

### More Detailed Description of the Technologies

Constructing tissue microarrays represents a considerably more complex problem than constructing nucleic acid microarrays. This problem is addressed by the present invention, in which one or multiple tissue samples are taken from a larger tissue specimen, and the samples are placed in corresponding positions of multiple recipient substrates.

Multiple tissue samples may be taken from multiple such tissue specimens, and the multiple samples from a particular specimen are similarly placed at corresponding positions in the multiple recipient substrates. Each of the resulting substrates contains an array of tissue samples from multiple specimens, in which corresponding positions in each of the arrays represent tissue samples from the same tissue specimen. In particular examples, each substrate is then sectioned into multiple similar sections with samples from the same tissue specimen at corresponding positions of the sequential sections. The different sections may then be subjected to different reactions, such as exposure to different histological stains or molecular markers, so that the multiple “copies” of the tissue microarrays can be compared for the presence of reactants of interest. The large number of tissue samples, which are repeated in each of a potentially large number of sections of multiple substrates, can be exposed to as many different reactions as there are sections. For example, about 100,000 array sections may be obtained from a set of 1000 tissue specimens measuring 15×15×3 mm. This approach provides a high-throughput technique for rapid parallel analysis of many different tissue specimens.

Also disclosed herein are particular examples of methods and apparatus for high-throughput large-scale molecular profiling of tissue specimens, in a manner that allows rapid parallel analysis of biological characteristics, such as molecular and cellular characteristics (for example, gene dosage or gene/protein expression), from hundreds of tissue specimens. In particular embodiments, the invention includes an automated apparatus for constructing tissue sample arrays from a plurality of specimens, in which the apparatus includes a specimen source from which tissue specimens are retrieved from assigned locations, a retriever that retrieves the tissue specimens from the specimen source, and a constructor that removes tissue samples from a plurality of the tissue specimens, and arrays the tissue samples at identifiable locations in three dimensional arrays in one or more substrates, wherein the different identifiable locations correspond to tissue samples from different tissue specimens.

In some embodiments, a sectioner then sections the three dimensional arrays into cut sections which carry the tissue samples from different tissue specimens, such that the locations in the three dimensional arrays correspond to locations in the cut sections. Some embodiments of the automated apparatus also include a controller that directs the retriever, constructor and sectioner, and can also record an identification of a subject associated with a particular specimen, as well as the identifiable locations in the three dimensional arrays and the cut sections that contain samples from that particular specimen.

Some embodiments of the apparatus include a donor source containing a plurality of identifiable donor tissue specimens, a retriever that retrieves the donor tissue specimens from the donor source, and a tissue microarray constructor that receives donor tissue samples from different tissue specimens retrieved by the retriever, and inserts the tissue samples into recipient blocks, thereby constructing a tissue microarray. A controller operates the retriever and array constructor, and identifies tissue samples within the array by recognizing identifiers associated with the tissue specimens. In particular embodiments, the tissue specimens are associated with a carrier medium, such as tissue block medium, and the apparatus further comprises a locator that records a location of the tissue specimen in the carrier medium, and a sectioner that cuts sections of the block.

In particular examples, the donor source is a donor specimen storage station, from which the constructor obtains tissue samples for insertion into the array, and to which the tissue specimens can be returned after obtaining tissue samples for insertion into the array. The tissue specimens can be located in the storage station by a coordinate positioning device, such as a robotic arm that retrieves tissue specimens from the donor source, and subsequently transfers tissue specimens to the tissue microarray constructor and returns tissue specimens to the donor source. A holder can be positioned to hold a separate tissue specimen and recipient block, and a reciprocal punch can be used to form receptacles in the recipient block and punch tissue samples from the tissue specimen. The punch then delivers a tissue sample from the tissue specimen to an identifiable receptacle in the recipient block. In disclosed embodiments, the recipient block is incrementally advanced to align a predetermined receptacle with the reciprocal punch, and deliver the tissue sample into the receptacle. A recorder records the location of the receptacle in the recipient block, and an identity of the tissue specimen from which the sample in the receptacle was obtained.

The apparatus can also include a microscope for locating a structure or region of interest (ROI) in a reference slide aligned with the tissue specimen prior to sampling, so that samples can be taken from the structure or region of interest. Moreover, once the samples have been placed in the recipient blocks, the blocks may be stored at identifiable locations in a donor source, such as an array of recipient blocks in a storage station. The same or a different storage station can also hold donor tissue specimens, prior and subsequent to taking the samples from the tissue specimens.

An advantage of some embodiments of the invention is that the cut images can be processed in a processing station, for example by exposing different sections to different biological reagents (such as standard stains, or immunohistochemical or genetic markers) that recognize biological structures in the cut sections. An imager then obtains an image of the cut processed sections, and an image processor identifies regions of the cut sections that contain images of biological interest (such as evidence of gene copy numbers), and stores images of the cut sections. If desired, quantities of biological reagents can be detected to quantify reactions (such as an amount of probe that hybridizes to the specimen as an indication of gene amplification or deletion), or to determine the distribution of the reagent in the sample.

The results of the image processing of any tissue microarrays can correlate the biological reactions of interest with identifying information about the cut sections and the subjects from whom the tissue specimens were obtained (such as clinical information about the subject). This information can be stored, for example, in a database that also includes the location of tissue donor specimens in the donor source, the location of recipient blocks in the recipient array, and the location of the tissue samples in the tissue microarray. Information in this sample database can be linked with information on the clinical, histological and demographic information of the patients

In yet another embodiment, the apparatus for assembling tissue microarrays includes a donor specimen station which includes compartments for assigned tissue specimens, a computer readable identifier which identifies the tissue specimens in the donor specimen station, a donor block scanner for reading the identifers and locating the tissue specimens in the carrier, and a tissue microarray fabricator which obtains a plurality of elongated tissue samples from a plurality of tissue specimens and places them in a recipient block. The apparatus can also include a sectioner that sections the recipient block sufficiently transverse to the elongated tissue samples to form a series of block sections which retain a relationship of the elongated tissue samples in the recipient block, so that the sections from the same block are similar copies of one another. A processing station can then expose different similar sections to different biological markers that associate with biological substrates of interest in the sections, if the biological substrates are present, so that multiple tests can be simultaneously performed on multiple samples in multiple sections. In some examples, an automated scanner then scans the different sections to detect the presence of the biological markers in the different sections. A scanner can, for example, acquire images for a pathologist to interpret, or process the images to derive intensity information and save them for future use. A controller (such as a computer) can be programmed to perform these functions.

Although the donor specimen station, donor block scanner, tissue microarray fabricator, sectioner, processing station, automated scanner, controller, and other components of this system are described in combination, the invention also includes any of these sub-units in isolation, or in combination with any other sub-units. The sub-units need not be in the same physical location, nor do they need to run simultaneously. For example, arrays can be formed and then delivered to a sectioner, where sectioning is performed as a temporally unrelated step. Similarly, the array blocks may be sent to different facilities for sectioning and analysis, or the sections can be sent to different facilities for analysis. Data from off-site analyses can be sent back to a central database for storage and/or data analysis.

The disclosure also includes a method for performing molecular analysis of biological specimens by providing multiple sections each including multiple biological samples. In particular embodiments, subsets of the sections include multiple similar sections in which tissue samples from the same specimen are located at corresponding positions in different sections. The different sections are exposed to biological reagents (for example, different biological reagents) that react with biological substrates of interest in the biological samples, and images are obtained of the different sections after exposing the sections to the biological reagents. The images are then analyzed to determine whether a reaction with a substrate has occurred in the different sections, or specimen samples represented in the sections. The images also can be used to quantitate the degree of staining, analyze its homogeneity within and between tissue samples, as well as determine the subcellular distribution of the biomolecules of interest.

In particular embodiments, the different biological specimens are obtained from different specimens (such as tumors, normal tissue, or biopsy specimens), and in particular examples the different specimens are obtained from different subjects. Information about the biological specimens (such as clinical information about the subject) are correlated with the results of analyzing the images, to obtain relationships between the information and the reaction. For example, the stage of a tumor can be correlated with the presence of a particular biomarker, such as an immunohistochemical (IHC) marker, or gene amplification. The same gene of interest (such as HER-2) can be analyzed at both DNA, RNA and protein level from different samples (or the same sample, with multi-color detection methods) and the results of these molecular analyses correlated with one another. This method is capable of efficiently obtaining many data points, because multiple tests can relatively quickly be performed on multiple similar copies of samples from multiple specimens. For example, if samples from at least 10 different tissue specimens are present in each of at least 10 different sections, and the ten different sections are respectively exposed to 10 different reagents, then 100 data points can quickly be obtained.

The power of this approach is even more evident if one sample is taken from each of 100 different tissue specimens and placed in a three dimensional matrix that is sectioned into 300 sections. There would be 30,000 individual samples in the 300 sections that can be exposed to a variety of biological reagents to detect biomarkers. If 300 samples were taken from each of the 100 different tissue specimens, and placed in 300 different three dimensional matrices that were subsequently sectioned into 300 sections, three million distinct samples would be present in the 90,000 sections that would result. Exposing the 90,000 different sections to many different reagents (such as different probes) rapidly provides a large number of data points from which biological conclusions can be drawn with statistical confidence. Reactions with the biological reagents can also be correlated with clinical information associated with the tissue specimens.

This large scale arraying system can array specimens from a large number of specimens, or a large number of samples from one or more specimens can be arrayed. For example, a multi-tumor array could include hundreds or thousands (for example 5000 or more) different tumors, representing many (for example 135 or more) different types of tumors, and examples of corresponding normal tissue (e.g. 34 different normal tissues of the same type from which the tumors developed). Such an array can provide a template for a systematic and comprehensive analysis of disease genes, molecular alterations, etc. in substantially an entire spectrum of human neoplastic disease. Alternatively, an array of different breast cancer tumors could be made and distributed for molecular and other analyses at different locations, for example throughout a country or even globally.

In a particular embodiment of the method, the specimens are embedded in embedding medium to form tissue donor blocks, which are stored at identifiable locations in a donor array. The donor blocks are retrieved from the donor array, coordinates of particular areas in each of the tissue specimens in the donor blocks are determined, and tissue samples from the donor blocks (such as elongated punches) are retrieved and inserted into receptacles of corresponding size (such as punched holes) in different recipient tissue microarray blocks. After repeating this process with multiple donor blocks, to form a three-dimensional array of substantially parallel elongated samples from a variety of different specimens, the recipient tissue microarray blocks are then sectioned to make multiple similar tissue microarray sections that include samples of many different specimens. Each of these sections can then be subjected to treatment with multiple reagents, and subsequently analyzed for the presence of biological markers. This analysis can be performed by obtaining digital images of each section, or the samples in each specimen, and processing the image to identify specific regions of the section or sample that correspond to the presence of a biological marker, or to determine the amount and distribution of a biological marker that is present in the tissue microarray section. This information can be stored in a database for subsequent analysis and correlation with other information about the specimens and samples (such as clinical stage, or co-alteration of gene copies or expression).

In yet another iteration, the invention is a computer implemented system for rapid construction and analysis of tissue microarray sections, in which a recipient block retriever obtains recipient blocks from a recipient block array, and transfers recipient blocks to a sectioner, which cuts sections from the recipient blocks, and mounts the sections on a solid support. A conveyor transfers the mounted sections to a processor, which processes the samples for biological analysis. An image analyzer obtains images of the tissue microarray sections, and either provides these to a pathologist to interpret or performs quantitative analysis for the presence of biological structures of interest, such as biological markers. A database stores information identifying tissue samples which are analyzed, and also stores information obtained from analysis of tissue microarray sections for correlation with other information available on these cases The computer implemented system can include a plurality of different stations for the sectioner, processor and image analyzer, a conveyor that transports mounted samples between stations, a plurality of robotic arms that expose the mounted sections to biological reagents for biological analysis, and a controller directing the transport of mounted sections to stations, the time that samples remain at individual stations, and the amount of time that sections are exposed to biological reagents.

The multiple recipient blocks can be constructed with corresponding samples at corresponding positions in the array (for example, at the same X-Y or other coordinate positions) because this arrangement facilitates tracking and identification of samples (and the specimens from which they come) in the different recipient blocks. However, the location of the sample in each block can also be randomized, and the sample (and the specimen from which it came) can be tracked, for example by a computer implemented system that associates the location of each sample in the array with a tissue specimen from which the sample was obtained. Alternatively, multiple (for example five or more) samples could be taken from each biological specimen, and placed in random locations in each recipient block. These multiple corresponding specimens could serve as an internal control on the accuracy of the analyzer (either human or automated), because similar results would be expected from the randomly located samples. The array constructor could also include a “scrambling” function in which the arrays are purposefully made with tissue specimens in non-corresponding locations, so that a manual interpreter of the results would not be influenced by the expectation that identical samples will be present at identical locations. Conversely, similar kind of samples from multiple tissues can be placed next to one another for simple visualization of the results at the microscope. Alternatively, multiple samples (e.g. normal and paired tumor tissues) from a given block can be arrayed next to one another in the resulting tissue microarray. The computerized system can keep track of the specimen locations in each array, even if their positions are randomly scrambled. It can then display the data in any order the observer wishes. Different permutations of this and other aspects of the present technology are quite varied.

Moreover, although certain aspects of the disclosed method and device are disclosed as being automated (such as microarray fabrication, sectioning, reagent processing, and image acquisition and analysis), any of these steps can be performed manually, or in other than an automated fashion as described in WO 99/44062 and WO 99/44063, herein incorporated by reference. Certain of these aspects maybe disclosed as automated, and may be used in combination with other of these aspects that are not automated. For example, array construction may be automated, while sectioning and subsequent steps may not be automated. Alternatively, sectioning may be automated, while examination and interpretation of the sections may be performed manually.

The present disclosure also provides an approach for presenting multiple tissue samples to an examiner, in a manner that facilitates review of the samples and can improve uniformity of standards of examination of biological materials, such as histologic or molecular diagnostic examination of tissue specimens. The biological samples are presented in an array, in which the biological materials are at assigned positions which correspond to identifying information about the sample. The arrays can be prepared at a single location, to help avoid differences in procedures for preparing the biological material that can affect subsequent interpretation of results and tissue diagnosis. All of the biological materials can be simultaneously subjected to diagnostic or other techniques (such as exposure to histologic stains and molecular markers) that will also diminish differences that can produce discordant results. In particular embodiments, multiple substantial copies of each of the arrays is provided, for distribution to multiple recipients. The multiple substantial copies can be provided either by sectioning a substrate into which the biological samples have been placed, and/or by photographic or digital duplication and transmission.

The array can provide a relatively fast and convenient approach for examination of a large number of tissue specimens under substantially identical conditions by one or more persons, who can provide a much more uniform interpretation of results than is possible with multiple examiners at multiple locations. The resulting arrays also provide an important teaching tool that can be used by trainers and trainees to more conveniently display and examine large numbers of biological specimens under a microscope. Diagnostic interpretation of the samples in the array can also be normalized, to provide a standard set or guidelines for the interpretation of a given staining pattern that then can be used as a more uniform instruction to trainees and for the quality control of clinical assays.

In one embodiment of the method, a plurality of biological samples are provided at identifiable positions in the array, and the samples are subjected to a biological analysis. The biological analysis is usually performed after the samples are placed in the array, although the analysis can be performed prior to placement of the sample in the array. The array is then examined to detect a biological, histological or clinical marker, such as (a) the presence of a histologic sign of disease (e.g. cellular atypia or pyknotic nuclei) or (b) the presence of a molecular marker (such as an immunohistochemical marker or a nucleic acid probe) which is specifically bound to a substrate in the biological sample. The biological samples in the array may be samples of different tissue specimens (such as samples from many different tumors), or multiple samples from a single tissue specimen (for example to assess tissue homogeneity or heterogeneity). Alternatively, the biological samples in the array can include samples from different tissue specimens, as well as multiple samples from a single tissue specimen (for example, multiple copies of normal tissue as an internal control). This allows standardization of the molecular results from different sections of the same array or between multiple tissue microarray blocks that have different samples, but the same references included. The multiple substantial copies of the array can be subjected to the same biological analysis (such as immunohistochemical staining or molecular probing), or to different biological analyses, for example at a single location or at multiple different locations. The biological analysis may be performed, for example with a specific binding agent, such as an antibody or a nucleic acid probe, which substantially only or specifically recognizes and binds to a biological substrate of interest.

The multiple sections obtained from multiple tissue samples may vary slightly from one another. This variability may be due to the fact that the tissue morphology varies slightly from one location to another, or from the fact that the morphology changes as one cuts sections through the tissue microarray block. This variability can be controlled, for example by only including in the analysis donor blocks that have sufficient quantities of representative tumor areas, and blocks that have sufficient “depth” with representative tissue material. In addition, one would not need to include in array construction a particular case after the useful tissue area is used up. Variation in section morphology can be controlled by evaluating the morphology of the sections after a morphological stain, such as hematoxylin-eosin staining. This will enable the observer to determine which sections are likely to be representative.

In one embodiment, one can study the degree of intra-tumor heterogeneity of a biomolecule by acquiring a plurality of sections (for example, about 10, about 100, about 1000, or about 10,000 sections) from a given set of tumors, and testing a staining for the biomolecule in any number of these sections, such as at regular intervals (for example, about every 5th, 10th, 50^{th}, 100^{th} or 500^{th} section) from each tissue microarray block constructed.

In one embodiment, the multiple substantial copies of the array are obtained by providing elongated samples, substantially parallel to one another, at identifiable locations in a substrate, and sectioning the substrate. At least one of the multiple substantial copies may be subjected to a reference biological analysis, and multiple substantial copies are disseminated to one or more others to subject the copies to the same biological analysis, and compare the results of the same biological analysis to the reference biological analysis. This embodiment allows purchasers of test kits (such as kits containing IHC or nucleic acid probes) to perform an analysis and compare their results to a standard. If the purchaser obtains a different result, then modifications can be made in the purchaser's techniques until the purchaser's result conforms to the result shown in the standard.

Alternatively, the substantial copies (array sections) can be disseminated to different researchers who can all perform the same or different biological analyses on the uniformly prepared tissue, and who can compare the results of their biological analyses to the reference biological analysis.

The substantial copies (e.g. different sections) of the array can be used for a broad variety of additional purposes. When the array is used for quality control purposes, an interpretation of the same biological analysis performed by different researchers can be compared to a reference interpretation of the reference biological analysis. For example, the comparison can determine whether a reagent used by the different researchers performs comparably to a reagent used in the reference biological analysis. When the array is used for training purposes (for example with medical students or pathology residents), the trainees can indicate a proposed interpretation of the biological analysis, and the proposed interpretation is compared to a reference interpretation of the reference biological analysis. In some embodiments, the trainees are test takers, who are graded by comparing the proposed interpretation to the reference interpretation. The reference interpretation need not be the interpretation of a single individual, but can instead be obtained by combining an interpretation of multiple referees. The trainess can also evaluate images, not the actual sections. The trainee can also be a computer controlled program/imaging system that is calibrated to give the same interpretation from a given set of tissue microarrays as a panel of experts.

The array which has been subjected to the biological analysis may be disseminated to multiple viewers at multiple locations, for example in electronic form, such as through a communication channel or a computer readable medium. The communication channel may be a global communication system, such as the INTERNET (for example as an attachment to an e-mail), and the computer readable medium may be a CD-ROM, DVD-ROM, or any other optical, magnetic or other data storage medium.

In particular disclosed embodiments, the array may be a microarray, for example in which the plurality of biological samples includes at least 100, 500 or even 1000 or more biological samples placed at identifiable positions in the microarray. The identifiable positions may be coordinates of the array, such as coordinates of a substantially uniform matrix of rows and columns. Identifiers (such as electronic identifiers) can be associated with the array, and diagnoses may be associated with the identifiers. In this manner, a viewer may conveniently immediately determine an interpretation associated with a sample, for immediate confirmation of a correct interpretation or correction of an incorrect interpretation.

The array is particularly suitable for displaying tissue specimens, such as pathology specimens. In some examples, the pathology specimens are neoplastic tissue, non-neoplastic tissue, a combination of neoplastic and non-neoplastic tissue, and/or comparative specimens of different examples in a biological spectrum. For example, the comparative specimens may be different stages in development of a tumor, different types of tumor; and/or different stages in progression of a biologically dynamic tissue (such as uterine endometrial tissue at different days during a menstrual cycle). The samples may also include multiple different types of histological and biological regions of intrerest from a given tissue or tumor, defined by a user.

This disclosure also concerns a method of examining biological samples by placing a plurality of elongated biological samples at identifiable positions in a substrate that is capable of being sectioned, sectioning the substrate to provide a plurality of substantial copies of an array of the biological samples, with the samples at the identifiable positions, identifying one or more reference copies, disseminating one or more dissemination copies to others, and comparing a biological interpretation of one or more dissemination copies to a biological interpretation of one or more reference copies. The reference copies may, for example, be included with a test kit.

The use of such multiple specimens allows one to examine the variability in assaying a particular biomolecule from tissue sections, as well as to continue and minimize such variability. The biological interpretations of one or more dissemination copies may be combined to provide a composite reference copy interpretation (such as testing the variability of tumor grading or stain evaluation by different pathologists and averaging of the grades of a tumor as assigned by an expert panel of pathologists). The biological samples can also be used as a convenient holder for a library of multiple tissue samples, to replace space consuming libraries of slides on which tissue sections are mounted. Information about subjects from whom the samples were obtained can also be associated with each sample, and readily retrieved (for example electronically) so that clinical information (including clinical course) can be linked to the tissue.

In yet other embodiments, the multiple sections (or other copies) are disseminated to different recipients, who indicate an interpretation of the samples in the array, and communicate the interpretation to different recipients or a central source. In this manner, a pooled interpretation of the samples may be obtained from a small or large group of experts. Alternatively, the multiple interpretations thus obtained could be used to determine the extent of variability in interpretation of a particular tumor, disease, or pathologic/histological feature.

The array technology described in this disclosure is versatile, and allows a variety of different biological samples (for example samples from at least 10 different tissue specimens present in each different section) to be exposed to a variety of different biological analyses (for example at least 10 different reagents). Alternatively, the biological samples are obtained from at least 100 different tissue specimens, and are exposed to at least 100 different reagents. Images (such as digital images) of the arrays can be obtained, and the images analyzed, for example by quantifying the reaction with the substrate. The results of the biological analyses can be used for a variety of purposes, such as validating the presence of a particular biomerker in a set of tissues, determining the frequency and clinical associations of such a marker, evaluating a reagent for disease diagnosis or treatment; identifying a prognostic marker for cancer; assessing or selecting therapy for a subject; and/or finding a biochemical target for medical therapy. The biological sample may be a tissue specimen, as well as a hematological or cytological preparation of cells.

### Explanations of Terms

An “annotation”, when used in the context of a region of interest, a tissue sample, a tissue specimen, a tissue section, a tissue microarray, a tissue donor block, or a recipient block, refers to retrievably stored information that relates to the region of interest, the tissue sample, the tissue specimen, the tissue section, the tissue microarray, the tissue donor block, or the recipient block. For example, an annotation may be retrievably stored information regarding the source of a tissue sample; clinical, medical or demographic information about the donor of the tissue specimen; time, manner, location and/or institution in which the specimen was obtained; method of fixation, if any; type of tissue; histological or pathological features observable within the tissue, such as tumor type, tumor grade, acute and/or chronic inflammation, thromboses, or examples of normal (nondiseased) tissue or cells; information that enables location of histological or pathological features; tissue, cellular, or subcellular location and/or quantity of biological markers of interest; location information regarding one or more reference points or indicia in a tissue section, a tissue microarray section, or a tissue donor block; information regarding the distance of one or more reference points or indicia from a region of interest; information that enables location and/or retrieval of other tissue samples, tissue specimens, tissue sections, tissue microarrays, tissue donor blocks, or recipient blocks, that may share one or more features in common with the tissue sample, section, microarray, etc. that is the subject of the annotation. The descriptions of the types of annotations that are possible is intended to be illustrative and not exhaustive. Virtually any type of information may the subject of an annotation. For example, an investigator may hypothesize that the development of a particular type of cancer, or a particular inflammatory or infectious disease, is related to an individual's family history, astrological sign, birthplace, level of education, or exposure to a particular kind of animal. All such information could readily be stored as an annotation associated with the region of interest, tissue sample, tissue section, tissue microarray, tissue donor block, or recipient block. The annotation would then be available for review, and could serve as a tag for locating and/or retrieving tissue specimens, tissue microarrays, regions of interest, etc.

An “array” refers to a grouping or an arrangement, without necessarily being a regular arrangement.

A “biological analysis” or “bioanalysis” is an analytical technique for obtaining biological information about a substrate, such as a tissue specimen. Particular example of such techniques are the use of histological stains (such as H&E), immunohistochemical markers such as labeled antibodies for antigens of interest, and nucleic acid probes for detecting mRNA, DNA and other nucleic acids in the cells. Antibodies and other genetically engineered detection probes, antibodies and reagents can be used. Nucleic acid probes could be used on proteins and antibodies to detect nucleic acid targets.

A “biological marker” is a biomolecule, a biochemical label, or other biological label that identifies a structure or function of interest in a biological specimen.

A “biological substrate of interest” is one or more biological markers which are being observed by an observer.

A “biomolecule” is any molecule which is synthesized in any living cell, or used by living cells in biosynthetic pathways. The term includes, for example, nucleic acids, proteins, carbohydrates, lipids and lipid derivatives, amino acids, nucleotides, nucleosides, prostaglandins, and the like. Additional examples may be found in Stryer, Biochemistry, 4th ed. 1995.

“Cell free analysis” is a subset of biological analysis, in which the biological substrate of interest is partially or completely isolated from a cell prior to observing the biological substrate of interest. The biological substrate of interest may be any biomolecule, or a plurality of biomolecules. Examples of cell free analysis are innumerable, and include DNA sequencing, restriction fragment length polymorphism determination, Southern blotting and other forms of DNA hybridization analysis, determination of single-strand conformational polymorphisms (Sakar et al., Nucleic Acid Res 1992; 20:871-8), comparative genomic hybidization (Kallioniemi et al., Science. 258: 818-21, 1992), mobility-shift DNA binding assays, protein gel electrophoresis, Northern blotting and other forms of RNA hybridization analysis, protein purification, chromatography, immunoprecipitation, protein sequence determination, Western blotting (protein immunoblotting), ELISA and other forms of anybody-based protein detection, isolation of biomolecules for use as antigens to produce antibodies, PCR, RT PCR, differential display of mRNA by PCR (known in the art as differential display; Liang et al., Science 1992;257:967-72), serial analysis of gene expression (U.S. Pat. No. 5,695,537), protein truncation test (Wimmer et al., Human Mutation. 16(1):90-1, 2000; Moore et al., Molecular Biotechnology. 14(2):89-97, 2000; Den Dunnen et al., Human Mutation. 14(2):95-102, 1999). Protocols for carrying out these and other forms of cell free analysis are readily available to those skilled in the art, for example in Ausubel et al., Current Protocols in Molecular Biology, (c) 1998, John Wiley & Sons Ausubel et al., Short Protocols in Molecular Biology, (c) 1999, John Wiley & Sons; Maniatis et al., Molecular Cloning: A Laboratory Manual; and the series of publications known as Methods in Emzymology.

A “communication channel” or “network” is a system, such as the internet, which permits digital dissemination of digital information, such as digital images and test associated with the iamges. An example of such a communication channel is shown in PCT publication WO 99/30264, which discloses a digital telepathology imaging system, and is incorporated by reference.

A “copy” of a section refers to substantial similarity, and not absolute identity.

A “donor block” can include a substrate into which has been introduced solid donor tissue or a cell suspension, or any other biological tissue.

By “polypeptide” is meant any chain of amino acids, regardless of length or post-translational modification (e.g., glycosylation or phosphorylation).

A “gene amplification” is an increase in the copy number of a gene, as compared to the copy number in normal tissue. An example of a genomic amplification is an increase in the copy number of an oncogene. A “gene deletion” is a deletion of one or more nucleic acids normally present in a gene sequence, and in extreme examples can include deletions of entire genes or even portions of chromosomes. Gene amplifications and deletions are examples of variations in gene copy number.

A “genomic target sequence” is a sequence of nucleotides located in a particular region in the human genome that corresponds to one or more specific loci, gene, or specific DNA sequence, including genetic abnormalities, such as a nucleotide polymorphism, a deletion, or an amplification.

A “genetic disorder” is any illness, disease, or abnormal physical or mental condition that is caused or suspected to be caused by an alteration in one or more genes or regulatory sequences (such as a mutation, deletion or translocation).

“Immunohistochemical” (abbreviated IHC) refers to specific binding agents, such as polyclonal and monoclonal antibodies, which recognize and mark antigens of interest, often by a chemical that shows that the agent has bound to the antigen of interest. An example of an IHC agent is HER-2 monoclonal antibody.

A “nucleic acid array” refers to an arrangement of nucleic acids (such as DNA or RNA) in assigned locations in the arrangement, such as that found in cDNA or CGH arrays.

A “microarray” is an array that is miniaturized so as to require microscopic examination for visual evaluation.

A “DNA chip” is a DNA array in which multiple DNA molecules (such as cDNAs) of known DNA sequences are arrayed on a substrate, usually in a microarray, so that the DNA molecules can hybridize with nucleic acids (such as cDNA or RNA) from a specimen of interest. DNA chips are further described in Ramsay, Nature Biotechnology 16: 40-44, 1998, which is incorporated by reference.

Unless indicated otherwise by context, a “tissue specimen” refers to an intact piece of tissue, for example embedded in medium. A “tissue sample” refers to a sample taken from the specimen, or a sectioned portion of the sample. A sample can be either a tissue sample or a sample of other biological material, such as a liquid cellular suspension.

“Comparative Genomic Hybridization” or “CGH” is a technique of differential labeling of test DNA and normal reference DNA, which are hybridized simultaneously to chromosome spreads, as described in Kallioniemi et al., Science 258:818-821, 1992, which is incorporated by reference.

“Gene expression microarrays” refers to microscopic arrays of cDNAs printed on a substrate, which serve as a high density hybridization target for mRNA probes, as in Schena, BioEssays 18:427-431, 1996, which is incorporated by reference.

“Serial Analysis of Gene Expression” or “SAGE” refers to the use of short sequence tags to allow the quantitative and simultaneous analysis of a large number of transcripts in tissue, as described in Velculescu et al., Science 270:484-487, 1995, which is incorporated by reference.

“High throughput genomics” refers to application of genomic or genetic data or analysis techniques that use microarrays or other genomic technologies to rapidly identify large numbers of genes or proteins, or distinguish their structure, expression or function from normal or abnormal cells or tissues.

An observer can be a person viewing a slide with a microscope or an observer who views digital images acquired. Alternatively, an observer can be a computer-based image analysis system, which automatically observes, analyses and quantitates biological arrayed samples with or without user interaction.

A “specific binding agent” is an agent that recognizes and binds substantially preferentially to a biological marker of interest, so that the agent provides potentially useful information about the biological marker. Examples of specific binding agents are polyclonal and monoclonal antibodies for an antigen of interest; proteins and proteins derivatives that interact or bind to to other (for example, calmodulin or a labeled calmodulin derivative;), and nucleic acid probes such as DNA and RNA probes.

The term “tissue” as used herein includes cellular specimens unless the context clearly dictates otherwise. Such cellular specimens include, for example, cervical cell samples, bronchial washings, cell samples obtained by endoscopy, blood cells, bacteria, fungi, yeasts, and the like.

A “tumor” is a neoplasm that may be either malignant or non-malignant. “Tumors of the same tissue type” refers to primary tumors originating in a particular organ (such as breast, prostate, bladder or lung). Tumors of the same tissue type may be divided into tumors of different sub-types (a classic example being bronchogenic carcinomas (lung tumors) which can be an adenocarcinoma, small cell, squamous cell, or large cell tumor).

The singular forms “a” or “an” or “the” include plural referents unless the context clearly dictates otherwise. Thus, for example, reference to “a section” includes a plurality of such sections, and reference to “a biological marker” includes reference to one or more biological marker and equivalents thereof known to those skilled in the art, and so forth.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the present specification, including definitions, will control. In addition, the materials, methods, and examples are illustrative only and are not intended to be limiting.

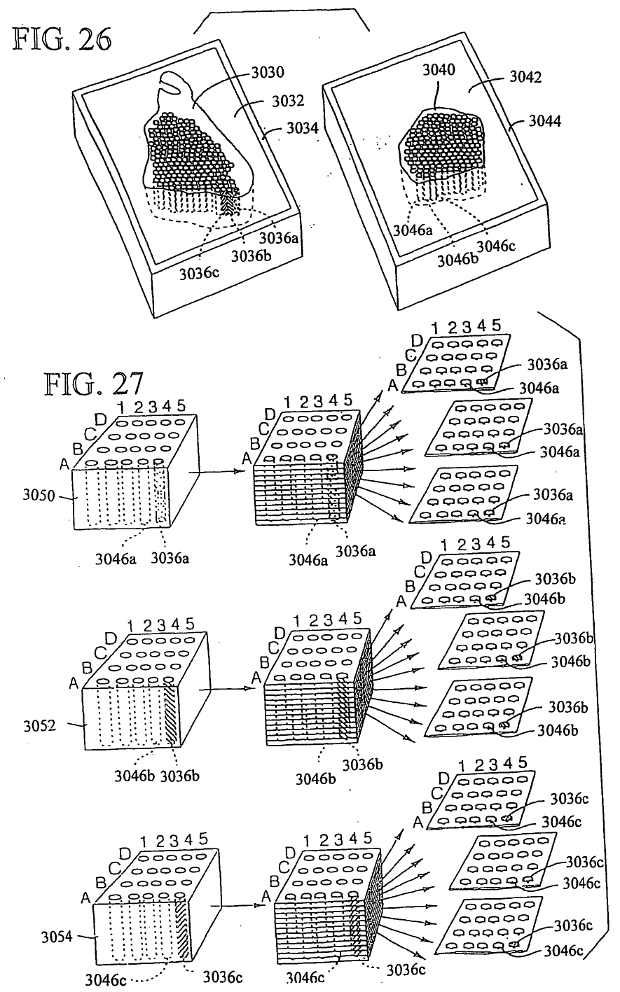

### Overview of Method (FIGS. 26-29)

The present disclosure concerns an automated method and device for manufacturing large numbers of arrays of biological materials, such as tissue specimens, which can be subjected to rapid parallel analysis with a variety of different biological reagents, such as nucleic acid probes and antibodies. This high speed parallel analysis of samples from multiple sources (such as a variety of tumors) permits simultaneous detection of multiple biomarkers in the samples, and further allows correlations to be made about the presence, distribution (between and within tissues, between and within cells in a tissue) and quantity of biomarkers in different samples from different tissue specimens. This enables one to determine the precise population frequency of a biomolecule in a large population sample of a certain type of tissue, and quantitate precise frequencies of molecular alterations, for example molecular alterations of clinical, pathological, or disease-producing significance. This information can further be associated with clinical and demographic information about the subject from whom the tissue was taken (such as tumor stage) or other histological information (such as degrees of cellular atypia in the specimen) to obtain correlations (with high statistical significance). This approach is more fully disclosed in U.S. Provisional Application Nos. 60/106,038 and 60/075,979, and PCT publications WO9944063A2 and WO9944062A1, all of which are incorporated by reference in their entirety.

An overview of the production of microarrays for high throughput parallel and serial biological analysis of large numbers of biological samples, such as samples of tissue specimens, is shown in FIGS. 26-28. Parallel refers to the fact that multiple tissues can be analyzed at once from the same set of tissue specimens. The word “serial” refers to the fact that one can construct literally tens of thousands of tissue microarray sections, and these can be molecularly profiled one at a time to achieve a serial molecular profiling of many biomolecules in each of the tissue specimens on the array. The methods described here for the high-throughput automated arraying increase the speed and efficiency of both the parallel and serial “dimensions” of the tissue microarraying applications. The method also applies to nonautomated tissue microarraying applications.

A tissue specimen 3030 is shown in FIG. 26 embedded in a block of embedding medium 3032, which is carried by a container 3034. Multiple punches of small diameter cylindrical sample cores 3036 of material (for example 0.6 mm in diameter) are taken from specimen 3030 (as illustrated by the small cylindrical openings in specimen 3030). These specimens can come from histologically similar or identical regions of the tumor considered interesting or representative, or from histologically or biologically different regions within each tissue. Although hundreds of similar cylindrical cores of tissue specimen 3030 are removed, for purposes of explanation three such sample cores 3036a, 3036b and 3036c will be discussed. Each of these sample cores 3036a, 3036b and 3036c is differently shaded to help trace them through the method illustrated in FIG. 27. The sample cores could be of any shape or configuration, but are shown as cylinders for ease of illustration.

For purposes of illustration, FIG. 26 also shows a second tissue specimen 3040 embedded in embedding medium 3042, which is carried by a container 3044. Hundreds of small diameter cylindrical sample cores 3046 are also taken from specimen 3040, although for purposes of illustration only three such sample cores 3046a, 3046b and 3046c are labeled. In addition to tissue specimens 3030 and 3040, hundreds or even thousands of different embedded tissue specimens may be available, and one sample or hundreds of cylindrical sample cores are obtained from each of those specimens. However, for purposes of this example, twenty different tissue specimens will be described as available as source material for the array, two of which are illustrated in FIG. 26.

FIG. 27 illustrates three substantially identical different receptacle blocks 3050, 3052, 3054, each of which is made of paraffin or other suitable material, in which twenty cylindrical receptacles have been formed that are complementary in size and shape to the cylindrical sample cores punched or bored from the tissue specimen shown in FIG. 26. The cylindrical receptacles are substantially parallel and form an array in the block, and the array is labeled in FIG. 27 by coordinate positions A, B, C and D along one edge of the block, and 1, 2, 3, 4 and 5 along a perpendicular edge of the block. Hence each of the twenty receptacles in each block 3050, 3052 and 3054 can be uniquely identified as receptacle A5, D1, etc.

Each of the cylindrical cores taken from the tissue specimen is placed in a corresponding position in the different blocks 3050, 3052 and 3054, so that corresponding positions of the array can be more easily identified as corresponding to tissue samples from the same specimen. Hence sample cores 3036a, 3036b and 3036c (all of which were sampled from tissue specimen 3030 in FIG. 26) are inserted in the receptacle array at position A5 in blocks 3050, 3052 and 3054. Similarly, sample cores 3046a, 3046b and 3046c (all of which are sampled from tissue specimen 3040 in FIG. 26) are inserted in the receptacle array at position A4 in blocks 3050, 3052 and 3054. This process is repeated until sample cores are taken from twenty different tumors (not shown in FIG. 26) and placed in corresponding positions of the blocks to form a recipient array of parallel cores in each of the multiple receptacle blocks. Although only three receptacle blocks 3050, 3052 and 3054 are shown in FIG. 27, as many blocks can be used as there are sample cores taken from each of the tissue specimens (which is often hundreds of sample cores).

Once the recipient arrays have been formed in the blocks 3050, 3052 and 3054, the blocks are sectioned (with a sectioner, for example with a microtome). The block section cuts can be placed in many different orientations, but for purposes of illustration they are shown substantially transverse (at a right angle) to the longitudinal axes of the sample cores. The thickness of the block sections can be very small, for example 0.01 mm, so that 300 block sections would be obtained from a sample core that is 3 mm long and 0.6 mm in diameter. Each of the block sections is a substantial copy of the other sections in the array, and the tissue samples at each location in the array are from the same tissue specimen, and generally share common biological characteristics (such as gene or protein expression) that can be ascertained with biomarkers.

For example, block 3050 is sectioned into 300 multiple block sections (only three of which are separately shown in FIG. 27) with specimen core 3036a at position A5. After the block is sectioned, each of the sections retains sample 3036a at position A5 (as shown by the dark color of 3036a in all the views of block 3050). Similarly, each of the sections of block 3052 retains sample 3036b at position A5, and each of the sections of block 3054 retains sample 3036c at position A5. Hence the corresponding positions A5 in the multiple sections will likely share biological characteristics that can be simultaneously analyzed by exposing the multiple different sections to different biological analyses.

Similarly, after the block is sectioned, each of the sections retains sample 3046a at position A4. Each of the sections of block 3052 retains sample 3046b at position A4, and each of the sections of block 3054 retains sample 3046c at position A4. Hence the corresponding positions A4 in the multiple sections will likely share biological characteristics that can be simultaneously analyzed when the multiple different sections are exposed to the different biological analyses.

The results of the biological analyses for the samples at positions A1, A2, A3 . . . D5 can then be recorded, and the results will then allow one to establish the prevalence, distribution and quantity of a biomarker in the set of specimens analyzed. The results of biological analyses can also be associated with clinical or other information that has been collected about each of the specimens. Moreover, biological patterns can be detected from the large number of data points that can be quickly obtained by this method. For example, the same tumor is sampled from multiple sites, the degree of heterogeneity in biomarker expression can be directly ascertained from the tissue microarray analysis. Similarly, variations in gene copy numbers can be detected not only within, but also between the tissue samples, and independent characteristics about these samples can then be reviewed to determine whether variations in the gene copy number can be correlated with clinical or other information that is available about the sample.

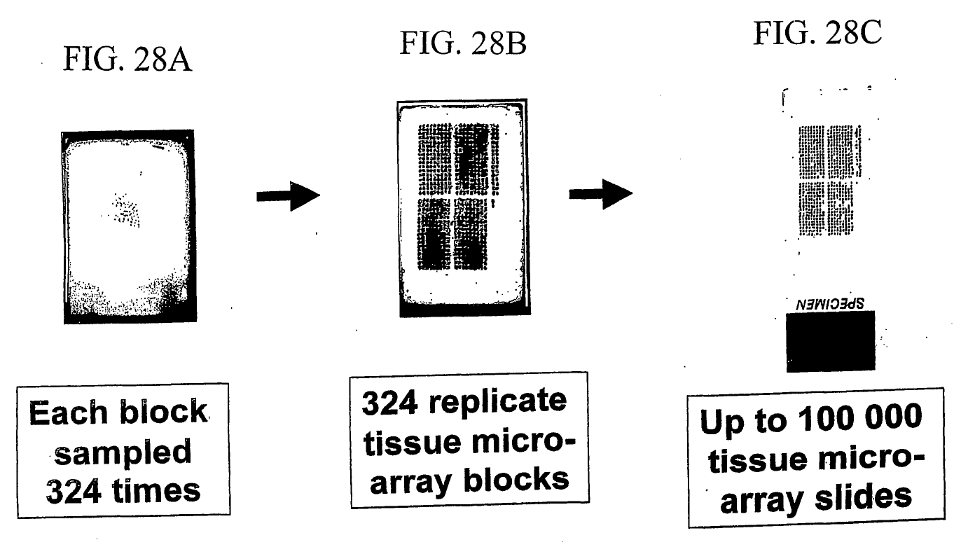

FIG. 28 helps illustrate this concept, by showing in FIG. 28A that 1000 different embedded tissue specimens can each be sampled 324 times (as shown by the 324 small holes in the top tissue specimen). Each of the 324 samples can be placed in 324 different recipient blocks (FIG. 28B). Each of the 324 recipient blocks has 1000 different samples arrayed in the block, each of the 1000 different samples having been obtained from each of the 1000 different tissue specimens. Once each of the 324 recipient blocks is sectioned into 300 sections, 97,200 tissue microarray slides (FIG. 28) are obtained, with each position in the array containing a sample from the same tissue specimen. If each of the 97,200 slides is then subjected to a different biological analysis (such as exposure to a DNA probe) then each of the 1000 different tissue specimens can undergo 97,200 different analyses, and 97,200,000 different data points can be obtained in this example.

The use of 324 samples in this example assumes that the dimension of useful tumor area is 15×15 mm in the block, and that the center to center distance of the sample punches in the tumor is 0.8 mm. Using these dimensions in a theoretical calculation, approximately 100,000 slides could be obtained, which in theory would be sufficient to have approximately one different slide for each gene in the human genome. However, a larger or smaller number of arrays could be made, depending on the size of the useful tumor area, the number of available tissue blocks per subject, and a depth of the original blocks. Although the sample morphology on all of the 100,000 slides will not be identical, the variability within one specimen could be compensated by similar variability in other locations. That is, one could obtain a representative sample of the population of tumors.

Uniformity of tissue morphology in a tissue specimen can also be a factor in determining the number of sample punches taken from a tissue specimen, because substantial changes in the coordinates (for example in X, Y or Z directions) could limit the area from which similar punches could be taken. However, the arrays can also be used for the purpose of taking samples from different areas of the specimen, for example from different tumor containing areas of the specimen. The arrays can also be used to sample different areas having different morphologies, for example by defining multiple types of cells or tissues from each block, and arraying them separately. For example surrounding stroma could be sampled, apart from the tumor itself, or invasive and non-invasive tumor present in the same tissue specimen can be separately sampled, and placed in a single or multiple arrays. Each of the areas from which such tissues are taken can be marked separately in advance, and the automated array can keep track of the origin or designation that is assigned to each sample in the array. It will be recognized that these possibilities are only a few examples of the multiple possibilities and permutations that can be used in association with the array technology disclosed herein.

Alternatively, multiple samples (for example 10-20 samples) may be taken from different sites within each tumor, and biomarkers can be evaluated at each of these sites. The information obtained from such an analysis would provide a comprehensive analysis (such as a quantitative analysis) of the impact of tumor heterogeneity, and could correlate patterns of heterogeneity with prior or subsequent tumor behavior, patient survival, etc.

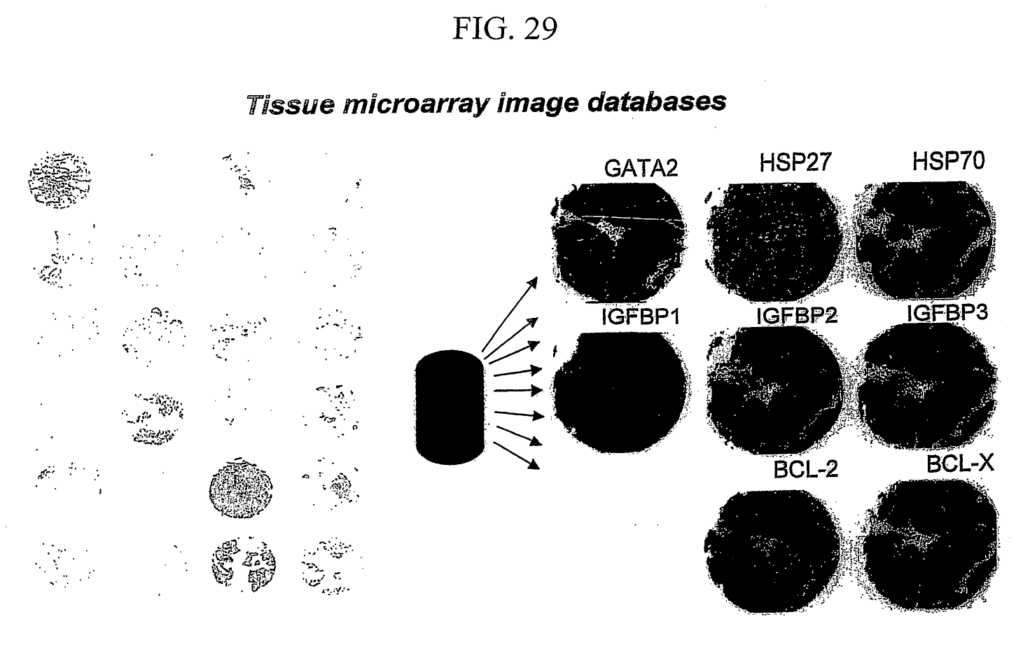

### Image Analysis of the Tissue Microarray Experiments (FIG. 29)

FIG. 29 illustrates how the data points can be obtained by either parallel (left) or serial analysis (right) of tissue microarrays. Serial analysis is achieved by exposing different tissue microarray slides to different immunohistologic markers (although in alternative embodiments nucleic acid probes or many other reagents may be used to detect gene expressions or amplifications). The different microarray slides will contain different sections of a cylindrical tissue sample, which will then react with the nucleic acid probes or antibodies. The microarray slides can then be examined under a microscope, and changes in presence, quantity and distribution of a biomolecule can be accurately determined from each of the arrayed samples. For example, the frequency of a particular gene or gene mutation in a particular tissue type may be determined. The type of biomarker expression can e.g. be membranous, cytoplasmic, nuclear or combinations thereof. It can be uniformly or ununiformly distributed between and within cell types present in the tissues. The images of the samples (such as those shown in FIG. 29) can consist of both “horizontal” or “parallel” (left panel) (X-Y, i.e. different tissue sample spots that have been on the same slide and that have therefore been exposed to the same detection reagent). The parallel dimension allows one to determine the frequency, pattern and quantity of a biomolecule in tissue spots on the same tissue microarray slide. The other dimension is “vertical” or “serial” dimension (right panel) (Z-axis, i.e. the different sections of the same tissue, or multiple different parameters analyzed from the multiple section copies). In the example of a serial application, the same prostate cancer tissue microarray was cut into multiple consecutive sections that were each stained with a different reagent (in this case antibodies to eight gene products suspected to have an importance in prostate cancer). Out of these multiple tissue microarrays, the example here contains images of only a single tumor, which is now profiled with eight different antibodies

Automated or manual image acquisition may be based on collecting images of an entire slide (such as the subsection of the array shown in FIG. 29) or from each spot separately. The latter approach will then enable one to form a database of images that can be displayed either in the original order and position (left panel), in a rearranged manner to display similar types of tumors next to one another, or by displaying multiple different staining results from the same sample (different sections of the same core sample). Based on the example of FIGS. 28A to 28B, one could therefore stain/hybridize up to 100,000 sections from a given set of tumors with different reagents, and acquire images of all the tissue spots. These images could be then rearranged for display in a number of different formats based on the general principles shown in FIG. 29.

Images of the experiments indicated above were acquired with a Zeiss Progress Camera connected to a Zeiss Axiophot camera with a manual XYZ stage. Multiple prostate cancer tissue microarray sections were each stained with a particular antibody according to the manufacturers' instructions. The staining is reflected as a brown immunoperoxidase precipitate. It can be readily distinguished that that the markers mostly had a membranous or cytoplasmic staining. Similarly, nuclear or membranous staining could be distinguished. An image analysis system or a manual observation of the images may now depict the type of staining, the variability of the staining within and between tissue spots, within and in between individual cells in the spots, determine the staining intensity qualitatively, semi-quantitatively (scale 0 to 4, for example) or in a full quantitative analysis of the staining reaction (gray scale values, for example from 1-256, or as a color/hue of the specimens). The imaging system could separately determine the staining reaction in different parts of the spot, such as separately in stromal or carcinoma components. A computer may be used to compare automatically the staining results between adjacent sections of the same tissue microarray with same or different antibodies to form ratios of molecular intensities. Multiple images of the same or different spots could be subjected to an automated multi-parametric analysis, where one could classify tumors based on the intensity, distribution or other features of multiple stainings on consecutive tissue microarray sections.

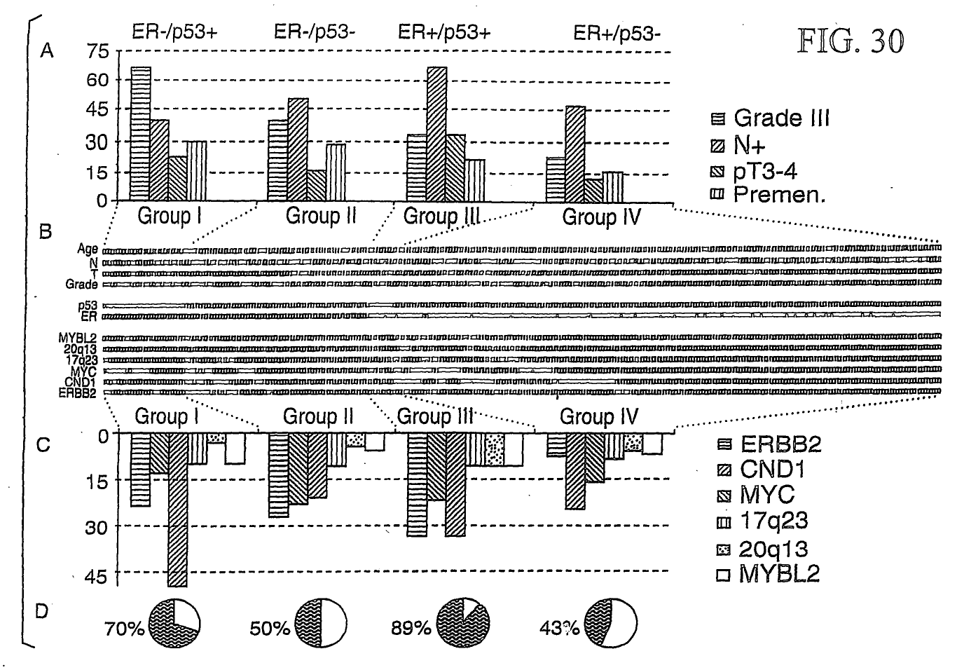

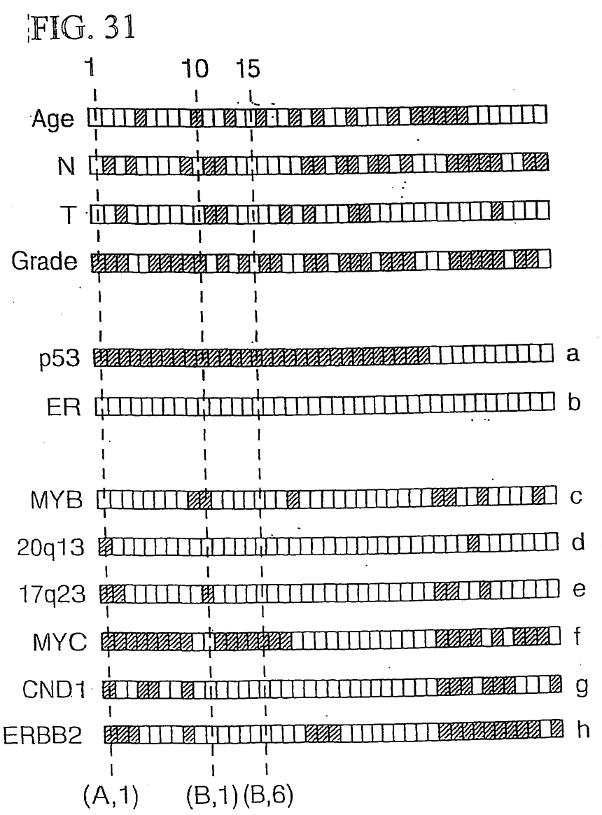

### Overview of Data Correlation in FIGS. 30-31

The potential of the array technology of the present invention to perform rapid parallel molecular analysis of multiple tissue specimens is illustrated in FIGS. 30A-30D, where the y-axis of the graphs in FIGS. 30A and 30C corresponds to percentages of tumors in specific groups that have defined clinicopathological or molecular characteristics. This diagram shows correlations between clinical and histopathological characteristics of the tissue specimens in the micro-array. Each small box in the aligned rows of FIG. 30B represents a coordinate location in the array. Corresponding coordinates of consecutive thin sections of the recipient block are vertically aligned above one another in the horizontally extending rows. These results show that the tissue specimens could be classified into four classifications of tumors (FIG. 30A) based on the presence or absence of cell membrane estrogen receptor expression, and the presence or absence of the p53 mutation in the cellular DNA. In FIG. 30B, the presence of the p53 mutation is shown by a darkened box, while the presence of estrogen receptors is also shown by a darkened box. Categorization into each of four groups (ER−/p53+, ER−/p53−, ER+/p53+ and ER+/p53−) is shown by the dotted lines between FIGS. 30A and 30B, which divide the categories into Groups I, III, m and IV corresponding to the ER/p53 status.

FIG. 30B also shows clinical characteristics that were associated with the tissue at each respective coordinate of the array. A darkened box for Age indicates that the patient is premenopausal, a darkened box N indicates the presence of metastatic disease in the regional lymph nodes, a darkened box T indicates a stage 3 or 4 tumor which is more clinically advanced, and a darkened box for grade indicates a high grade (at least grade III) tumor, which is associated with increased malignancy. The correlation of ER/p53 status can be performed by comparing the top four lines of clinical indicator boxes (Age, N, T, Grade) with the middle two lines of boxes (ER/p53 status). The results of this cross correlation are shown in the bar graph of FIG. 30A, where it can be seen that ER−/p53+ (Group I) tumors tend to be of higher grade than the other tumors, and had a particularly high frequency of myc amplification, while ER+/p53+ (Group III) tumors were more likely to have positive nodes at the time of surgical resection. The ER−/p53− (Group II) showed that the most common gene amplified in that group was erbB2. ER−/p53− (Group II) and ER+/p53− (Group IV) tumors, in contrast, were shown to have fewer indicators of severe disease, thus suggesting a correlation between the absence of the p53 mutation and a better prognosis.

This method was also used to analyze the copy numbers of several other major breast cancer oncogenes in the 372 arrayed primary breast cancer specimens in consecutive FISH experiments, and those results were used to ascertain correlations between the ER/p53 classifications and the expression of these other oncogenes. These results were obtained by using probes for each of the separate oncogenes, in successive sections of the recipient block, and comparing the results at corresponding coordinates of the array. In FIG. 30B, a positive result for the amplification of the specific oncogene or marker (mybL2, 20q13, 17q23, myc, cnd1 and erbB2) is indicated by a darkened box. The erbB2 oncogene was amplified in 18% of the 372 arrayed specimens, myc in 25% and cyclin D1 (cnd1) in 24% of the tumors.

Two recently discovered novel regions of frequent DNA amplification in breast cancer, 17q23 and 20q13, were found to be amplified in 13% and 6% of the tumors, respectively. The oncogene mybL2 (which was recently localized to 20q13.1 and found to be overexpressed in breast cancer cell lines) was found to be amplified in 7% of the same set of tumors. MybL2 was amplified in tumors with normal copy number of the main 20q13 locus, indicating that it may define an independently selected region of amplification at 20q. Dotted lines between FIGS. 30B and 30C again divide the complex co-amplification patterns of these genes into Groups I-IV which correspond to ER−/p53+, ER−/p53−, ER+/p53+ and ER+/p53−.

FIGS. 30C and 30D show that 70% of the ER−/p53+ specimens were positive for one or more of these oncogenes, and that myc was the predominant oncogene amplified in this group. In contrast, only 43% of the specimens in the ER+/p53− group showed co-amplification of one of these oncogenes, and this information could in turn be correlated with the clinical parameters shown in FIG. 30A. Hence the microarray technology of the present invention permits a large number of tumor specimens to be conveniently and rapidly screened for these many characteristics, and analyzed for patterns of gene expression that may be related to the clinical presentation of the patient and the molecular evolution of the disease. In the absence of the microarray technology of the present invention, these correlations are more difficult to obtain.

A specific method of obtaining these correlations is illustrated in FIG. 31, which is an enlargement of the right hand portion of FIG. 30B. The microarray in this example is arranged in sections that contain seventeen rows and nine columns of circular locations that correspond to cross-sections of cylindrical tissue specimens from different tumors, wherein each location in the microarray can be represented by the coordinates (row, column). For example, the specimens in the first row of the first section have coordinate positions (A,1), (A,2) . . . (A,9), and the specimens in the second row have coordinate positions (B,1), (B,2) . . . (B,9). Each of these array coordinates can be used to locate tissue specimens from corresponding positions on sequential sections of the recipient block, to identify tissue specimens of the array that were cut from the same tissue cylinder.

FIG. 31 illustrates one conceptual approach to organizing and analyzing the array, in which the rectangular array may be converted into a linear representation in which each box of the linear representation corresponds to a coordinate position of the array. Each of the lines of boxes may be aligned so that each box that corresponds to an identical array coordinate position is located above other boxes from the same coordinate position. Hence the boxes connected by dotted line 1 correspond to the results that can be obtained by looking at the results at coordinate position (A,1) in successive thin sections of the donor block, or clinical data that may not have been obtained from the microarray, but which can be entered into the system to further identify tissue from a tumor that corresponds to that coordinate position. Similarly, the boxes connected by dotted line 10 correspond to the results that can be found at coordinate position (B,1) of the array, and the boxes connected by dotted line 15 correspond to the results at coordinate position (B,6) of the array. The letters a, b, c, d, e, f, g, and h correspond to successive sections of the donor block that are cut to form the array.

By comparing the aligned boxes along line 1 in FIG. 31, it can be seen that a tumor was obtained from a postmenopausal woman with no metastatic disease in her lymph nodes at the time of surgical resection, in which the tumor was less than stage 3, but in which the histology of the tumor was at least Grade III. A tissue block was taken from this tumor and is associated with the recipient array at coordinate position (A,1). This array position was sectioned into eight parallel sections (a, b, c, d, e, f, g, and h) each of which contained a representative section of the cylindrical array. Each of these sections was analyzed with a different probe specific for a particular molecular attribute. In section a, the results indicated that this tissue specimen was p53+; in section b that it was ER−; in section c that it did not show amplification of the mybL2 oncogene; in separate sections d, e, f, g and h that it was positive for the amplification of 20q13, 17q23, myc, cnd1 and erbB2.

Similar comparisons of molecular characteristics of the tumor specimen cylinder that was placed at coordinate position (B,1) can be made by following vertical line 10 in FIG. 31, which connects the tenth box in each line, and corresponds to the second row, first column (B,1) of the array. Similarly the characteristics of the sections of the tumor specimen cylinder at coordinate position (B,6) can be analyzed by following vertical line 15 down through the 15^{th} box of each row. In this manner, parallel information about the separate sections of the array can be performed for all positions of the array. This information can be presented visually for analysis as in FIG. 31, or entered into a database for analysis and correlation of different molecular characteristics (such as patterns of oncogene amplification, and the correspondence of those patterns of amplification to clinical presentation of the tumor).

In the particular examples above, the staining intensity of FISH result is condensed to the mere presence or absence of a biomarker. However, image analysis techniques, or even semi-quantitative manual scoring can be used to determine the staining intensity with a particular antibody. The same principle applies to quantitation of DNA copy number changes, mRNA in situ hybridization or other molecular analyses. Similarly, statistical analyses could be performed, or the data displayed in a quantitative manner, for example in gray scales, or colors.

Analysis of consecutive sections from the tumor arrays enables co-localization of hundreds of different DNA, RNA, protein or other targets in the same cell populations in morphologically defined regions of every tumor, which facilitates construction of a database of a large number of correlated genotypic or phenotypic characteristics of uncultured human tumors.

The fact that the same tissue can also be analyzed at the gene, mRNA, or protein level, enables the determination of the level of the molecular alteration affecting a particular tissue or tumor. For example, a tumor may have DNA amplification, which leads to increased mRNA ad protein expression. Alternatively it is possible to observe elevation of mRNA expression only, without associated changes in protein level (for example as might occur due to different patterns of protein degradation). Knowledge of the relationships of gene, mRNA and protein will qualitatively and quantitatively enhance understanding tumor biology, development of diagnostics, and defining therapeutic targets. Such multiple determinations are made possible by tissue microarray technology.

Scoring of mRNA in situ hybridizations or protein immunohistochemical staining is also facilitated with tumor tissue microarrays, because hundreds of specimens can be analyzed in a single experiment. The tumor arrays also substantially reduce tissue consumption, reagent use, and workload when compared with processing individual conventional specimens one at a time for sectioning, staining and scoring. The combined analysis of several DNA, RNA and protein targets provides a powerful means for stratification of tumor specimens by virtue of their molecular characteristics. Such patterns will be helpful to detect previously unappreciated but important molecular features of the tumors that may turn out to have diagnostic or prognostic utility. These can be analyzed using multi-parametric tools for analyzing multiple prognostic features (such as Cox regression analysis, or other methods of multiple regression analysis) or by using methods developed for cDNA microarray image analysis (for example, scanner and image analysis software as described in U.S. Pat. No. 6,004,755, herein incorporated by reference in its entirety).

Analysis techniques for observing and scoring the experiments performed on tissue microarray sections include a bright-field microscope, fluorescent microscope, confocal microscope, a digital imaging system based on a CCD camera, or a photomultiplier or a scanner, such as those used in the DNA chip based analyses. The entire slide can either be visualized at once (and then breaking this up to multiple smaller entities) or images may be acquired separately from each tissue spot.

These results show that the very small cylinders used to prepare tissue microarrays can in most cases provide accurate information, especially when the site for tissue sampling from the donor block is selected to contain histological structures that are most representative of tumor regions. It is also possible to collect samples from multiple histologically defined regions in a single donor tissue block to obtain a more comprehensive representation of the original tissue, and to directly analyze the correlation between phenotype (tissue morphology) and genotype. For example, an array could be constructed to include hundreds of tissues representing different stages of breast cancer progression (e.g. normal tissue, hyperplasia, a typical hyperplasia, intraductal cancer, invasive and metastatic cancer). The tissue microarray technology would then be used to analyze the molecular events that correspond to tumor progression.

A tighter packing of cylinders, and a larger recipient block can also provide an even higher number of specimens per array. Entire archives from pathology laboratories can be placed in replicate 500-1000 specimen tissue microarrays for molecular profiling. Using automation of the procedure for sampling and arraying, it is possible to make dozens of replicate tumor arrays, each providing hundreds of sections for molecular analyses. The same strategy and instrumentation developed for tumor arrays also enables the use of tissue cylinders for isolation of high-molecular weight RNA and DNA from optimally fixed, morphologically defined tumor tissue elements, thereby allowing correlated analysis of the same tumors by molecular biological techniques (such as PCR-based techniques) based on RNA and DNA. When nucleic acid analysis is planned, the tissue specimen is preferably fixed (before embedding in paraffin) in an alcohol based fixative, such as ethanol or Molecular Biology Fixative (Streck Laboratories, Inc., Omaha, Nebr.) instead of in formalin, because formalin can cross-link and otherwise damage nucleic acid. The tissue cylinder of the present invention provides an ample amount of DNA or RNA on which to perform a variety of molecular analyses.

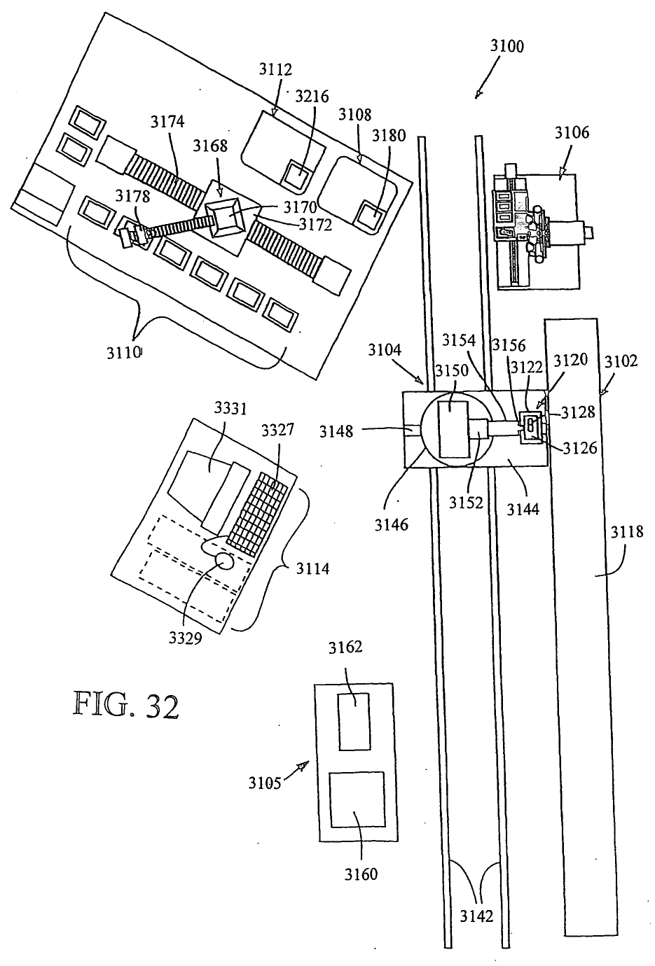

### Embodiment of FIGS. 32-45

An example of an automated system for high speed preparation of the microarrays is shown in FIGS. 32-45. An overview of the system is illustrated in FIG. 32, which shows an automated apparatus 3100 for preparing tissue specimens for analysis in microarrays. The apparatus includes a specimen source 3102, a retriever 3104 that retrieves tissue specimens from assigned locations in specimen source 3102, and a detector 3105 that locates a position of a tissue specimen within a specimen block and labels the specimen block with a computer readable identifier. Apparatus 3100 further includes a constructor 3106 that removes tissue samples from different tissue specimens and arrays the tissue samples in recipient blocks, a sectioner 3108 that sections the blocks into sections, a reagent station 3110 to which the sections are exposed, a scanner 3112 for scanning the sections after they have been exposed to the reagents and obtaining digital images of the sections (and the component samples in the sections), and a controller 3114. The controller 3114 automatically controls the other components of apparatus 3100, and records the identification of a subject associated with a particular specimen, including clinical information about the subject.

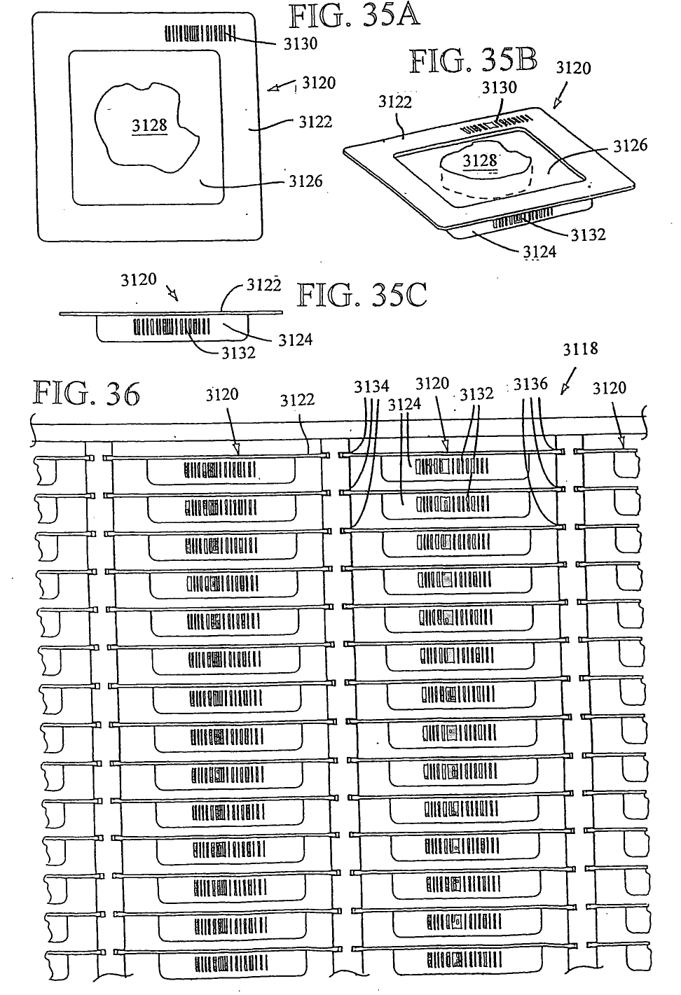

A particular embodiment of specimen source 3102 is shown in greater detail in FIG. 33, which illustrates it as a cabinet 3118 divided into many compartments that are arranged in columns and rows. Each of the compartments can be assigned a coordinate (e.g., x-y) identifier, so that a position of each of the compartments corresponds to a particular coordinate position within the columns and rows of compartments. As shown in FIGS. 35 and 36, each of the compartments is occupied by a specimen holder 3120, which is formed by a peripheral flange 3122 and a recessed bottom 3124 that forms a central cavity which contains embedding medium 3126 that contains a tissue specimen 3128, such as a surgical pathological specimen of a tumor removed from a subject. A top surface of flange 3122 is labeled with a first computer readable bar code identifier 3130, and a side wall of bottom 3124 is labeled with another copy of the computer readable bar code identifier 3132.

As illustrated in FIG. 36, each compartment of cabinet 3118 includes a pair of opposing, parallel slots 3134, 3136 which receives the lip of peripheral flange 3122 to hold each specimen holder 3120 in place within an assigned compartment. This arrangement allows each holder 3120 to be slid into the compartment by aligning the edges of flange 3122 with the slots 3134, 3136 and pushing the holder into the compartment. Alternatively, the holder 3120 can be removed by pulling on it so that it slides along slots 3134, 3136 until the holder is disengaged from the compartment.

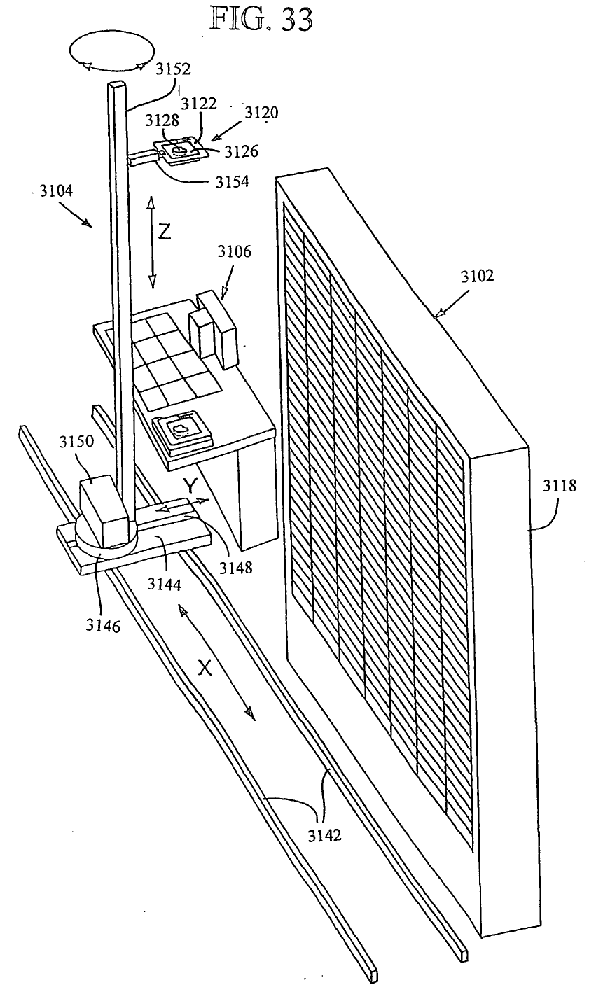

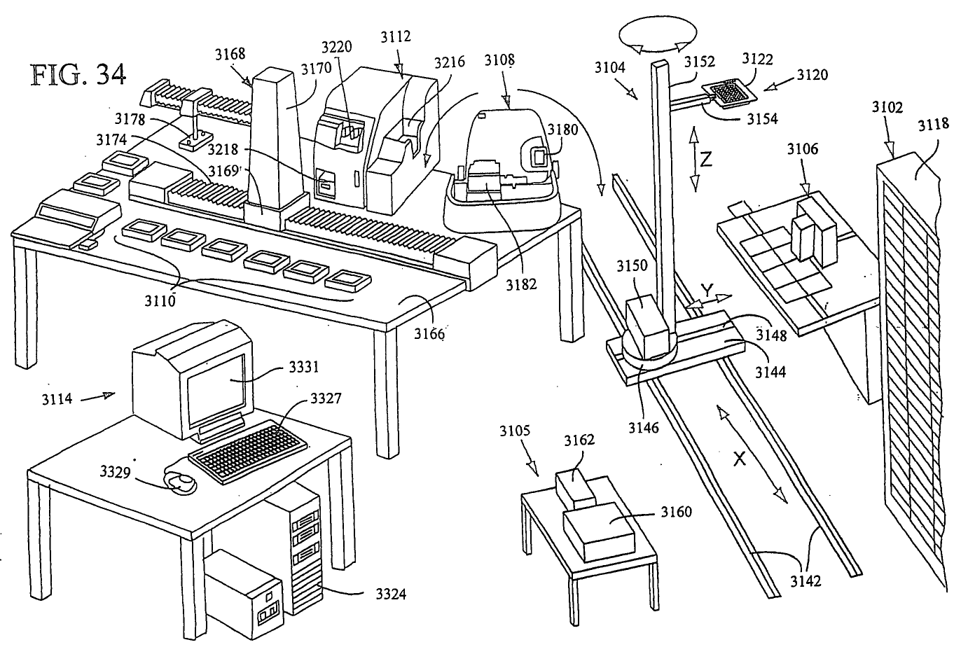

Holders 3120 can be inserted into or removed from the compartments of cabinet 3118 by the retriever 3104 (FIG. 32), which in the disclosed embodiment is a robotic transporter (FIGS. 33, 34 and 37), which moves along a track 3142 in an X direction, and which travels among the stations of apparatus 3100, and permits the robotic arm access to all of the stations that it must reach. The robotic transporter includes a base 3144 which supports a rotatable turntable 3146, which in turn moves transverse to rails 3142 (in a Y direction) along a guide channel 3148. Mounted on turntable 3146 is a motor 3150 which moves retriever 3104 along rails 3142, rotates turntable 3146, and moves turntable 3146 in the Y direction along channel 3148. Retriever 3104 also includes an upright standard 3152 mounted on turntable 3146, and a retractable/extendible arm 3154 that projects from standard 3152. Arm 3154 moves up and down standard 3152 (in the Z direction illustrated in FIGS. 33 and 34). Retriever 3104 therefore is capable of retrieving holders 3120 from compartments of cabinet 3118, and moving them in all three directions of movement (X, Y and Z) among the stations of apparatus 3100.

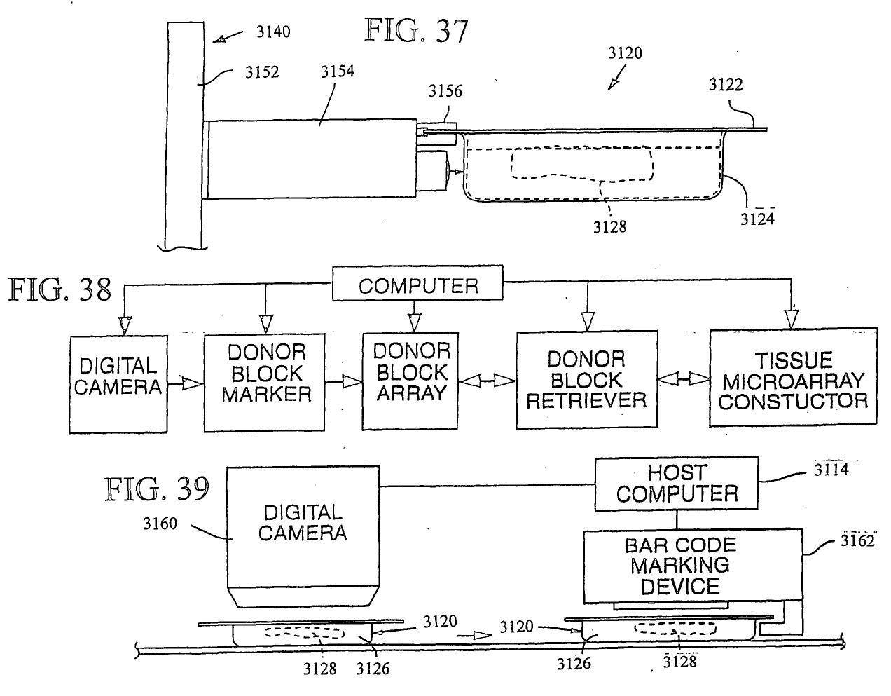

FIG. 37 illustrates an interaction between retriever 3104 and holder 3120. In this view, retractable arm 3154 is shown fully retracted. At a free end of arm 3154 is carried a clasp 3156 with upper and lower jaws that fit above and below a front edge of flange 3122 that is exposed when holders 3120 are in place within the compartments of cabinet 3118. Below clasp 3156 is an optical reader 3157 that is capable of reading bar codes displayed on a front of holder 3120, and sending signals to controller 3114 to identify tissue specimens contained in a holder.

FIGS. 32, 34 and 39 also illustrate a detector station, which includes a digital camera 3160 and a bar code marker 3162. As best illustrated in FIG. 39, digital camera 3160 is capable of obtaining a digital image of tissue specimen 3128 embedded in medium 3126, to assign coordinates (such as x-y coordinates) to the outlines of specimen 3128 with reference to a field defined by a surface of embedding medium 3126 in holder 3120. Alternatively, an operator could locate and mark (either by demarcating a region on the slide, or storing coordinates in a computer memory) regions of interest on the slide. This information could be electronically stored, to enable subsequent automated punching of samples from the tissue specimen. Coordinates within this region could subsequently be changed from “available” to “punched” once a sample has been punched from a site, such that a puncher would not subsequently attempt to obtain an additional sample from this site. Hence the region of interest defines a field within which potential donor sites are available.

Tissue microarray constructor 3106 is shown in FIGS. 32-34 and is discussed in greater detail in association with FIGS. 41-45 later in this specification.

Sectioner 3108 is located on a table 3166 (FIGS. 32 and 34), which also holds reagent station 3110 and scanner 3112. Also on table 3166 is a robotic transporter 3168 that can access all the stations on the table. Transporter 3168 is of the type shown in U.S. Pat. No. 5,355,439, which is incorporated by reference. Briefly, the robotic transporter includes an upright standard 3170 that is pivotally mounted on a base 3172 that is capable of moving on elongated track 3174. A cantilevered arm 3176, which projects from near the top of standard 3170, includes serrations along which a slide holder 3178 is capable of moving.

Sectioner 3108 on table 3166 (FIGS. 32 and 34) is an automated, high speed microtome that includes an input port 3180 into which recipient blocks can be placed, and an output port 3182 (FIG. 34) from which sections of the recipient blocks are retrieved. An example of an automated microtome that could be used is found in U.S. Pat. No. 5,746,855, which is incorporated by reference. Reagent station 3110 includes a series of reagent trays (such as solutions that contain nucleic acid probes or other markers for performing biological analyses such as detection of gene copy number alterations). An incubator setup for performing certain experiments as well as a washing station for removing unbound reagent, may be provided.

Scanner 3112 on table 3166 can be a scanner such as that shown in PCT publication WO 98/44333, which is incorporated by reference, and commercial embodiments available from Chromavision Medical Systems, Inc. of San Juan Capistrano, Calif. Most commercial microscopic imaging systems can be utilized for this purpose. Modifications may include automated stage capable of X-Y scanning and Z-axis autofocusing. A manual, user-defined image acquisition is also possible. Images may be acquired using a CCD camera, which may be computer controlled. Alternatively, the scanner can be a confocal scanner, such as described in U.S. Pat. No. 6,084,991. A Phosphorimager or a scanner of radioactive film (see Kononen et al., Nature Medicine 4: 844-847, 1998), can be used for quantitation of radioactive signal intensities, such as in mRNA in situ hybridization.

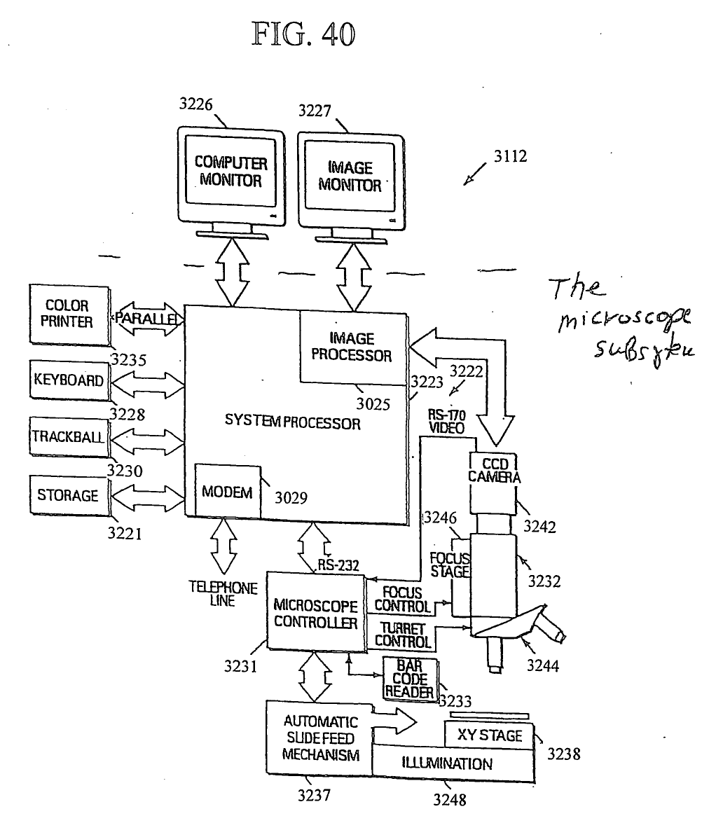

FIG. 40 shows a block diagram which illustrates scanner 3112, which includes a microscope subsystem 3232 housed in scanner 3112. The scanner includes a slide carrier input hopper 3216 and a slide carrier output hopper 3218. A housing secures the microscope subsytem from the external environment. A computer subsystem includes a computer 3222 having a system processor 3223, an image processor 3225, and a communication modem 3229. The computer subsystem further includes a computer monitor 3226 and an image monitor 3227 and other external peripherals including storage device 3221, track ball device 3230, keyboard 3228 and color printer 3235. An external power supply 3224 is also shown for powering the system.

Viewing oculars 3220 of the microscope subsystem project from scanner 3112 for operator viewing, although the system can be automated. Scanner 3112 further includes a CCD camera 3242 for acquiring images through the microscope subsystem 3232. A microscope controller 3231 under the control of system processor 3223 controls a number of microscope-subsystem functions. An automatic slide feed mechanism 3237 in conjunction with an X-Y stage 3238 provides automatic slide handling. An illumination light source 3248 projects light on to the X-Y stage 3238 which is subsequently imaged through the microscope subsystem 3232 and acquired through CCD camera 3242 for processing in image processor 3225. A Z stage or focus stage 3246 under control of microscope controller 3231 provides displacement of the microscope subsystem in the Z plane for focusing. The microscope subsystem further includes a motorized objective turret 3244 for selection of objectives. This example is a bright-field microscope, but fluorescence micsorcopes and imaging systems may be similarly utilized.

Scanner 3112 permits unattended automatic scanning of prepared microscope slides for the detection of candidate objects of interest, such as particular cells which may contain marker identifying reagents, and evaluation of the amount of the reagent that is present. Scanner 3112 automatically locates candidate objects of interest present in a biological specimen on the basis of color, size and shape characteristics. Grades indicative of the amount of marker (such as a nucleic acid probe) are determined and summed to generate a score for the biological specimen. When the marker is a probe signal (as in fluorescent in situ hybridization or FISH) signal counting can be performed as in U.S. Provisional Patent application No. 60/154,601, which is incorporated by reference. This score may be used to evaluate whether the biological specimen contains a biological marker of interest. The system described in U.S. Provisional Patent Application No. 60/154,601 also includes description of a fluorescence microscope imaging system, which is widely applicable to analysis of other types of fluorescent stains.

An alternative example of signal counting and scoring would be performed as follows. Unattended scanning of slides is prompted by loading of the slides onto motorized X-Y stage 3238. A bar code label affixed to each slide maybe read by a bar code reader 3238 to identify each slide during this loading operation. Each slide may be scanned at a low magnification, for example 20×, to identify potential samples that may display a positive signal (such as a FISH or IHC signal). After the low magnification is completed, the apparatus automatically returns to each candidate object, focuses at a higher magnification, such as 60×, and captures a digitized image for further analysis to confirm the object candidate. The degree of resolution required may depend on the type of analysis to be performed. If it is desirable to obtain information on the cellular or subcellular localization/distribution of the biomolecule, a high resolution is desirable. Quantitation of the overall fluorescence intensity or staining intensity in a tissue spot requires very little resolution, such as that obtained by a Phosphorimager used for radioactive detection.

A centroid for each confirmed cell candidate is computed and stored for evaluation of the marker. The marker can be the staining precicipate itself, or it can be a counter-stain. Scanner 3112 then returns to the centroid for the first confirmed candidate object of interest and captures a color image of an area centered about the centroid. The pixel data for this area is processed to determine the amount of marker (for example as determined by intensity or hue of a color) in the area and a grade is assigned to the object. Scanner 3112 continues processing and grading areas centered about other confirmed candidate objects of interest until a predetermined number of objects have been processed. An aggregate score is then computed from the grades for the predetermined number of objects. The object grades, aggregate score and images may then be stored in storage device 3221, such as a removable hard drive or DAT tape, which communicates with controller 3114. The stored images are available in a mosaic of images for further review. Alternatively, detected images can also be viewed directly through the microscope using oculars 3227.

The images can be scanned in a variety of ways, for example by acquiring a montage image of the entire slide, and breaking it up into smaller segments each representing a single or multiple tissue spots or fractions thereof, or by acquiring a low-resolution scan of the slide, and then performing a high-resolution scan of each sample spot one at a time. This set of images could be subjected to morphological and image analytical tools to assess the quantity of immunostaining, based on the amount of staining present (as determined for example by intensity of the immunostain). This assessment could be based on the entire area in each sample spot, or by analysis of those regions in each tissue spot that contain tumor tissue, or other tissue of interest. The specific combination and strategy for image acquisition and analysis by a variety of factors, such as the number of specimens on the slide, their size, the type of staining or reagent system (brightfield or fluorescence), the number of parameters to be evaluated from the slide, the degree of automation required, the degree of resolution required, availabiliuty of autofocussing, CCD camera specifications, the desired instrumentation (microscope based, laser scanning, radioactive detection etc.).

An imaging system not only acquires images from a microscope slide, but may also archive, display, and analyze the images and incorporate data in a database. For example, the imaging system can display consecutive images on a computer screen for an observer to analyze, interpret and store. Alternatively, the program can pre-process images to display areas of positive staining, and present an image to the observer for approval. Completely automated image acquisition and analysis is possible. The image of a biomolecular marker detection may be compared with the corresponding Hematoxylin-Eosin stained morphological image (obtained from the same or nearby section) to verify that representative regions of the specimen are being evaluated.

### Operating Environment for Controller (FIG. 46)

An exemplary operating environment for system controller 3114 is shown in FIG. 46 and the following discussion is intended to provide a brief, general description of a suitable computing environment in which the invention may be implemented. The invention is implemented in a variety of program modules. Generally, program modules include routines, programs, components, data structures, etc. that perform particular tasks or implement particular abstract data types. The invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring to FIG. 46, an operating environment for an illustrated embodiment of the present invention is a computer system 3320 with a computer 3322 that comprises at least one high speed processing unit (CPU) 3324, in conjunction with a memory system 3326, an input device 3328, and an output device 3330. These elements are interconnected by at least one bus structure 3332.

The illustrated CPU 3324 is of familiar design and includes an ALU 3334 for performing computations, a collection of registers 3336 for temporary storage of data and instructions, and a control unit 3338 for controlling operation of the system 3320. The CPU 3324 may be a processor having any of a variety of architectures including Alpha from Digital; MIPS from MIPS Technology, NEC, IDT, Siemens and others; x86 from Intel and others, including Cyrix, AMD, and Nexgen; 680x0 from Motorola; and PowerPC from IBM and Motorola

The memory system 3326 generally includes high-speed main memory 3340 in the form of a medium such as random access memory (RAM) and read only memory (ROM) semiconductor devices, and secondary storage 3342 in the form of long term storage mediums such as floppy disks, hard disks, tape, optical disks, CD-ROM, DVD-ROM, flash memory, etc. and other devices that store data using electrical, magnetic, optical or other recording media The main memory 3340 also can include video display memory for displaying images through a display device. Those skilled in the art will recognize that the memory 3326 can comprise a variety of alternative components having a variety of storage capacities.

The input and output devices 3328, 3330 also are familiar. The input device 3328 can comprise a keyboard 3327, a mouse 3329, a scanner, a camera, a capture card, a limit switch (such as home, safety or state switches), a physical transducer (e.g., a microphone), etc. The output device 3330 can comprise a display 3331, a printer, a motor driver, a solenoid, a transducer (e.g., a speaker), etc. Some devices, such as a network interface or a modem, can be used as input and/or output devices.

As is familiar to those skilled in the art, the computer system 3320 further includes an operating system and at least one application program. The operating system is the set of software which controls the computer system's operation and the allocation of resources. The application program is the set of software that performs a task desired by the user, using computer resources made available through the operating system. Both are resident in the illustrated memory system 3326.

For example, the invention could be implemented with a Power Macintosh 8500 available from Apple Computer, or an IBM compatible Personal Computer (PC). The Power Macintosh uses a PowerPC 604 CPU from Motorola and runs a MacOS operating system from Apple Computer such as System 8. Input and output devices can be interfaced with the CPU using the well-known SCSI interface or with expansion cards using the Peripheral Component interconnect (PCI) bus. A typical configuration of a Power Macintosh 8500 has 72 megabytes of RAM for high-speed main memory and a 2 gigabyte hard disk for secondary storage. An IBM compatible PC could have a \Pentium PC with 1 Ghz processor with 526 Mb of RAM, 20-200 Gb of hard disk space. An exemplary Apple Macintosh may have a G4 600 MHz processor, 526 Mb of RAM, and 20-200 Mb disk drive. Both may also house additional storage media, such as optical drives, CD-ROM (re-writable) and DVD-ROM, as well as backup systems.

In accordance with the practices of persons skilled in the art of computer programming, the present invention is described with reference to acts and symbolic representations of operations that are performed by the computer system 3320, unless indicated otherwise. Such acts and operations are sometimes referred to as being computer-executed. It will be appreciated that the acts and symbolically represented operations include the manipulation by the CPU 3324 of electrical signals representing data bits which causes a resulting transformation or reduction of the electrical signal representation, and the maintenance of data bits at memory locations in the memory system 3326 to thereby reconfigure or otherwise alter the computer system's operation, as well as other processing of signals. The memory locations where data bits are maintained are physical locations that have particular electrical, magnetic, or optical properties corresponding to the data bits.

Particularly preferred data storage would be on optical disks, CD-R, CD-RW, or DVD-ROMs. A tissue microarray storage requirement is often about 2 Gb per slide when images are acquired with a high-resolution CCD camera. This will take half of the available storage space on a DVD-ROM. Compression of images may be required for storage of images or displaying them for observer at the time of image interpretation or future review.

### System Operation

The operation of the system is best illustrated in FIGS. 32-34. Specimen holders 3120 are placed in cabinet 3118 of specimen source 3102 by inserting the peripheral flange 3122 of each holder 3120 into opposing slots of each compartment. The position of each specimen in the matrix of compartments is recorded, and associated with identifying information (such as patient identity and clinical information) about tissue specimen 3030 in the holder. Each holder 3120 may be retrieved from its compartment by retriever 3104, which moves along rails 3142 to position standard 3152 in front of a first column of compartments in cabinet 3118. Arm 3154 is then extended, until the jaws of clasp 3156 are positioned above and below a front lip of peripheral flange 3122 of holder 3120, and the clasp is actuated to grip the peripheral flange. Arm 3154 is then retracted to pull holder 3120 from its compartment, transporter 3104 then rotates on turntable 3146 as it travels down rails 3142 in the X direction toward detector station 3105.

Once transporter 3104 has reached detector station 3105, arm 3154 is moved in the Z and Y directions to position holder 3120 below digital camera 3160. The digital camera then obtains a digital image of specimen 3128 in embedding medium 3126, and determines x-y coordinates of specimen 3128 relative to holder 3120 which are recorded by controller 3114. Holder 3120 is then transported by arm 3154 to bar code marker 3162, where computer readable bar code labels 3130, 3132 (see FIG. 35) are applied to the top flange 3122 and side face of holder 3120. These bar code labels are uniquely associated with the holder from a particular compartment in the cabinet 3118, which is in turn associated with identifying information about the specimen in the holder (including the location of specimen 3128 in holder 3120).

Holder 3120 is then retrieved from station 3105 (FIGS. 32 and 34 above) by transporter 3104, and may be returned to an assigned compartment in cabinet 3118 (such as the compartment from which it had been previously retrieved). Alternatively, transporter 3104 can convey the holder, to which the bar codes have been applied, to constructor station 3106 where samples are removed from the sample in the holder and placed in recipient blocks (such as blocks 3050-3054 in FIG. 27 above). The operation of constructor station 3106 is more fully described in association with FIGS. 41 above-45 above.

After each recipient block is formed, it is placed back in the labeled holder 3120, which is lifted by arm 3154 off of constructor station 3106. Transporter 3104 then rotates, and empties the recipient block in tray 3120 into input port 3180 (FIGS. 32 above and 34 above) of sectioner 3108. The block is sectioned, each of the sections is mounted on a rigid support (such as a glass slide) that is labeled with a bar code which corresponds to the bar code on holder 3120 from which the block came. The sections are then retrieved by robotic transporter 3168, and exposed to bioanalysis reagents in reagent station 3110 (such as solutions that contain nucleic acid probes for informative biological markers). Exposure to various reagents can be performed, for example, as described in U.S. Pat. No. 5,355,439, which is incorporated by reference. Once these reactions have been performed, each section is then transported by robotic transporter 3168 to input hopper 3216 of automated scanner 3112, where each section is scanned to determine whether any of the samples on the section provide biologically useful information. For example, the scanner would determine whether a color change has occurred that would indicate hybridization of a nucleic acid probe to the sample, and would quantify such a color change to determine changes in gene copy number.

In addition to sectioning, the tissue microarray constructor may obtain samples of tissues for cell free analyses. For example, the presence or expression of a gene or mutant gene may be determined in a tissue sample by a broad range of of cell free techniques known in the art, such as protein immunoblotting, immunoprecipitation, Northern blot, RT PCR, single-strand confirmational polymorphism, serial analysis of gene expression, differential display and the like. Tissue samples may be obtained from a particular type of normal or diseased tissue, to perform a cell free analysis of one or more biomarkers in that tissue. For example, one may obtain a tissue sample or series of samples from a particular type of carcinoma to perform serial analysis of gene expression, differential display, or other high throughput analysis of gene expression.

Tissue samples may also be obtained from specific regions of interest (ROI) in a tissue specimen. The samples of the region of interest may then be used in a cell free analysis of one or more biomarkers. Tissue samples from similar or dissimilar regions of interest may be pooled if desired, for cell free analysis of biomarkers or biomolecules in the pooled tissue. Such analysis may help to define the molecular nature of a region of interest. For example, comparisons of mutations and/or gene expression could be made between ROIs representing invasive carcinoma and ROIs representing carcinoma in situ. As another example, comparisons could be made between ROIs representing different stages of development of an atheroma in a blood vessel. As another example, comparisons could be made of different stages of development in a particular tissue (e.g., in utero development of a mouse heart, comparisons of heart muscle obtained from young and old subjects, etc.). In this way, molecular changes associated with tissue or organ development or aging could be investigated. The same kinds of analysis may of course be performed on tissue specimens without obtaining samples from specific regions of interest. However, performing these analyses on specific regions of interest may considerably enhance sensitivity, specificity and/or utility of observations.

Digital images of the samples on each section, or at least samples that are determined to be of interest, are then stored in controller 3114 for future reference. The stored information may include the actual image itself, as well an any quantitative data acquired from the image. This information is incorporated into a database, and could later be retrieved and examined for correlation between clinical findings and biological findings in the digital images. The biological findings can be automatically determined. Alternatively, the images can be scored by a pathologist or other examiner, by calling up the electronic images to score on a screen, rather than at a microscope. The examiner can click on a menu which provides possible interpretations, save the data, and move on to the next image. In this manner, a large number of tissue samples, for example samples from a large number of specimens from different subjects, can be quickly scored.

The sections themselves may be returned to compartments in cabinet 3118, or discarded. Hence the entire operation can be automated, and performed continuously, for high throughput analysis of many thousands of slides in a single day. This automated apparatus therefore obtains potentially millions of data points about the reactions of different samples on different slides from different tissue specimens with different reagents, which can then be analyzed. The parallel analysis of many different data points permits an appreciation of previously unrecognized biological associations between different tissue specimens (such as gene amplifications in tumors of similar stage or grade). Previously unrecognized differences between different tissue specimens can also be demonstrated, such as changes in gene copy number at different stages of tumor progression.

### Operation of the Tissue Microarry Constructor (FIGS. 41-45)

An example of an automated tissue microarray constructor 3106 is shown in FIGS. 41-45. Constructor 3106 includes a stage 3364 having an x drive 3366 and a y drive 3368, each of which respectively rotates a drive shaft 3370, 3372. The shaft 3372 moves a specimen bench 3374 in a y direction, while the shaft 3370 moves a tray 3376 on bench 3374 in an X direction. Mounted in a front row of tray 3376 are three recipient containers 3378, 3380 and 3382, each of which contains a paraffin recipient block 3384, 3386 or 3388, and a donor container 3390 that contains tissue specimen 3030 in embedding medium 3034. In a back row on the tray is a discard container 3392.

Disposed above stage 3364 is a punch apparatus 3394 that can move up and down in a Z direction. Apparatus 3394 includes a central, vertically disposed, stylet drive 3396 in which reciprocates a stylet 3398. Apparatus 3394 also includes an inclined recipient punch drive 3400, and a inclined donor punch drive 3402. Punch drive 3400 includes a reciprocal ram 3404 that carries a tubular recipient punch 3406 at its distal end, and punch drive 3402 includes a reciprocal ram 3408 that carries a tubular donor punch 3410 at its distal end. When the ram 3404 is extended (FIG. 42), recipient punch 3406 is positioned with the open top of its tubular bore aligned with stylet 3398, and when ram 3408 is extended (FIG. 44), donor punch 3410 is positioned with the open top of its tubular bore aligned with stylet 3398.

The sequential operation of the apparatus 3394 is shown in FIGS. 42-45. Once the device is assembled as in FIG. 41, a computer system (such as controller 3114) can be used to operate the apparatus to achieve high efficiency. Hence the computer system can initialize itself by determining the location of the containers on tray 3376 shown in FIG. 41. The x and y drives 3366, 3368 are then activated to move bench 3374 and tray 3376 to the position shown in FIG. 42, so that activation of ram 3404 extends recipient punch 3106 to a position above position (1,1) in the recipient block 3384. Once punch 3406 is in position, apparatus moves downward in the Z direction to punch a cylindrical bore in the paraffin of the recipient block. The apparatus 3394 then moves upwardly in the Z direction to raise punch 3406 out of recipient block 3384, but the punch 3406 retains a core of paraffin that leaves a cylindrical receptacle in the recipient block 3384. The x-y drives are then activated to move bench 3374 and position discard container 3392 below punch 3406. Stylet drive 3396 is then activated to advance stylet 3398 into the aligned punch 3406, to dislodge the paraffin core from punch 3406 and into discard container 3392.

To receive the paraffin core, discard container 3392 may have an open top, or a closed top with holes 3393 of inside diameter slightly larger than the punch outside diameter. Punch 3406 is lowered into hole 3393, stylet 3398 is depressed and released, and punch 3406 raised so distal end of punch is just slightly above discard container 3392. X-y drives 3396, 3398 move the bench (which includes discard container 3392 so the punch tip is no longer over the hole and any paraffin stuck to the punch tip is knocked off. Discard container contains multiple holes 3393 for different size punches.

Alternatively, paraffin core from recipient block can be inserted into donor block in a location from which a tissue sample had been previously extracted. This can provide additional structural strength to the donor block when many punches are taken from the same general area of a specimen.

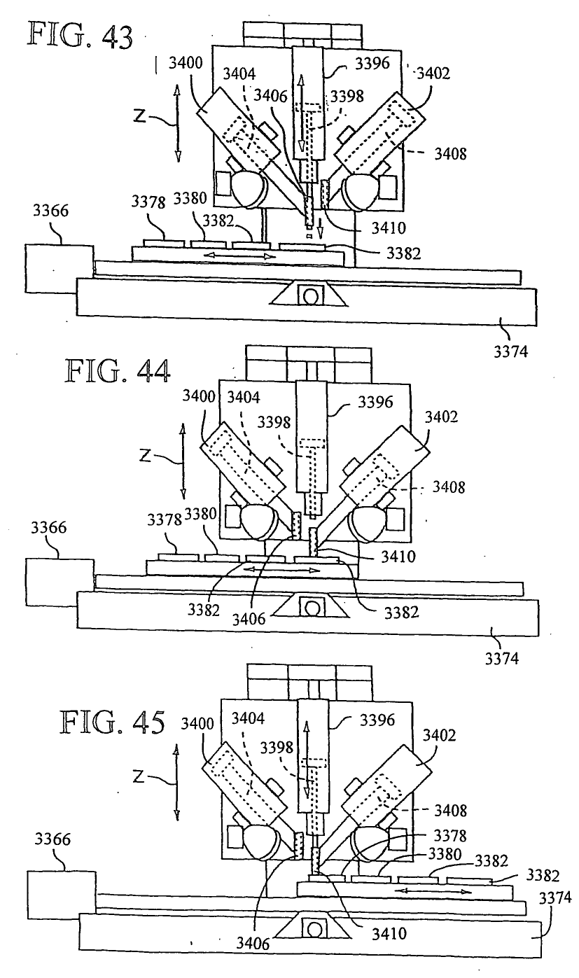

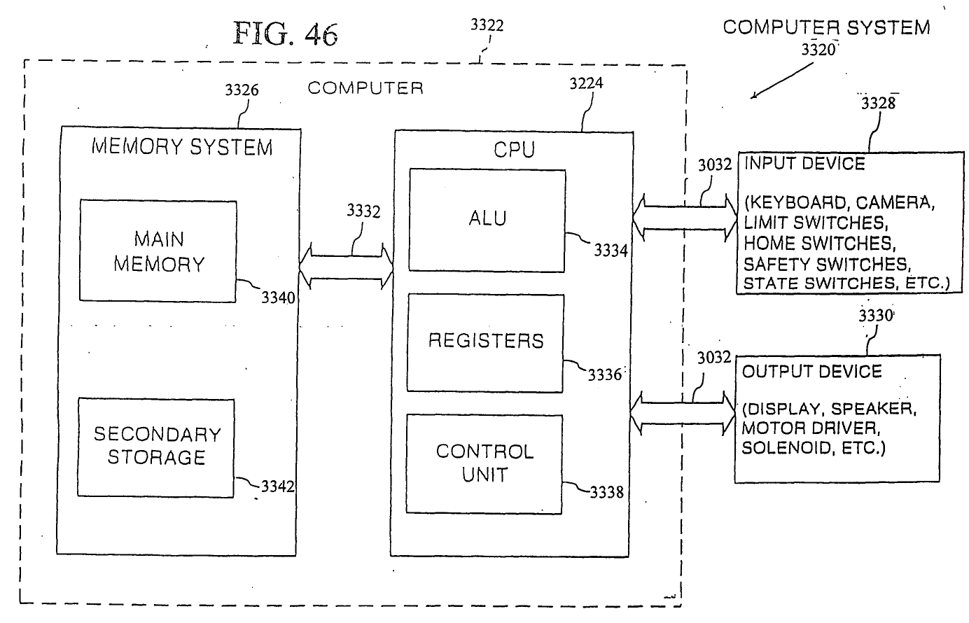

Stylet 3398 is retracted from recipient punch 3406, ram 3404 is retracted, and the x-y drive moves bench 3374 and tray 3376 to place donor container 3390 in a position (shown in FIG. 43) such that advancement of ram 3408 advances donor punch 3410 to a desired location over the donor block 3034 in container 3390. Apparatus 3394 is then moved down in the Z direction (FIG. 44) to punch a cylindrical core of tissue sample out of the donor block 3034, and apparatus 3394 is then retracted in the Z direction to withdraw donor punch 3410, with the cylindrical tissue sample retained in the punch. The x-y drive then moves bench 3374 and tray 3376 to the position shown in FIG. 45, such that movement of apparatus 3394 downwardly in the Z direction advances donor punch 3410 into the receptacle at the coordinate position (1,1) in block 3384 from which the recipient plug has been removed. Donor punch 3410 is aligned below stylet 3398, and the stylet is advanced to dislodge the retained tissue sample cylinder from donor punch 3410, so that the donor tissue cylinder remains in the receptacle of the recipient block 3386 as the apparatus 3394 moves up in the Z direction to retract donor punch 3410 from the recipient array. Ram 3408 is then retracted.

This process can be repeated until a desired number of recipient receptacles have been formed and filled with cylindrical donor tissue samples at the desired coordinate locations of the array. Although this illustrated method shows sequential alternating formation of each receptacle, and introduction of the tissue cylinder into the formed receptacle, it is also possible to form all the receptacles in recipient blocks 3384, 3386 and 3388 as an initial step, and then move to the step of obtaining the tissue samples and introducing them into the preformed receptacles. The same tissue specimen 3030 can be repeatedly used, or the specimen 3030 can be changed after each donor tissue specimen is obtained, by introducing a new donor block 3034 into container 3390. If the donor block 3034 is changed after each tissue cylinder is obtained, for example, each coordinate of the array will include tissue from a different tissue specimen.

One or more recipient blocks 3384 can be prepared by placing a solid paraffin block in container 3378 and using recipient punch 3106 (FIGS. 42-43) to make cylindrical punches in block 3384 in a regular pattern that produces an array of cylindrical receptacles. The regular array can be generated by positioning punch 3406 at a starting point above block 3384 (for example a corner of the prospective array), advancing and then retracting punch 3406 to remove a cylindrical core from a specific coordinate on block 3384, then dislodging the core from the punch by introducing a stylet into opening 3407. The punch apparatus or the recipient block is then moved in regular increments in the x and/or y directions, to the next coordinate of the array, and the punching step is repeated.

Any or all of the operation of a tissue microarray constructor may be controlled by a controller such as a computer. This includes any and all of the processes illustrated in FIGS. 41-45. The controller may, for example, control movement of stage 3364 by controlling x drive 3366 and y drive 3368; control operation and alignment of punch apparatus 3394, such as controlling location of punch sites and depth of punch sites; control operation of stylet 3398 to eject tissue sample and/or paraffin core; control detection and proper positioning of donor and recipient blocks; control placement of tissue sample into an assigned receptacle in recipient block 3386; control operation and alignment of discard container 3392 with stylet 3398 and punch 3406. Other functions which may be controlled by the controller include detection of damaged punches, and detection of block surfaces in relation to punch.

The controller allows an operator to completely design an array for automated construction by the tissue microarray constructor. An operator can specify construction of an array by indicating, for example: the specific donor tissue specimen to be sampled; the region of interest in the donor tissue specimen to be sampled; location of donor tissue specimen placement in recipient block; and size, shape, and regularity of the microarray, for example the total number of rows and columns of tissue specimens in the recipient block.

In the specific disclosed embodiment, the cylindrical receptacles of the array have diameters of about 0.6 mm, with the centers of the cylinders being spaced by a distance of about 0.7 mm (so that there is a distance of about 0.05 mm between the adjacent edges of the receptacles). Although the diameter of the biopsy punch can be varied, 0.6 mm cylinders have been found to be suitable because they are large enough to evaluate histological patterns in each element of the tumor array, yet are sufficiently small to cause only minimal damage to the original donor tissue blocks, and to isolate reasonably homogenous tissue blocks. Up to 1000 such tissue cylinders, or more, can be placed in one 20×45 mm recipient paraffin block. Specific disclosed diameters of the cylinders are 0.1-4.0 mm, for example 0.5-2.0 mm, and most specifically less than 1 mm, for example 0.6 mm. Computer-guided placement of the specimens allows very small specimens to be placed tightly together in the recipient block's array of receptacles. For example, a 0.4 mm punch diamater would allow construction of an array with 0.5 mm center to center distance between specimen cores, thereby increasing the number of specimens that can be obtained from a 15×15 mm tissue area to 900.

FIG. 28B shows the array in the recipient block after the receptacles of the array have been filled with tissue specimen cylinders. The top surface of the recipient block may be covered with an adhesive film from an adhesive coated tape sectioning system (Instrumedics) to help maintain the tissue cylinder sections in place in the array once it is cut. The array block may be warmed at 37° C. for 15 minutes before sectioning, to promote adherence of the tissue cores and allow smoothing of the block surface when pressing a smooth, clean surface (such as a microscope slide) against the block surface.

### Marking and Obtaining Regions of Interest in a Tissue Sample

Tissue samples generally contain multiple cell types. For example, a sample which contains a breast cancer may often have regions of surrounding stroma and connective tissue as well as a typical and normal epithelial tissue, in addition to regions of in situ (noninvasive) carcinoma or invasive carcinoma. Inflammatory cells, such as infiltrating lymphocytes and other leukocytes are common, as are areas close to necrotic regions. The cancer components of the tumor may have a varying degree of differentiation, or other morphological differences. The stromal, connective tissue and a typical and normal appearing epthelium may have subtle genetic differences or they may be having reactive changes to the growth factors, inflammation etc. produced by the tumor. Depending on the particular application of the microarray technology, the region of interest (ROI) may be any of these regions or all of these regions. Indeed, it is possible and usually desirable to define multiple histologic and pathologic features in a sample. Thus, a ROI is any subset of a tissue sample or tissue section which contains any feature or features to be imaged, examined or studied. The ROI subset may be the entire tissue sample or the entire tissue section, or any portion or portions of the tissue sample or tissue section.

It is often desirable to have tissue samples used in construction of a microarray marked to define one or multiple ROIs. The tissue microarray constructor's controller may be used to guide the tissue microarray constructor to obtain tissue samples from these ROIs, and place the ROI tissue samples into a recipient block microarray.

To accomplish this, the ROI is determined and marked in a manner that allows future automated retrieval of a tissue sample from the ROI. The marking method may include two separate stages. The first stage provides a method for ROI marking of a slide image (or any other image of the tissue donor block) and storing the information either in a standalone file or a database. The second function provides a method for regenerating the ROI perimeters using the stored information from the stage, and generating tissue microarrayer punch locations within the ROI. Each stage can be enhanced to provide the user more options and flexibility.

Determining and Marking Regions of Interest

Regions of interest (ROIs) within a tissue sample or specimen are determined, for example, by examining a section from a tissue donor block. An optical or digital image of the section is acquired through any suitable method (for example a high-speed CCD camera attached to a microscope), and ROIs are marked by an observer. Alternatively, ROIs may be marked on a digital image of the tissue specimens. The location of the ROIs are represented digitally as data points that can be stored and later used to regenerate perimeters of the ROIs.

Methods for marking ROIs are provided. For example, an observer may use a pen to manually mark a ROI in a sample on a microscope slide. A digital image of the sample is obtained, and the user may trace over the lines defining the ROI. Alternatively, detection of the ROI lines may be automated. If there are no markings present to identify the ROI, the user identifies ROIs on an image and marks them directly, for example marking digitally on a digital image. The user can annotate the ROIs with tissue type or other properties, characteristics, or instructions. These annotations can be automatically linked with the recipient tissue microarray block to which tissue from the ROI is transferred.

Once a digital image of an ROI is obtained, an estimate of the amount of tissue available in each ROI can be calculated, for example by multiplying a visible top surface area of tissue by an anticipated or measured depth of the specimen. The number of punches which can be extracted from each ROI can be calculated, by dividing the calculated volume of available tissue by a volume of each punch. By referring to annotations, the total amount of a particular kind of tissue in a tissue donor block, or in the entire tissue donor block array, can also be calculated.

Additional approaches to defining the ROI may make use of such features as distance from a particular distinctive area. The distinctive area may be a necrotic area, a tumor-stromal boundary, or any observable feature. Immunostaining or in situ hybridization or other biological reagent could be used to stain a section of a microarray, and then target the correponding region in a block for tissue microarray construction. For example, tissue microarrays could be constructed from regions that stain negative and positive for a particular immunostain, such as estrogen receptor-positive and estrogen-receptor negative regions.

Additional information is included to provide accurate marking information independent of the marked perimeters, scaling and orientation. This additional information can be provided by the use of indicia such as reference points. The use of such external reference marks aids in correcting for the effects that derive from the expansion, contraction and other morphological distortion that accompanies the sectioning of a tissue block, as well as the staining, and fixation of the tissue section on the slide. An indicium such as a reference point is in approximately the same position in the original tissue block as it is in a slide representing the same tissue block. For example, if a slide were placed on top of the source tissue block in the appropriate orientation, the indicia or reference points of the block would align with those on the slide.

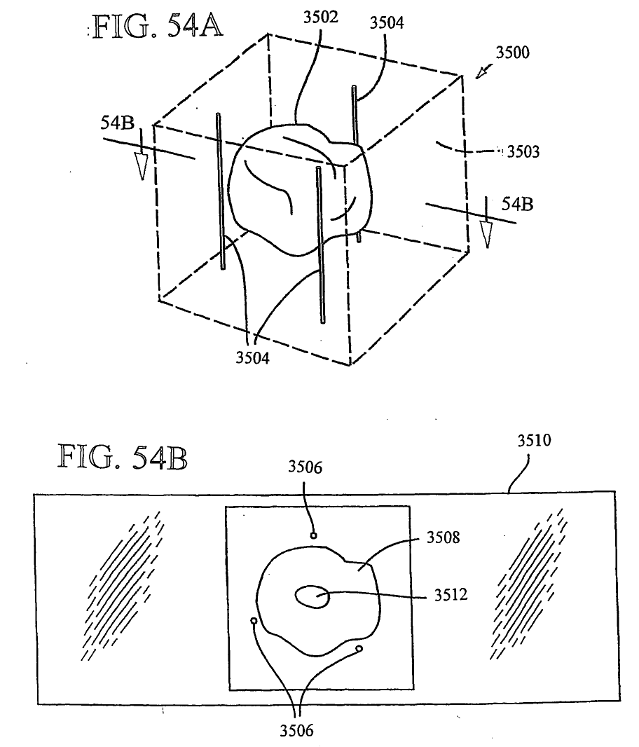

Such alignment may be achieved, for example, as illustrated in FIG. 54A by embedding an indicium or indicia in a tissue donor block 3500 before sectioning. The embedded indicia or reference points 3504 may be fluorescent, magnetic, or in some other way distinctive from the surrounding tissue 3502 and block substrate material 3503, to facilitate detection in subsequent construction of tissue microarrays. The examples of indicia in FIG. 54A are elongated, and extend through block 3500 in a direction that intersects the direction of the section cuts through block 3500. As illustrated in FIG. 54B, the indicia or reference points 3506 are sectioned during sectioning of the tissue donor block, and maintain substantially the same position with respect to the tissue section 3508 on a slide 3510 as they have to the tissue sample in the tissue donor block. The ROI perimeter 3512 may then be defined, and stored if desired, as a function of distance from the reference points. As an alternative, the reference points may not maintain a same position with respect to a tissue, but may vary in a predictable manner on different sections that allows the reference points to help locate ROIs or other structures in the tissue.

Reference points may be used to control for scaling and orientation. For example, the ROI may have been originally marked on an image much larger than the actual size of the tissue in the tissue donor block. In addition, the section used to define the ROI may be mounted on the slide in any rotational orientation. If the stored digital image information includes reference point information (including the actual distance between them in the tissue donor block), both scaling and orientation can be readily accounted for prior to taking a new sample for microarray construction.

Information on ROIs in tissue donor blocks can be stored in a database. In addition to the ROI perimeters and reference point information, the database could include substantial annotations, including patient demographic data, nature of disease process or tumor, characteristics of the ROI (for example, a region of well-differentiated carcinoma, invasive poorly differentiated carcinoma, etc.). Other information in the database could include, for example, location of the tissue donor block in a tissue donor block array, location of the sample in the recipient array, and/or location of the recipient block array. The reference points can be composed of any material, such as human or animal tissues, cells or other biological material, either stained or unstained. It may include stains embedded in any medium. Stains could be bright-field or fluorescent. Stains may be mixed with an appropriate medium chemically or they may be beads that are embedded in the material made into a reference point format.

The reference points may be, for example, inserted to the vicinity of the tissue before sections are obtained. A convenient method is drilling, punching or otherwise inserted in a paraffin block after the block has been fully processed.

Obtaining a Sample from a Region of Interest

Given the stored coordinates of the ROI, the tissue microarray constructor extracts a tissue sample from the ROI in a tissue donor block (as described in Operation of the Tissue Microarray Constructor, above). The tissue microarray constructor deposits the sample from the ROI in a specified location in a recipient block.

To accomplish this task, the tissue microarray constructor can use at least two microarray constructor reference points, of known separation distance and known angle in reference to the arrayer coordinates. If the absolute coordinates of one of the two microarray constructor reference points is known, and the microarray constructor reference points are placed in the field of view of an imaging system associated with the tissue microarray constructor, the microarray constructor reference points appear in the same image as the tissue donor block.

The tissue microarray constructor's imaging system can also detect at least two tissue donor block reference points (for example, embedded in paraffin in the tissue donor block). The imaging system detects the microarray constructor and donor block reference points, and delivers the information to the controller which electronically retrieves the stored ROI information, and regenerates the ROI perimeters given the known identity of the tissue donor block and its reference point locations. The distance between the reference points on the block image is compared to the distance between the reference points on the slide image (which is stored along with ROI information). The comparison yields a scaling factor which can be used to scale all the ROI saved information and display it in the correct scale on the block image. The controller generates the desired punch locations inside the ROIs and translates these punch locations to the tissue microarray constructor. The punch then obtains the sample and places it into a recipient block microarray (as described in Operation of the Tissue Microarray Constructor, above).

The conveniences of being able to move punch locations around, delete certain punches, mark certain punches as undesired, add punches, etc. are also provided to the user at this stage. Changes that occur to the tissue donor block due to tissue extraction are stored in the database. Consequently, if the tissue at a certain location was extracted and deposited in a recipient block, then information about the position of extraction is stored in the database to substantially prevent a user from attempting to mark the same position for extraction at a later point.

A minimum of two donor block reference points can be used to accurately reconstruct the ROI perimeters. More than two donor block reference points, for example three or more reference points, may enhance the accuracy with which the ROI is located during subsequent microarray construction. Having three or more reference points in the tissue donor block also ensures that if a reference point is lost during sectioning, two or more would remain on the slide to assist in the block marking process. It is possible to derive multiple different regions within a block. High-resolution imaging of a slide combined with accurate alignment with the block would allow sub-millimeter accuracy in the region of the punch for tissue microarray construction.

Recipient Array Design

Scaling information enables estimates of tissue quantities of a specific tissue type to be calculated. An array of similar or different tissue types may be composed by defining the layout or arrangement of the array within the recipient block (for example a 4 by 6 subarray of a particular tissue type, a 5 by 5 array of a different tissue type, etc.). The punching properties are specified for both the tissue donor block and the recipient block. For example, the punch size and punch spacing may be specified for both tissue donor block and recipient block. The database can be examined to determine which tissue donor blocks satisfy the request along with information on where to extract tissue and how much to extract from each individual tissue donor block. Once tissue is extracted, the database is updated, for example to include information on amount and location of tissue removed from the tissue donor block, and tissue location information within the recipient array.

Database queries can be submitted remotely, and an operator does not need to be physically near the tissue microarray constructor. Construction of tissue microarrays can be entirely automated, and does not require operator intervention other than defining the ROI and specifying the composition of a particular microarray.

Additional information regarding regions of interest is presented in Example 19: Regions of Interest.

### Reagent Station

Once recipient tissue microarray blocks are sectioned by sectioner 3108, and the tissue microarray sections are mounted onto microscope slides, they may be prepared for a variety of subsequent analyses. These analyses may include, for example: detection of tissue micro-structure with, for example, hematoxylin/eosin (H&E) staining; detection of specific gene expression at the mRNA level with, for example, in situ hybridization; detection of specific gene expression at the protein level with, for example, immunohistochemistry (IHC); detection of genetic abnormalities at the DNA level, with, for example, fluorescence in situ hybridization (FISH); detection of specific enzymatic activities in tissues, with, for example, histochemistry (e.g., NADPH diaphorase histochemistry to detect nitric oxide synthase activity); and detection of apoptotic cell death, with, for example, TUNEL assay. Any other staining that can be done on regular sections can be done on tissue microarray sections.

Each of these analyses can be performed with a specific series of steps performed in a defined order, often with a need for precise timing. For example, paraffin embedded tissue microarray sections may be prepared for subsequent immunohistochemical analysis by incubation at 37° C., followed by xylene treatment (two changes, three minutes each); rehydration by passing through graded alcohols (two changes, absolute ethanol, three minutes each, followed by two changes, 95% ethanol, three minutes each); followed by a water rinse.

After preparation, the sections are incubated for a defined period of time (typically 30 minutes to two hours) with a dilute solution of antibody (for example, antibody ER ID5, anti-human estrogen receptor monoclonal antibody from DAKO, Glostrup Denmark, at 1:400 dilution in phosphate buffer saline (PBS)+3% bovine serum albumin (BSA)). The slide is washed three times with PBS, a secondary antibody is applied (for example, biotinylated anti-mouse IgG, 1:1000 dilution in PBS+3% BSA for 30 min), the slide is washed with PBS, avidin-biotinylated horseradish peroxidase complex is applied for thirty minutes, and the slide again washed with PBS. In this example, the presence of estrogen receptor in tissue microarray sections may be detected by applying diaminobenzidine solution to the slide, and observing the slide for the presence of brown color. The intensity and distribution of the colorimetric reaction may be quantified by image analysis.

The present invention includes a series of individual reaction chambers at reagent station 3110 (FIGS. 32 and 34) at which such timed steps are performed. A conveyor or robotic arm moves the tissue microarray sections between the reaction chambers according to instructions delivered by the controller 3114 of this computer implemented system. After individual section of the blocks emerge from output port 3182 of sectioner 3108, robotic transporter 3168 can individually deliver different sections to different reagent trays in reagent station 3110. The processing may include washing, fixing and embedding a section. Processes can be temperature and humidity controlled. Multiple commercially available reagent preparation stations are available that perform either a complete processing of microascope slides, or a specific step (such as hybridization, staining or incubation).

The sections mounted on slides are transported via robotic arm 3168 from microtome 3108 to individual workstations of the reagent station 3110. At each workstation, successive specific, timed procedures may be performed (for example, deparaffinization by warming the slide to 37° C., followed by xylene treatment; passage through graded alcohols; rinsing in water). The movement of each slide by robotic arm 3168, and its timing at each position, are controlled by instructions entered by the operator into host the computer of controller 3114. Sectioner 3108 applies a bar-code marker to each slide to identify it, so that the robotic arm will be able to identify each slide. For example, the bar code may identify the slide as containing an array of specific breast-cancer sections, which are to be processed through a series of workstations optimized for the detection of estrogen receptor expression.

Once slides are prepared, robotic arm 3168 may transfer them to scanner 3112 for image analysis, as already described. Image analysis yields quantitative data regarding presence, amount, and distribution of a particular set of biological markers within cells, between cells in a specimen, within tissue spots and between tissue spots. This is stored in a database, along with tissue specimen identity (for example, breast biopsy), clinical information regarding the patient (for example, age, sex, medical history, family history, social history, physical findings, laboratory values), tumor-node-metastasis staging and/or stage grouping, histologic tumor subtype, nature of treatment given, clinical course and response to therapy, and any other relevant information available. The database would also store location information (for example, coordinates of the tissue specimen in donor block, location of the donor block in the donor block array, location of recipient block in recipient block array).

The database's power as a scientific and clinical tool increases with the amount and reliability of the stored information. For example, medical professionals may enter detailed medical histories and other clinical data directly into remote computers, which would transmit that information directly to the database. Such information would allow continuous updating of clinical information, which would then be correlated with quantitative data from an increasing number of biological markers. In addition, an accurate, thorough, and up-to-date database would allow investigators to identify new biological markers and assess disease pathogenesis, or their value in prognosing disease or predicting response to therapeutic interventions.

### Examples of Array Technology

Applications of the tissue microarray technology are not limited to studies of cancer, although the following Examples disclose embodiments of its use in connection with analysis of neoplasms. Array analysis could also be instrumental in understanding expression and dosage of multiple genes in other diseases, as well as in normal human or animal tissues, including tissues from different transgenic animals or cultured cells.

Tissue microarrays may also be used to perform further analysis of genes and targets discovered from, for example, high-throughput genomics, such as DNA sequencing, DNA microarrays, or SAGE (Serial Analysis of Gene Expression) (Velculescu et al., Science 270:484-487, 1995). Tissue microarrays may also be used to evaluate reagents for cancer diagnostics, for instance specific antibodies or probes that react with certain tissues at different stages of cancer development, and to follow progression of genetic changes both in the same and in different cancer types, or in diseases other than cancer. Tissue microarrays may be used to identify and analyze prognostic markers or markers that predict therapy outcome for cancers. Tissue microarrays compiled from hundreds of cancers derived from patients with known outcomes permit one or more of DNA, RNA and protein assays to be performed on those arrays, to determine important prognostic markers, or markers predicting therapy outcome.

Tissue microarrays may also be used to help assess optimal therapy for particular patients showing particular tumor marker profiles. For example, an array of tumors may be analyzed to determine which amplify and/or overexpress HER-2, such that the tumor type (or more specifically the subject from whom the tumor was taken) would be a good candidate for anti-HER-2 Herceptin immunotherapy. In another application, tissue microarrays may be used to find novel targets for gene therapy. For example, cDNA hybridization patterns (such as on a DNA chip) may reveal differential gene regulation in a tumor of a particular tissue type (such as lung cancer), or a particular histological sub-type of the particular tumor (such as adenocarcinoma of the lung). Analysis of each at such gene candidates on a large tissue microarray containing hundreds of tumors would help determine which is the most promising target for developing diagnostic, prognostic or therapeutic approaches for cancer.

The methods and apparatuses disclosed herein provide a method for comparing image analysis systems or software in the interpretation of staining intensity or the type of histology or staining pattern. The methods and apparatuses disclosed herein provide a method method of comparing image analysis systems against one another to test, optimize and quality control the results. This approach could be used to optimize, develop and define clinical diagnostic kits for a large number of disease states.

The methods and apparatuses disclosed herein provide a method of testing automated tissue interpretation methods with manual methods (for example, a panel of experts who evaluate and diagnose a tissue specimen). The evaluation, assessment, or diagnosis of the automated method is compared with that arrived at by the manual method. The methods and apparatuses disclosed herein provide a method for training a computer-based system image analysis to recognize the same features on tissue microarrays as the human experts have scored. The methods and apparatuses disclosed herein provide a method for quality control of such automated tissue interpretation methods “machine vision” approaches between different models/approaches, from one day to another, calibrating with manual experts on a continuous basis, with different reagent systems in use, with different laboratory methods for the same target (such as different commercial kits), with different specimens orginating from the same or different laboratories, comparing the effects of other experimental procedures.

The methods and apparatuses disclosed herein provide a method of evaluating multiple samples from a neoplastic or normeoplastic tissue to evaluate heterogeneity of a biomarker, to improve the sampling of different regions within a neoplastic or normeoplastic tissue, to make results more comparabile with tissue microarray analysis of whole sections. Multiple samples from a specimen may be used to improve the reliability of the tissue microarray analysis, by providing an average biomarker content in a tissue specimen.

The methods and apparatuses disclosed herein provide a method of evaluating multiple samples from a primary tumor and its lymph node metastases, as well as distant metastases to compare differences in the biomolecule expression or genetic changes between the primary and metastatic specimens and in between metastatic specimens to identify and validate biomolecules that may predict metastatic progression or that may provide starting points for the development of treatment for metastatic cancer.

The methods and apparatuses disclosed herein provide a method of evaluating different regions in neoplastic or nonneoplastic tissue, based on histological type, grade, differentiation, degree of proliferation, invasion, atypia, angiogenesis, inflammation, necrosis, apoptosis, metastasis, tissue response to treatment, or other observable parameter or biological marker.

The methods and apparatuses disclosed herein provide a method of evaluating tumor areas defined by measurable properties, such as distance from the center of the tumor, periphery of the tumor, necrosis, inflammation, infection (such as viral) stromal boundary, normal epithelium boundary, border of invasion, or any other morphological feature.

The methods and apparatuses disclosed herein provide a method of evaluating regions within a tissue that comprise different cell types or histological structures, such as kidney glomeruli, collecting ducts, stroma etc.

The methods and apparatuses disclosed herein provide a method of evaluating regions within any type of tissue, such as atherosclerotic tissues with intimal thickening, early lesions, fully atheromas, thrombotic, complicted atheromas etc.

The methods and apparatuses disclosed herein provide a method of evaluating regions within an animal or plant species where one or more normal or abnormal organs or cell types are selected for arraying. This may include, for example, developmental stages within an animal or plant species, subregions within an organ, or any disease state affecting an organ or tissue.

The methods and apparatuses disclosed herein enable multi-parametric approaches for defining a combination of biomarkers that together have diagnostic or prognostic significance that is greater than any of the biomarkers alone. Because the high throughput nature of tissue microarray analysis, very large numbers of samples may be evaluated for very large numbers of markers, enabling the definition of sets of markers that may better define the biology of a particular disease state. For example, immunohistochemistry for a variety of tumor markers may be performed on tissue microarrays, followed by quantitative image analysis and statistical analysis. From this analysis, it may emerge that, for example, increased expression of three or four biomarkers is associated with a poor clinical prognosis, propensity to metastasize, or to respond or not respond to a particular type of therapy. Similar multiparametric approaches enable the definition of biomarkers that may predict progression in other diseases, allow disease subclassification, or provide help to diagnostic or therapy assesment. Similar multi-parametric approaches will be useful to study biological processes, such as cell differentiation, organ development and differentiation, proliferation and death.

The following additional examples illustrate how some particular assays would be performed with the automated system.

### EXAMPLE 13

### Tissue Specimens

A total of 645 breast cancer specimens is used for construction of a breast cancer tumor tissue microarray. The samples include 372 fresh-frozen ethanol-fixed tumors, as well as 273 formalin-fixed breast cancers, normal tissues and fixation controls. The subset of frozen breast cancer samples is selected at random from the tumor bank of the Institute of Pathology, University of Basel, which includes more than 1500 frozen breast cancers obtained by surgical resections during 1986-1997. This subset is reviewed by a pathologist, who determines histological characteristics of the specimens. Other clinical information about the patients is also obtained (such as whether they have undergone chemotherapy, and what clinical stage of disease they had, as well as node status at the time of surgical resection). All previously unfixed tumors are fixed in cold ethanol at +4° C. overnight and then embedded in paraffin.

### EXAMPLE 14

### Immunohistochemistry

After formation of the array and sectioning of the donor block, standard indirect immunoperoxidase procedures are used for immunohistochemistry (ABC-Elite, Vector Laboratories). Monoclonal antibodies from DAKO (Glostrup, Denmark) are used for detection of p53 (DO-7, mouse, 1:200), erbB-2 (c-erbB-2, rabbit, 1:4000), and estrogen receptor (ER IDS, mouse, 1:400). A microwave pretreatment is performed for p53 (30 minutes at 90° C.) and erbB-2 antigen (60 minutes at 90° C.) retrieval. Diaminobenzidine is used as a chromogen. Tumors with known positivity are used as positive controls. The primary antibody is omitted for negative controls. Tumors are considered positive for ER or p53 if an unequivocal nuclear positivity was seen in at least 10% of tumor cells. The erbB-2 staining is subjectively graded into 3 groups: negative (no staining), weakly positive (weak membranous positivity), strongly positive (strong membranous positivity).

### EXAMPLE 15

### Fluorescent In Situ Hybridization (FISH)

Two-color FISH hybridizations are performed using Spectrum-Orange labeled cyclin D1, myc or erbB2 probes together with corresponding FITC labeled centromeric reference probes (Vysis). One-color FISH hybridizations are done with spectrum orange-labeled 20q13 minimal common region (Vysis, and see Tanner et al., Cancer Res. 54:4257-4260 (1994)), mybL2 and 17q23 probes (Barlund et al., Genes Chrom. Cancer 20:372-376 (1997)). Before hybridization, tumor array sections are deparaffinized at reagent station 3110, air dried and dehydrated in 70, 85 and 100% ethanol followed by denaturation for 5 minutes at 74° C. in 70% formamide-2×SSC solution. The hybridization mixture includes 30 ng of each of the probes and 15 μg of human Cot1-DNA. After overnight hybridization at 37° C. in a humidified chamber, slides are washed and counterstained with 0.2 μM DAPI in an antifade solution. FISH signals are scored with double-band pass filters for simultaneous visualization of FITC and Spectrum Orange signals. Over 10 FISH signals per cell or tight clusters of signals are considered as indicative of gene amplification.

### EXAMPLE 16

### mRNA In Situ Hybridization

For RNA in situ hybridization, tumor array sections are deparaffinized and air dried before hybridization. Synthetic oligonucleotide probes directed against erbB2 mRNA (Genbank accession number X03363, nucleotides 350-396) are labeled at the 3′-end with ³³P-dATP using terminal deoxynucleotidyl transferase. Sections are hybridized in a humidified chamber at 42° C. for 18 hours with 1×10⁷ CPM/ml of the probe in 100 μL of hybridization mixture (50% formamide, 10% dextran sulfate, 1% sarkosyl, 0.02 M sodium phosphate, pH 7.0, 4×SSC, 1× Denhardt's solution and 10 mg/ml ssDNA). After hybridization, sections are washed several times in 1×SSC at 55° C. to remove unbound probe, and briefly dehydrated. Sections are exposed for three days to phosphorimager screens to visualize ERBB2 mRNA expression. Negative control sections are treated with RNase prior to hybridization, to abolish all hybridization signals.

The present method enables high throughput analysis of hundreds of specimens per array. This technology therefore provides a great increase in the number of specimens that can be analyzed, as compared to prior blocks where a few dozen individual formalin-fixed specimens are in a less defined or undefined configuration, and used for antibody testing. Further advantages of the present invention include negligible destruction of the original tissue blocks, and an optimized fixation protocol which expands the utility of this technique to visualization of DNA and RNA targets. The present method also permits improved procurement and distribution of human tumor tissues for research purposes. Entire archives of tens of thousands of existing formalin-fixed tissues from pathology laboratories can be placed in a few dozen high-density tissue microarrays to survey many kinds of tumor types, as well as different stages of tumor progression. The tumor array strategy also allows testing of dozens or even hundreds of potential prognostic or diagnostic molecular markers from the same set of tumors. Alternatively, the cylindrical tissue samples provide specimens that can be used to isolate DNA and RNA for molecular analysis.

### EXAMPLE 17

### Novel Gene Targets

Tissue microarrays may be used to find, validate, prioritize and extend information on novel targets for cancer diagnostics or therapies. Hundreds of different genes may be differentially regulated in a given cancer (based on cDNA, e.g. microarray, hybridizations, or other high-throughput expression screening methods such as sequencing or SAGE). Similarly, proteomics techniques are available for detecting thousands of proteins in a cell. Combined with Internet database access to genomic sequence, frictional genomics and proteomics databases, the future of biomedical research is based on analyzing thousands of parameters from each specimen. To date, there has not been a method available for high throughput tissue analysis using molecular pathological tools (such as mRNA ISH, IHC or FISH). Tissue microarrays enable the analysis of many sections sequentially (unlike the cDNA microarray concept, which allows multiple genes to be analyzed at once from a single specimen).

Analysis of each gene candidate on a large tissue microarray can help determine which is the most promising target for development of novel diagnostic methods, drugs, inhibitors, etc. For instance, a tumor microarray containing thousands of diverse tumor samples may be screened with a probe for an oncogene, or a gene coding for a novel signal transduction molecule, such as a G-proteinc coupled receptor Such a probe may bind to one or a number of different tumor types. This can reveal a host of important information on the type of the molecular target. For example, it will give information on the presence or absence of the target in the tissue and cells therein; the quantity of the biomolecule in all the specimens; the distribution of the biomolecule with the various cell types in the various tissues, between cells in a tissue spot and variability between tissue spots. Tissue microarrays may also help to define the frequency of involvement of a particular biomarker in a large epidemiological sample, and it can provide information on critical clinico-pathological, features of specimens expressing a particular biomarker. It can provide information on the difference between biomarker expression between normal and diseased tissues, or on the involvement of the biomarker during development and differentiation of tissues. This kind of information is important for addressing the relative importance of novel biomolecules as durg or diagnostic targets. The tissue microarray analysis will produce important information for investigators and companies in the field of genomics and proteomics on the clinical and biological significance of genes. At the same time, it will allow the diagnostic and pharmaceutical industry to find, validate, prioritize and optimize targets from the abundant genomic and proteomic information.

If a probe reveals that a particular gene is highly expressed and/or amplified in many tumors, then that gene may be an important target, playing a key role in many tumors of one histological type or in different tumor types. Therapies directed to interfering with the expression of that gene or with the function of the gene product may produce promising novel cancer drugs. In particular, the tissue microarrays can help to prioritize the selection of targets for drug development. Since there are thousands of candidate drug and diagnostic targets, such prioritization will greatly assist the search for novel therapies.

### EXAMPLE 18

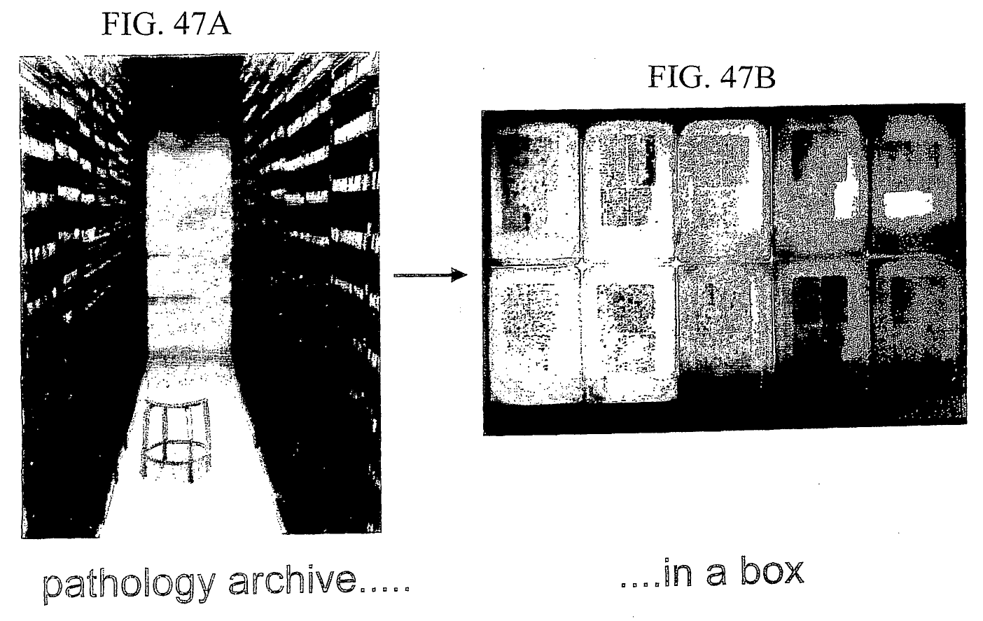

### Uses of the Array (FIGS. 47-53)

FIGS. 47A and 47B illustrate that the arrays of the present invention can be used to greatly compress a pathological archive into a format that enables one to effectively carry out molecular analyses. In the past, such archives of individual tissue sections, from thousands of patients, mounted on slides, have occupied shelves of space in storage areas (FIG. 47A). This dramatically increases the utility of pathological archives in molecular analyses. Using the tissue microarrays disclosed herein, samples from thousands of tissue specimens can be arrayed on a single slide, as shown in FIG. 47B. Hundreds or thousands of copies of the array slides can be used to further increase the available information in the arrays. Before samples from the archive can be used for array construction, one needs to define the blocks and slides corresponding to a given patient, review the histology of the slides, select the right blocks and slides (often there are many per patient) for arraying, select and mark the regions of interest in these slides or blocks (either manually marking on the block surface or digitally with the specifications provided in this patent application), perform the arraying, perhaps generating multiple copies of the array blocks, section them on hundreds of slides, interrogate each with one or more reagents for a particular biomarker.

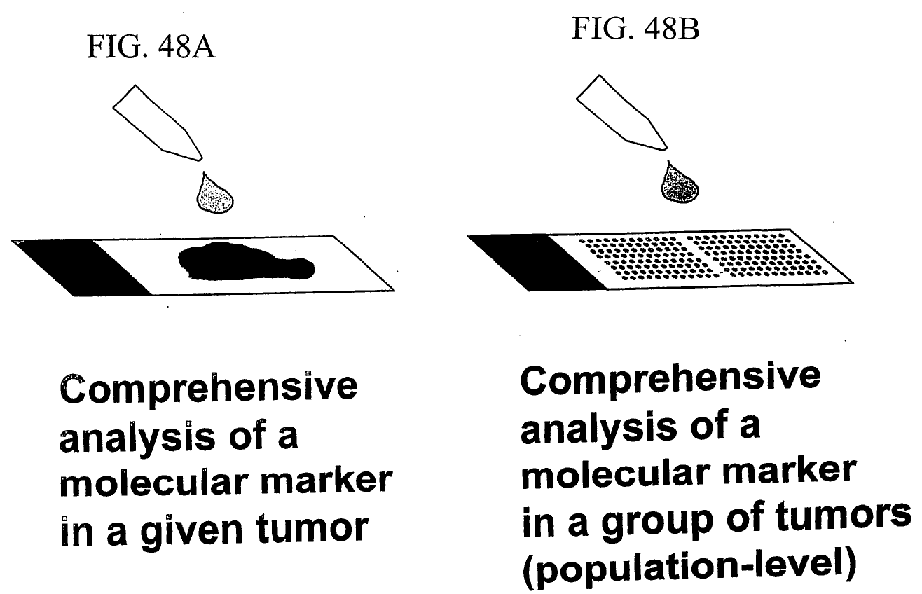

FIG. 48A illustrates the prior approach of exposing a single tumor section to a molecular marking agent (such as an IHC marker or a nucleic acid probe), to ascertain whether the agent recognizes a substrate of interest (such as a protein or DNA sequence). Use of the arrays shown in FIG. 48B, however, permits the simultaneous exposure of a molecular marker to a multiplicity of different tumors, under standardized conditions of array preparation and processing. The array therefore immediately provides an amount of information that would otherwise require laborious preparation of multiple tissue sections and processing steps (perhaps at multiple locations) which can introduce variability and scientific error into the analysis.

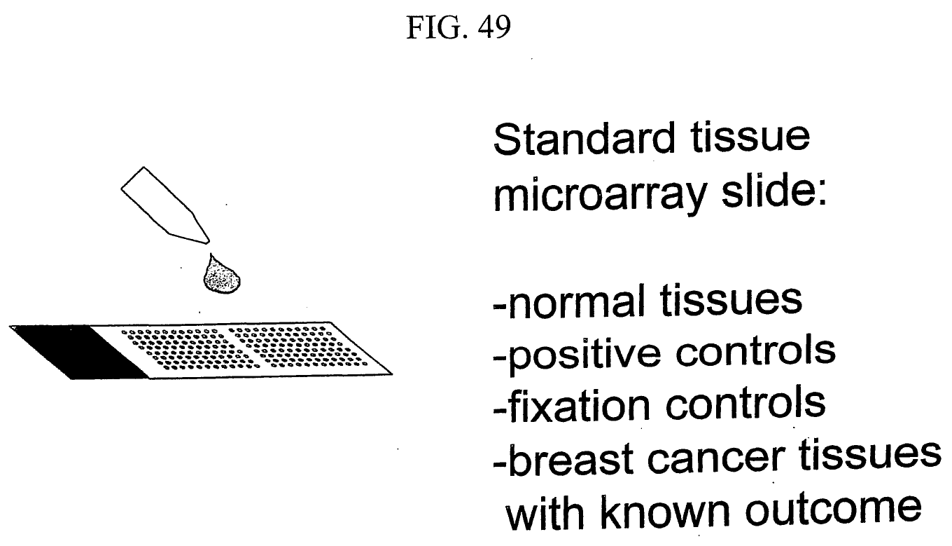

FIG. 49 illustrates that the array slides can be subjected to a bioanalysis at a single location, for example by a manufacturer of a test kit that contains an IHC marker such as a monoclonal antibody. The array can contain, for example, samples of normal tissues, positive controls, fixation controls, and/or tumors with known clinical outcomes, that have been exposed to the marker. For example, samples of the same tissue may be included that have been each fixed in a different fixative (such as formalin vs. ethanol), for various time-points and at various concentrations. Similarly, one can vary the time before fixation, to establish whether this pre-fixation delays causes variability in the biomarker detection from tissue microarrays or from conventional sections. Such tissue microarray slides may be used to evaluate how sensitive a particular staining reaction is to conditions used for fixing and treatment of the original tissue samples. For examples, some antigens may be very sensitive to the effects of fixation variations, while others can be very resistant. This kind of simple tissue microarray slides will provide important information to help developers of reagents, kits and other detection methods.

This slide (and corresponding array sections that are substantial copies of the slide) can then be sent to purchasers of the kit, who then possesses a compact and convenient reference to which the results of the purchasers' bioanalyses can be compared. Hence if the purchaser wants to determine if the tissue being analyzed is expressing a particular biomolecule, the purchaser reacts the tissue of interest with the IHC marker, and compares the result to the library of results on the array. Alternatively, the purchasers' results can be compared to standard results in the array, and those reactions that most closely match can be determined. If clinical outcomes are associated with a standard sample in the array, those clinical outcomes can be used to provide prognostic information about a patient having similar IHC results, or proposed treatments can be suggested by closely matching results.

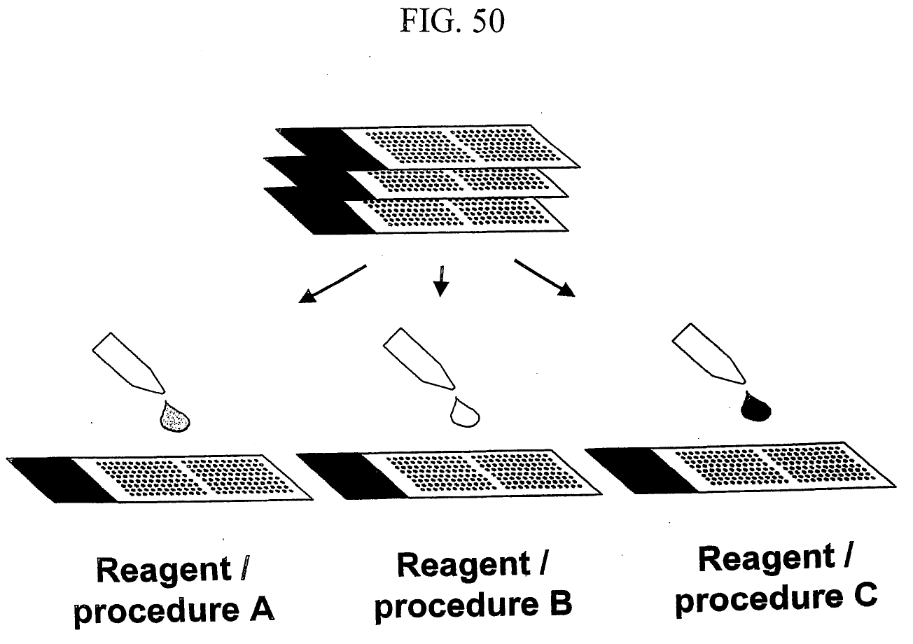

FIG. 50 illustrates a different use of the array, in which quality control of laboratory investigations of the biological material can be enhanced by obtaining multiple corresponding substantial copies of the array (for example by sectioning a block in which tissue cylinders have been placed), and then performing tests (for example with Reagent A, B or C by Procedure A, B or C) on the array copies. Since all of the samples on a single slide will be simultaneously exposed to Reagent A, variability of results (and consequent scientific error) will not be introduced by variations in Procedure A with the different samples. Similarly, all of the samples on a second slide will be simultaneously exposed to Reagent B, variability of results will not be introduced by variations in Procedure B. This allows effective testing and comparison of reagents, pretreatment methods, kits, staining conditions etc. on the same slide in otherwise identical conditions. This helps to determine the origins of variabilty, and to suggest measures that might reduce variability.

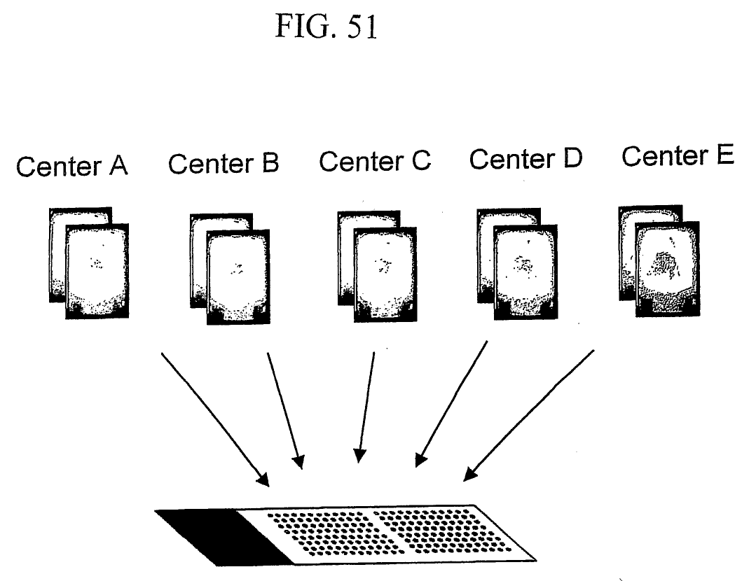

FIG. 51 illustrates how biological material from multi-center trials can be combined into a single array, and multiple copies of that array can be subjected to different biological analyses (not shown). Tissue specimens, for example surgical specimens of tumors, can be sent to a single location, where a sample is punched from each of the tumors and placed in a substrate, which is subsequently sectioned to obtain multiple corresponding sections, with corresponding samples at corresponding positions in the array. The multiple arrays are then subjected to different biological analyses.

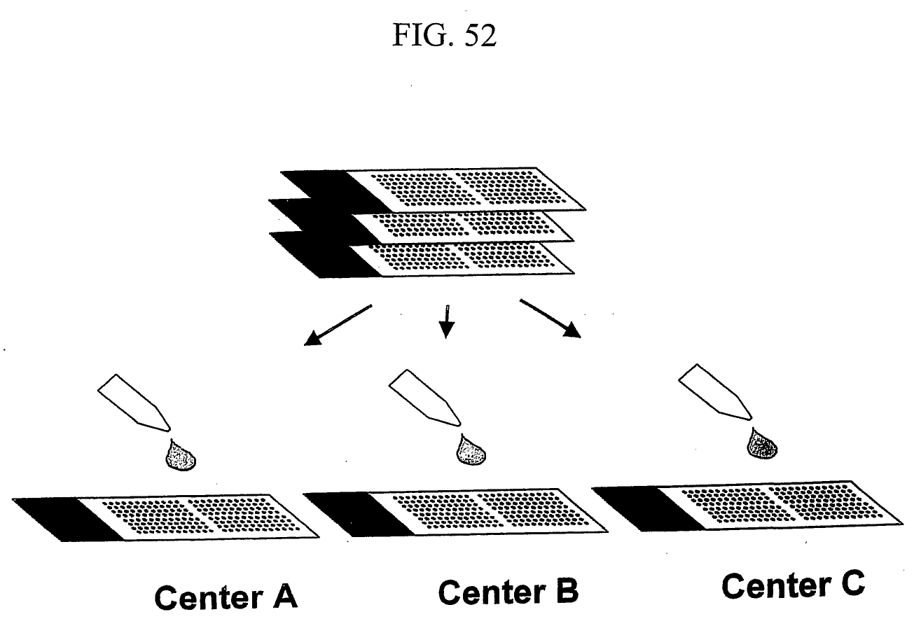

This approach allows several types of analyses. For example, it can be determined if a particular biomarker, test, kit etc. provides the same result from all kinds of samples fixed at different points in different institutes, then inserted to the same tissue microarray and used in the same experimental procedure. It could also be established whether similar results are obtained from samples from different institutions hat may have ethnic or demographic differences between patients, use different sampling strategies, fixation and other differences between one another). FIG. 52 illustrates that the multiple copies of the arrays can be used as a quality control device, to detect variations in reagents or procedures at different centers. For example, if a particular IHC reagent is applied to different corresponding array sections at different centers (Centers A, B, C) the results of the procedures should be substantially identical. However, if the array sections from Centers A, B and C are subsequently examined and compared, differences in reactions (such as variability in positive IHC markers) can be attributed to variations in technique. Hence if the arrays treated at Centers A and C are substantially identical, but the array from Center B appears different, then quality control investigations can be undertaken with respect to the procedures used at Center B to stain the array.

Quality control can also be examined with respect to inter- or intra-observer bias. Hence the substantially identical arrays, which have been subjected to biological analyses (such as IHC staining or nucleic acid probing) at a single location may be distributed to different observers (such as collaborators at different institutions). Since the results of a test (such as Her-2 staining) should be essentially the same for each consecutive copy of the array, the different observers (A, B and C) can be asked to score or interpret the samples in the array. Alternatively, the esact same tissue microarray slide can be easily shipped from one location to another for analysis. An example of the score may be that the sample is Her-2 positive, Her-2 negative, or indeterminate. To the extent that an observer's scores (such as those of Observer B) differ from the scores of other observers (such as Observers A and C), the interpretations of Observer B can be discounted or discarded. Alternatively, information about the discrepancy can be provided to Observer B, so that Observer B can learn to conform his analyses to those of the other Observers. In this manner, greater uniformity of analysis is achieved. The observers may be observing digital images acquired from slides. Furthermore, one or more of the observers can be an imaging system/software that is being tested, teached, optimized or quality controlled to semi-automatically or automatically observe the staining characteristics of the slide.

A related problem with tissue examination is that it is often subject to variable interpretation by different examiners. Pathologic examination (including molecular analysis) is usually accomplished by microscopic examination of biological material by a clinician or researcher. When the clinician is a pathologist, important clinical decisions are often made based on an interpretation of the biological material. For example, if a bladder cancer specimen is judged to show a grade 3 (poorly differentiated) bladder tumor, the patient's bladder is often removed (cystectomy) because large scale studies have shown such surgery to be required to provide the greatest chance of survival. However, if the tissue is judged to show a grade 2 tumor (moderately differentiated) more conservative measures are adopted which would be inappropriate for more advanced disease. Since the selection of an appropriate treatment requires that pathologic diagnoses be made in accordance with uniform standards, methods are needed to help ensure that clinicians in different localities have uniform standards of histologic diagnosis.

Tissue microarrays may be used to address the problem of variable interpretation by different examiners. When the clinician is a pathologist, important clinical decisions are often made based on an interpretation of the biological material. For example, pathologists at different institutions (or even within the same institution) may differ on whether a particular bladder cancer is histologic grade 2, moderately differentiated, or histologic grade 3, poorly differentiated. The analysis carries profound implications for the patient: grade 2 tumors may be managed conservatively, whereas grade 3 tumors generally require radical cystectomy (bladder and lymph node removal). Similarly drastic decisions may be made depending on the interpretation of a particular immunostaining or other molecular marker. For example, HERCEPTIN treatment is initiated for breast cancer, if the tumor is positive for the HER-2 gene/protein either by FISH analysis (for gene amplification) or by IHC (for protein overexpression). Similarly, estrogen receptor expression is gauged as a measure of the likelihood to get a response to hormonal therapy for breast cancer. Its is important to assure reproducibility and quality control of such measurements in the clinical setting.

As an example, to address the variability of tumor grading from one pathologist to another or between pathologists at different time points, tissue microarrays are constructed presenting several examples of various histologic grades of bladder cancer. Multiple substantial copies (for example sections mounted on microscope slides) of these tissue microarrays are disseminated to pathologists, trainees or other clinicians who interpret tissue histology. The dissemination may occur after the copies are reacted with biological reagents (such as hematoxylin-eosin staining or immunohistochemical staining) at a central site. Alternatively, multiple substantial copies may be disseminated to pathologists who perform reactions with biological reagents at a remote site. The substantial copies themselves may be disseminated, or images of the substantial copies may be disseminated.

A specimen of a suspected bladder cancer is obtained during a surgical procedure, and sent to a pathologist for diagnosis. The pathologist compares the tissue features and degree of differentiation in a surgical specimen with the features and degree of differentiation of the various bladder cancer in the tissue microarray. The pathologist may find that the degree of differentiation best matches the examples of grade 2 bladder carcinomas in the microarray. The pathologist then diagnoses grade 2, moderately differentiated bladder carcinoma. Alternatively, the pathologist examines the surgical specimen and arrives at a preliminary diagnosis of grade 2 bladder carcinoma. The pathologist then examines the tissue microarray to confirm the diagnosis, or revise the diagnosis to a different grade, such as grade 3 bladder carcinoma. In these and other manners, the use of tissue microarrays promote greater uniformity of diagnosis, and thereby improves therapy.

Although this example uses bladder carcinoma, the approach is readily adaptable to any other neoplastic or nonneoplastic disease in which tissue samples may be evaluated. For example, a microarray is constructed and disseminated having numerous examples of glomerulonephritis, and is used by a pathologist to assist the evaluation of a kidney biopsy. The microarray may be, for example, numerous examples of membranous glomerulonephritis, which may stained for light microscopic evaluation, or reacted with various immunological or immunohistochemical markers. The pathologist compares the light microscopic and immunologic features of the kidney biopsy to the various examples of nephritis contained in one or more tissue microarrays. The pathologist may use this comparison to conclude that the kidney biopsy represents an example or particular subtype of membranous glomerulonephritis.

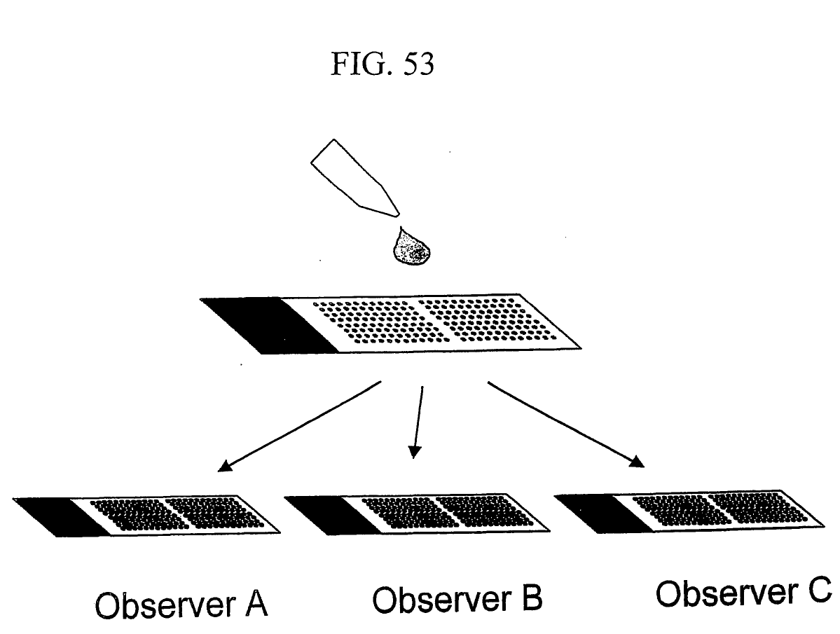

Alternatively, the different Observers A, B and C in FIG. 53 can be trainees, such as multiple medical students or pathology residents taking a qualifying examination. Each of the trainees has one of the array slides. The “correct” answers can be the analysis of each sample provided by an independent expert observer. Alternatively, “correct” answers can be obtained if Observers A, B and C are experts, and the multiple analyses can be used to help determine “correct” answers in situations in which an interpretation may be ambiguous. Moreover, many observers (such as at least 5, 10, 20, 50, 100 or more observers) can be asked to interpret the results of the bioanalysis, to provide an interpretation that has greater reliability (because inter-observer variability can be neutralized by the large number of observers). Such an approach can provide information analogous to that now obtained by multi-center meta-analysis of multiple studies. In this manner the biological significance of a molecular marker (such as Her-2) can be determined much more quickly, instead of requiring years of effort in different trials before a biologically reliable conclusion emerges.

Interpretation of molecular pathology results may become increasingly based on computer evaluation. Therefore, one or more of the observers can be a computer controlled imaging system that automaticlly or semi-automaticllys cores tissue samples for grade or staining intensity. Such results can be compared with the results of an expert, or a panel of experts, who have been asked to review the same slides. This multi-level assesment will make it possible to define optimal conditions, methods and quality control procedures for biomolecular detection in the clinical and research setting.

It is evident from the foregoing discussion that the arrays described herein can be used for a variety of purposes. In view of the many possible embodiments to which the principles of the invention may be applied, it should be recognized that the illustrated embodiments are examples of the invention, and should not be taken as a limitation on the scope of the invention. Rather, the scope of the invention is defined by the following claims. We therefore claim as our invention all that comes within the scope and spirit of these claims.

These and many other uses of the arrays, and examples of different bioanalyses that can be performed with the arrays, are disclosed in U.S. Provisional Application Nos. 60/106,038 and 60/075,979, and PCT publications WO9944063A2 and WO9944062A1, which have been incorporated by reference.

### EXAMPLE 19

### Regions of Interest

A digital image representing a tissue donor block is acquired. A digital image enables the regions of interest (ROIs) on the block to be electronically stored for later use. The digital image may be acquired through several methods, and can include pre-annotation information. In one method, a pathologist or other examiner manually marks a microscope slide (containing a section from the tissue block) with a pen while viewing the tissue section under high magnification, and then acquires an image of the marked slide through any available means including a flatbed scanner. In another method, the examiner is supplied with a high-resolution image of a slide (containing a section from the tissue block) possibly acquired with a high-resolution camera mounted on a microscope capable of providing the needed resolution to define ROIs. In either case, the end result is a digital image of the slide that represents the tissue block. The difference, however, is that the first method yields an image that not only represents the block but also indicates the ROIs in the block.

Once the digital image is acquired, the marking information is represented electronically (digitally). The marking information consists of data points that can be later used to regenerate the perimeters of the ROIs.

Because no restrictions are placed, or guaranteed, on the slide image scaling or orientation relative to the block which it represents, additional information may be included to provide accurate marking information independent of the marked image scaling and orientation. This additional information can be provided by the use of indicia or reference points. In one embodiment, indicia or reference points are in approximately a same position in the original tissue block as they are in any slide representing the same tissue block. For example, if a slide were placed on top of the source tissue block in the appropriate orientation, the indicia or reference points of the block would align with those on the slide. One way of achieving such alignment is to embed the indicia or reference points in the block before sectioning, whether manually or automatically using a specialized apparatus, or tissue microarrayer, to embed the indicia or reference points. In this way the indicia or reference points would be sectioned along with the tissue block, and would maintain the approximately same position with respect to the tissue on the slide as they have on the tissue block. The material embedded in the tissue blocks may be fluorescent, magnetic, or somehow distinctive from the surrounding tissue and block paraffin, to facilitate detection of the indicia or reference points in subsequent tissue microarray procedures.

Having three or more reference points in the block provides an added benefit if a reference point is lost, others would remain on the slide and they would be sufficient in generating the marking information. Representing the marking information as a function of the distance from reference points renders the ‘block marking’ process independent of rotations (i.e. when the slide image is a rotated version of the block). To make the process independent of scaling (i.e. when the slide image is physically larger or smaller than the block), information about the actual distances between the indicia or reference points themselves is included. Hence if reference points 1 and 2 for example are separated by 20 units on the slide and only 5 units on the block, the slide image size is four times that of the block. Thus the marking information consisting of ROI perimeters marked on the slide may be scaled appropriately.

Given a specific coordinate pair (x,y) the arrayer is capable of extracting the tissue sample located at (x,y) from the donor block and depositing it in a specified location in a recipient block. The arrayer has microarray constructor reference points, for example two or more microarray constructor reference point. These two microarray constructor reference points would have a known separation distance and known angle in reference to the arrayer coordinates. Additionally, the absolute coordinates of one of the two microarray constructor reference points is known. Furthermore, the microarray constructor reference points are in the field of view of the tissue microarrayer imaging system and appear on the same image as the tissue donor block.

A tissue donor block is provided with at least two embedded reference points and an image of the block itself, or of a slide made from a section of the block that retained at least two of the donor block reference points. As explained previously, this image may or may not have ROI markings.

A database including information on donor block ROIs may be constructed or maintained. The ROI points that define the perimeter are stored along with any other features that characterize this ROI (possibly including the type of cancer, punching priority, etc). When tissue from a ROI is extracted and deposited in a recipient block, enough information may be stored in the database to trace the recipient block tissue sample back to the originating donor block and vice versa. The database may also store the different slide images that are associated with each block and possible updated block images that reflect extracted tissue.

Tissue block marking methods can be viewed as having two separate functions/stages. The first function provides a method for ROI marking of the slide image (or any other image representing the tissue block) and storing the information either in a standalone file or a database. The second function provides a method for regenerating the ROI perimeters using the stored information from the first function/stage, and generating tissue microarrayer punch locations within the ROI. Each function/stage can be enhanced to provide the user more options and flexibility.

Marking stage

In the marking stage, the image indicia or reference points are assigned in a predefined order that would be compatible with later use of the same reference points on the block at the time of regeneration of ROIs on the tissue microarrayer. After locating and selecting the reference points, a method for marking of ROIs is provided. In the case of the ROIs being previously marked on a slide with a pen before the image was acquired, the user's responsibility is reduced to retracing over those pen lines defining the ROI. In the case of no previous markings, the user must identify the ROIs on the image and mark them directly. Tools to mark polygons, circles, or scattered points on the image are readily available. Furthermore, the user can mark a subregion of a specific ROI to exclude from the full ROI. The user can annotate the ROIs with their tissue type or other needed properties, characteristics, or instructions. These annotations can be automatically associated/linked with the recipient tissue microarray block to which this tissue is transferred to identify the arrayed tissue. Additionally, properties of the block itself can also be stored for later use.

If scaling information is known, then additional features can be implemented. One method to incorporate scaling information is to include two points of known physical separation on the slide before an image of the slide is acquired. A user can locate these two points on the slide image, which will allow precise calculation of the scaling information.

This scaling information can be used in the tissue microarraying process, for example to calculate an estimate of the amount of tissue available in each ROI. The number of punches which can be extracted from each ROI defined within the block can then be computed. Furthermore the amount of tissue having certain characteristics can be calculated per block, not just per ROI. There are many benefits to having this information. As an example, a pathologist searching for a specific type of tissue could easily query the database containing the block marking information, and retrieve blocks that would provide the required quantity of tissue meeting the specific tissue criteria.

Scaling information would also enable tissue microarrayer punch locations to be generated and stored, and downloaded later for actual tissue extraction. This would provide the pathologist more control over punch locations. The pathologist may manually manipulate (fine tune) the locations of the automatically generated punch locations, delete certain punches, mark certain areas as not desired, assign specific punches to certain recipient blocks, etc. In summary, the pathologist could then more easily control the extraction process down to the individual punches.

ROI Regeneration Stage

Once the indicia or reference points are located, the marking information can be retrieved to regenerate the ROI information previously saved at the time of marking the image representing the block. The distance between the reference points on the block image is compared to the distance between the reference points on the slide image (which was saved along with ROI information). This comparison yields a scaling factor that can be used to scale all the ROI saved information and display it in the correct scale on the block image. At this point, the user may manually mark the microarray constructor reference points, or allow them to be automatically detected. The conveniences of being able to move punch locations around, delete certain punches, mark certain punches as undesired, add punches, etc. are also provided to the user at this stage.

Changes that occur to the tissue block at this stage due to tissue extraction may be stored in the database. Consequently, if the tissue at a certain location was extracted and deposited in a recipient block, then information about the position of extraction is stored in the database to prevent a user from attempting to mark the same position for extraction at a later point. Along with the fact that the tissue was extracted at the given position, the recipient block in which that specific punch was deposited has its unique identification stored with the donor block information so as to be able to trace it down given the donor block information. In a similar way, the donor block identification is stored with the recipient block data so as to be able to identify which donor block contributed to which tissue sample in the recipient block. The arrayer control station may relay information regarding which punch location from the donor block was extracted and in which recipient block it was deposited so that changes may be stored in the database. Alternatively, if the arrayer is connected to the database, it can directly commit the changes.

Scaling information would allow for recipient block design. A pathologist wishing to compose an array of possibly different tissue types can proceed through the following steps:

1. Layout the arrangement of the array, or possibly subarrays, within the recipient block, i.e. a 4×6 subarray of tissue type a, 5×5 subarray of tissue type b, etc.

2. Specify the punching properties for both the donor and recipient block (i.e. specify the punch size for each subarray, punch spacing for both the donor and recipient, etc.)

3. Submit the array request to the database.

At this point, exact quantities of each specific tissue type requested by the user are calculated. A query is formed to the database to return a list of the blocks that can satisfy the request along with information on where to extract and how much to extract from each individual returned block. These blocks, along with the information on where to punch from each, can then be used for actual tissue extraction, and formation of the desired recipient array. Once tissue is extracted, the database is updated to include information on which recipient array, and where within the recipient array, the tissue was deposited. Also, the recipient array information would be stored in the database, and would include which donor block the tissue originated. Adding this information to the database allows a user who is viewing a specific donor block's information to determine the recipient array in which the extracted tissue from the donor was deposited, and a user viewing the recipient array can trace each tissue sample back to the source donor block.

Since database queries can be submitted remotely, a pathologist or other user does not need to be physically near the tissue microarray process and instrumentation. The tissue microarraying operation can be entirely completed without the pathologist.

### EXAMPLE 20

### Exemplary Operation of Automated Tissue Microarray Construction

The various techniques described prior to the tissue microarray description can be applied to result in implementations specific to tissue microarrays. The following example illustrates how the above techniques can be used to construct a recipient tissue block for use in a tissue microarray system.

In the example, the recipient tissue block is constructed by an automated arrayer which punches tissue from a number of donor tissue blocks; however, other techniques are possible. For example, a single donor tissue block can be manually placed on the arrayer. Tissue can be extracted from the donor tissue block and placed into one or more recipient tissue blocks. In such a scenario, information for the single block might be saved to a standalone file instead of storing the information in a database.

Using the database approach, information for a number of donor tissue blocks can be input into the system and can be stored in the database, which represents a donor block library. Over time, the library can be augmented as new donor blocks are prepared or acquired for the library. A number of operators can direct the information input for a variety of donor block sets. Subsequently, the combined work of the operators is available for constructing a recipient block that may contain any combination of tissue from the donor blocks.

In the following example, a software system with a user interface written in the JAVA programming language assists in adding new donor tissue blocks to the library and then subsequently assembling recipient tissue blocks. Various JAVA programming language tools are available from a variety of sources, including Sun Microsystems of Palo Alto, Calif.

To add information for a donor tissue block into the system, one or more regions of interest are denoted for the block. As explained in some of the examples described above, after an image of the donor block is captured, it is possible for the software to find the reference points and any regions of interest marked on the block. After finding the reference points and the regions of interest, information indicating the location and extent of the regions of interest can be stored to the database, along with any identifying information.

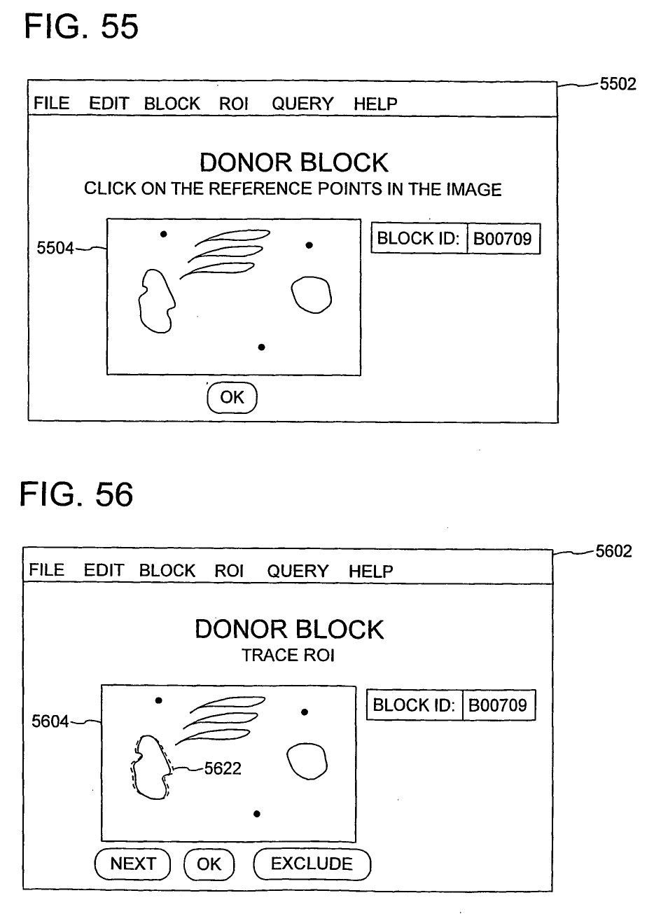

Alternatively, a user interface 5502 such as that shown in FIG. 55 can be presented to an operator, who finds the reference points on the image 5504 portraying the donor tissue block. The operator can indicate the location of a reference point (e.g., point 5512) by clicking on it. Alternatively, crosshairs can be manipulated by the operator until it is over the reference point. In another arrangement, the image 5504 is presented on a separate computer monitor.

If the reference points have been positioned according to a scheme as described in the above examples, the identity of the reference points can be automatically assigned by the software and then later identified when another image of the block is captured. Alternatively, each of the reference points can be assigned an identifier or be identified by some other means, such as by color or shape.

Further, the operator is given an opportunity to enter the distance between the reference points. The distance information can be stored and used to calculate scaling information for use when calculating the size of a region of interest, determining appropriate punch size, or setting appropriate center-to-center punch spacing. Alternatively, the distance could be known because reference points are placed at some known distance apart and a configuration setting is set to the distance. In still another arrangement, a ruler or some other mechanism indicating distance can be included for the image.

Instead of having the software find marked regions on the block, the operator can trace a region physically marked on the block or trace a region not physically marked on the block or a slide taken from the block.

For example, a pathologist may be able to determine the location and extent of a region of interest based on an image portraying a slide on which a slice of the block has been placed. The slide can be viewed under high magnification so that the pathologist can more readily determine the content of various portions of the slice and whether it should be included in a region of interest. During the marking or tracing process, the orientation of the slice may become rotated with respect to its original orientation on the block. The system can operate regardless of the rotation or difference in magnification.

For example, the user interface 5602 shows an image 5604. An operator has traced one of the features of the donor block to indicate it is a region of interest 5622. The operator can trace other regions of interest for the donor block or indicate that no more are currently to be traced.

After finding the reference points and the regions of interest, information indicating the location and extent of the regions of interest can be stored to the database, along with any identifying information for the regions of interest or the block. For example, the type of tissue contained in a marked region of interest can be stored.

In practice, a pathologist may wish to denote many (e.g., 20-30) regions of interest for a single donor block during one session. Regions can be labeled in the database as stroma, epithelium (e.g., a single layer of epithelial cells), inflammatory areas, and necrotic areas.

In addition, a single tissue (e.g., cancer tissue) often contains morphologically different regions, which can be labeled in the database as well differentiated, moderately differentiated, and poorly differentiated tumor areas. The database can also track the locations certain morphologically defined areas, such as a tumor edge, tumor center, blood vessel, necrotic area, and the like. Thus, a query can specify that punch locations be selected from locations at least a certain distance away from or proximate to a tracked feature.

As noted in some of the examples above, the information indicating the location and extent of the regions of interest can be stored as a set of points forming a perimeter for the region of interest. A point in the set is indicated by a set of distances from each of the reference points. Further, information related to the point can indicate whether the point is above or below lines defined by sets of two of the reference points. Thus, if a reference point is lost or missing, the points (and thus the perimeter) can still be reconstructed, and the location and extent of the region of interest can still be determined. Information indicating whether a point is above or below a line can be stored as a single bit.

It is possible to store the information indicating the location and extent of a region in a Java object having data members for the various fields. Then, the information can be written for later retrieval simply by using a feature of the Java programming language that serializes the contents of the object. Alternatively, a convention can be developed for storing the information so that when the object definition is modified or upgraded, information from previous versions is still easily readable. Yet another alternative is to store the data as fields in a database.

As shown in FIG. 57, information relating to a block can be entered by the operator via the user interface 5702. Certain information, such as the block identifier, may be determined by automated means (e.g., via a barcode reader reading a barcode affixed to the block).

Further, other information 5704 can be included about the block to facilitate querying and further investigation. When tissue is removed from the block and placed in a recipient block, a reference to the donor block is made so that later investigation can trace back to the source of the tissue. Information 5704 can include, for example, the name of a pathologist marking the block, the date marked, the origin of the tissue, and any comments about the block.

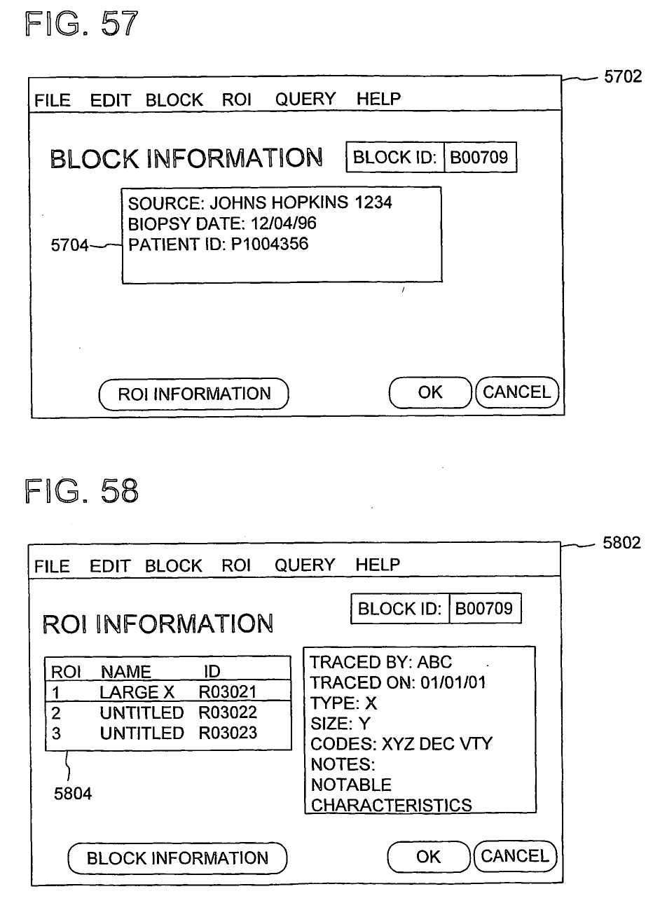

Further, as shown in FIG. 58, information relating to regions of interest for the block can also be entered via the user interface 5802. The regions of interest are listed in the RoI pane 5804. Certain information, such as the region of interest identifier or the size may be determined by automated means (e.g., by selecting the next available identifier). Other information can include, for example, the name of a pathologist who marked the region, and any comments about the region. The information for the region of interest can subsequently be used when performing a query. In this way, an operator can find particular regions of interest having tissue desired to be included in a recipient block. Queries can also be based on tissue available per donor block instead of per region of interest.

The information relating to the block and the regions of interest can be stored in a database along with information about numerous other blocks. Consequently, the combined work done for the blocks is available for browsing and other access by other operators using other systems.

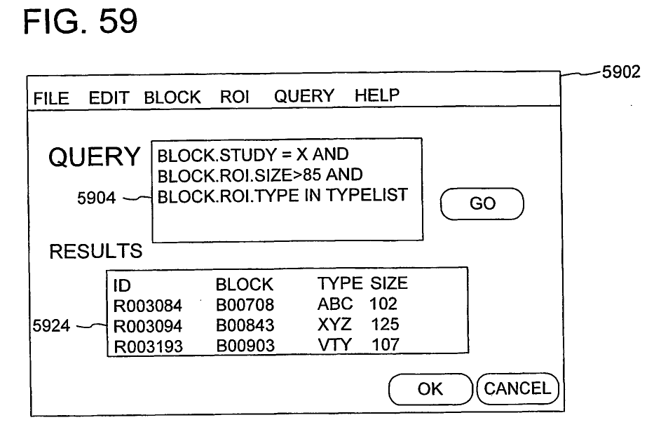

For example, FIG. 59 shows a user interface 5902 for entering criteria 5904 specifying a desired set of regions of interest. The resulting region of interest list 5924 can be modified, augmented, or saved for later retrieval. The operator can then submit the list for processing by an automated arrayer, which will find each of the blocks in the list, reconstruct the location and extent of the desired region of interest and extract tissue therefrom. The tissue can then be deposited in a recipient block. The recipient block thus comprises tissue from each of the desired regions of interest in the region of interest list 5924.

The software can automatically retrieve each of the blocks, find the reference points, reconstruct the location and extent of the region of interest, and perform the tissue extraction. An operator can assist in the automated process to various degrees. For example, the operator can assist by manually retrieving blocks identified by the software and manually placing the blocks on the platform one at a time, all at once, or in groups. The operator can also assist by identifying the reference points on an image captured after the block is retrieved. For example, a user interface similar to the user interface 5502 (FIG. 55) can be presented so the operator can indicate where on an image (e.g., portraying the block) the reference points appear.

If the reference points have been arranged as described in one of the schemes in the above examples, the identity of the reference points can be automatically determined. Further, if one of the reference points has become missing or lost, the remaining reference points may still be sufficient to reconstruct the region of interest. As a practical matter, if the image depicts at least two of the reference points, the region of interest can still be reliably reconstructed.

Also, if the region of interest has been indicated with respect to the reference points as described in some of the examples above, the region of interest can be reconstructed even if the block has been rotated, flipped, or inverted.

In addition, as a result of image capture during the block retrieval process, previously stored information indicating the distance between the reference points can be used in conjunction with the known distance between system reference points to calculate scaling information and determine a translation. The translation can take a location on the image or a location with respect to the region of interest as input and produce information for specifying a location to a mechanical device. The information can then be sent to the mechanical device to position a punch at the proper location (e.g., so that it will punch tissue from the region of interest). The tissue can then be placed in a recipient block.

Instead of the automated block retrieval scenario described above, the described techniques can be utilized with a single donor block or a number of donor blocks manually placed on the system. For example, a few donor tissue blocks could be placed on the system by hand, and tissue from the donor blocks automatically extracted to partially generate a number of recipient blocks. More tissue blocks could then be placed on the system to continue generation, and so forth, until the desired amount of tissue is placed into the recipient blocks.

In either the manual or automated techniques, the software supports a feature by which the operator can define the region into which the punched tissue is to be placed in the recipient block. For example, an image of a recipient block of paraffin is captured, and the operator then draws a rectangle around the area. The operator can also specify the recipient block configuration. For example, the operator can specify one or more 5 by 7 (or other X by Y) arrays with a specified distance between the punches. The system can then use techniques similar to those described above to determine the physical location of the recipient punches.

In one embodiment, a punch assembly having two punches is used. Typically, such a system first positions the punch assembly over an appropriate location of the donor block, extracts the tissue from the donor block with a first punch, positions the punch assembly over an appropriate location of the recipient block, extracts filler from the recipient block with the second punch, deposits the tissue in the first punch from the donor block into the recipient block, re-positions the punch assembly over the original location in the donor block, and finally deposits the filler material extracted from the recipient block into the donor block. Such a procedure can be repeated a number of times as appropriate. A toggle feature in the software allows easy mechanical switching between the first and second punch.

A calibration technique uses a pair of laser beams and laser sensors located on the platform. One laser beam corresponds to the x-axis, and the other corresponds to the y-axis. The platform is moved to a location at which an actuated automated tissue punch intercepts one of the laser beams, as indicated by a laser sensor. The appropriate controller (e.g., x-axis) for the platform is then calibrated. Calibration is then performed for the other laser beam. In other words, one laser beam corresponds to a known x location, and the other corresponds to a known y location.

The intersection point of the laser beams (whether or not they actually intersect) could be designated as the platform's origin, but in the example, the platform origin is designated as a fixed distance away from the location (e.g., at a physical location on the platform corresponding to a hole through a plastic block). The location of at least one of the system reference points with respect to the platform origin (e.g., the distance between the system reference point and the reference origin) is determined. Finally, the angle of two system reference points with respect to the platform coordinate system (e.g., as controlled by two motors moving the platform in perpendicular x and y directions) can be determined. In the example, the two system reference points are placed so that they are in line with the y-axis (i.e., the angle is zero). Various information, such as distances and angles, can be determined manually, stored, and reused for subsequent calibration operations.

Based on the foregoing calibration information, it is possible to then determine the physical location of items shown on a captured image, as long as the two reference points appear in the image. In other words, the platform can be moved to a location so that an operation will be performed on an item shown in the captured image.

To calibrate the camera, the platform can be moved so that an image of the system reference point is in a crosshairs. Then, an offset between the camera and the reference origin can be calculated. This information is not necessary for determining the physical location of items, but can be useful for properly positioning the camera in an automated system (e.g., by moving a platform).

Alternatively, a calibration mechanism can take the form of a moveable object placed on the platform. The moveable object conducts electricity, and when it is tapped, the electrical circuit is broken. Thus, a punch can be repeatedly actuated to move toward and away from the platform while the platform is moved in a direction (e.g., moving along x coordinates) until the electrical circuit is no longer broken (i.e., the punch is no longer hitting the moveable object). Then, the location of the platform (e.g., x coordinate) is determined to be a location designated as the reference origin, or a location from which a reference origin can be designated (e.g., by adjusting from the manually measured distance from a location on the platform designated as the reference origin). The process can be repeated for additional calibration (e.g., for y coordinates).

Given information indicating the region of interest and a captured image of an object including at least two system reference points, the system can regenerate the region of interest for the object. The system also relies on the known distance between the reference points, the angle between them, and the absolute position of at least one of the points. The system can operate without reference points if the camera is of fixed position and known magnification.

For example, if it is determined that an image is rotated by 45 degrees (i.e., with respect to the platform), a translation can be generated to rotate the information indicating the region of interest by 45 degrees to compensate. The rotation can be determined based on the known angle between the two system reference points via trigonometric functions.

The angle of the two system reference points can be defined in terms of rotation of a line between them with respect to a reference coordinate system (e.g., the coordinate system formed as a result of actuating motors driving the platform in x and y directions). In the illustrated example, the reference points are aligned with movement of the platform, so the angle is defined as zero.

The rotation of the object with respect to the orientation when the region of interest was denoted need not be explicitly calculated. For example, using the example method described above where the location of perimeter points is determined using a set of distances, rotation is automatically resolved.

The separation between the two points can be used to scale the region of interest. For example, if two points were separated by x units on the image when the region of interest was defined, but appear to be separated by y units on a subsequently-captured image, a scaling factor (x/y) can be applied to the subsequently-captured image to adjust the region of interest. Or, a scaling factor (y/x) can be applied to the region of interest as originally defined. Thus, punch locations can be translated from image coordinates to arrayer coordinates.

In addition, a recipient block is typically positioned on the same platform as a donor block. After tissue is punched from the donor block, the platform is then moved so that the recipient block is in a position to receive the punched tissue.

Because the automated arrayer can construct a recipient tissue block given a list of regions of interest, the arrayer can be controlled from a remote location. For example, a pathologist at a location remote from the arrayer can assemble an appropriate list of regions of interest and then submit them to the arrayer via the Internet. The arrayer then automatically processes the list to generate an appropriate recipient block. Another operator can be stationed at the arrayer's location to assist in manual placement of requested blocks if desired.

The degree of control maintained by the remote operator can be varied. For example, the software can automatically choose punching locations within the regions of interest, or the operator can specify them. In other words, the arrayer can accept a region of interest list, produce a punch location list, and then punch the locations. Alternatively, the arrayer can accept a punch location list and punch the indicated locations. Further, the operator can adjust various other parameters such as punch separation.

Other functions of the software system can also be controlled remotely. For example, a region of interest can be denoted at a location remote from the actual tissue block being observed.

### EXAMPLE 21

### Error Correction Mechanism

In some cases, a block can be more effectively analyzed for marking by sectioning (e.g., taking a slice from) the block, placing the section on a slide, and reviewing the slide under magnification. Based on review of the slide, it can then be marked to denote regions of interest.

If the technique of reference bars as described above is used, reference points appearing on the slide should correspond to those showing on the block Therefore, regions of interest for the marked slide can be recorded and subsequently used to determine where the regions of interest appear on the block via the region of interest regeneration techniques described above.

However, during sectioning and placement, the reference points on the slide might move or become lost. Thus, the reference points on the slide might not correspond to the original reference points on the block. Such misalignment will cause errors when the region of interest is regenerated.

Misalignment of reference points and error can be avoided by employing an exemplary error correcting technique. In addition to one or more regions of interest, other tissue regions can be marked and stored to improve performance of the error correcting technique. Such regions can be marked using the automatic or manual techniques described above.

The error correcting technique generally operates under the assumption that the topology of the tissue appearing on the slide (e.g., having the section) matches that appearing on the block. Sometimes this assumption will not be true, such as when distribution of tissue is not homogeneous in a vertical dimension when horizontal slices are used to generate sections. Such a situation can be avoided by not removing additional sections from the block after the slide is marked.

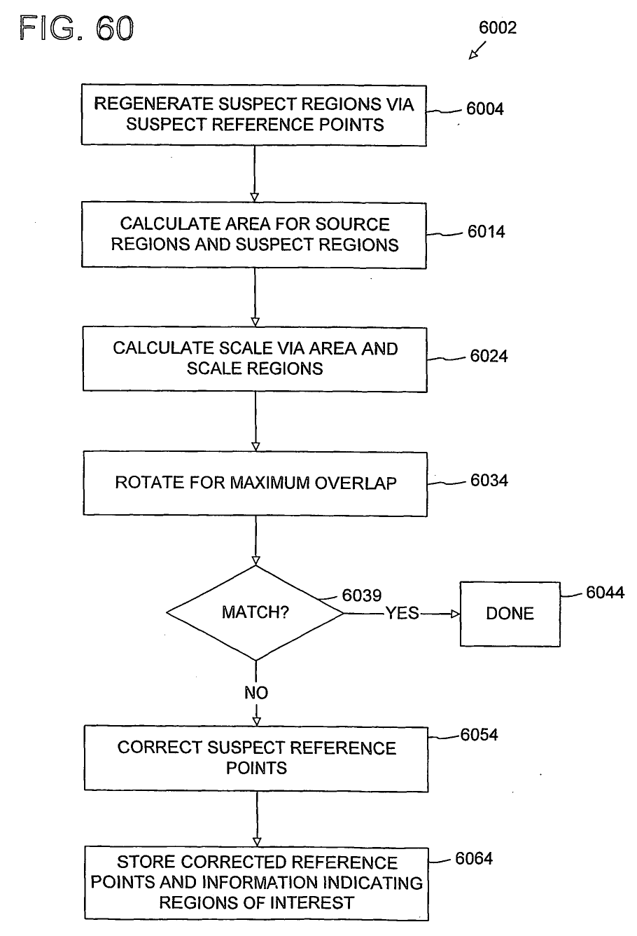

An exemplary method 6002 for an error correction technique is shown in FIG. 60. The technique can be used to correct errors related to suspect reference points, such as those for a slide having a section that has been removed from a source tissue block, such as a donor tissue block.

At 6004, the location and extent of tissue regions stored at the time of marking are regenerated via the suspect reference points. These regions are suspect because they are based on suspect reference points.

At 6014, the area of regions for the source tissue block and the area for the suspect regions are calculated. The source regions can be based on manual or automatic tracing of tissue areas or markings.

At 6024, a scale is calculated based on the ratio of the areas calculated in 6014. The scale can then be used to adjust the suspect or source regions so they are of the same scale.

At 6034, the suspect or source regions are rotated until maximum overlap is achieved. The reference points are also scaled and rotated. Then, at 6039 it is determined whether there is a match between the reference points. Match need not be exact, and a threshold value can be set to determine to what degree the points should match. If there is a match, no correction need be done, and the method ends at 6044.

Otherwise, the suspect reference points are corrected at 6054. The region of interest information stored with respect to the suspect reference points is regenerated via the suspect reference points, using the determined scaling and rotation. The suspect reference points are then discarded and the source's reference points are designated as new reference points for the slide.

The new, corrected reference points and the information indicating the regenerated region of interest with respect to the new, corrected reference points are stored at 6064.

The information stored for the slide has then been corrected for use in conjunction with the block. For example, region of interest information can now be regenerated from the stored information relying on the block's reference points.

### EXAMPLE 22

### Automatic Reference Point Identification

The above techniques described for error correction can also be used to automatically determine the identity of reference points. Thus, instead of labeling the reference points or placing them according to an arrangement scheme, the identity of reference points can be determined by scaling and rotating images until maximum overlap of regions is achieved. In some scenarios, the need for reference points can be eliminated entirely, or a single reference point can be used.

### Alternatives

Although various examples describe a single region of interest, multiple regions of interest can be processed for a block. Although various examples describe a camera, some other means could be used to determine the location and orientation of a retrieved block.

Although tissue microarray construction is presented as an example, the technologies described herein can also be applied to other scenarios, such as acquiring tissue for molecular analyses without using a tissue microarray. For example, tissue can be deposited on microtiter trays or test tubes for DNA isolation.

In view of the many possible embodiments to which the principles of the invention may be applied, it should be recognized that the illustrated embodiments are examples of the invention, and should not be taken as a limitation on the scope of the invention. Rather, the scope of the invention is defined by the following claims. We therefore claim as our invention all that comes within the scope and spirit of these claims.

We claim:

1. A computer-implemented method for automated processing of a physical object comprising biological material, the method comprising:
retrieving information indicating at least one region of interest of the physical object comprising biological material; and
based at least on the information indicating the region of interest, performing an operation on a physical location within the region of interest of the physical object comprising biological material.

2. The method of claim 1 wherein the information indicating the region of interest is independent of rotation of the physical object.

3. The method of claim 1 wherein the operation physically modifies the region of interest.

4. The method of claim 3 further comprising:
updating a database to reflect the region of interest has been modified.

5. The method of claim 4 further comprising:
after modifying the region of interest and updating the database, consulting the database to determine whether the region of interest meets specified criteria; and
responsive to determining the region of interest meets the specified criteria, adding the region of interest to a list of selected regions of interest on which the operation is to be performed.

6. The method of claim 1 wherein the operation comprises extracting material from the region of interest with an automated extractor.

7. The method of claim 6 further comprising:
inserting a filler material into the region of interest into an area from which the material has been extracted.

8. The method of claim 1 wherein the operation comprises removing biological tissue from the region of interest with an automated tissue punch.

9. The method of claim 1 wherein performing the operation comprises sending directives to an automated positioning device.

10. The method of claim 1 further comprising:
based at least in part on where in physical space the physical object is positioned, determining a translation for converting a location in coordinates related to the information indicating a region of interest of the physical object into coordinates indicating a location in physical space within the region of interest;
wherein performing the operation comprises applying the translation.

11. The method of claim 1 further comprising:
based at least in part on where in physical space the physical object is positioned, determining a translation for converting a location in coordinates related to the information indicating a region of interest of the physical object into coordinates related to an automated positioning device;
wherein performing the operation comprises applying the translation.

12. The method of claim 11 further comprising:
based on the coordinates related to the automated positioning device, sending directives to the automated positioning device to position the object so the operation can be performed at a physical location within the region of interest of the physical object.

13. The method of claim 11 wherein
the capturing comprises capturing an image of an item at a known location; and
the translation is based at least in part on the location within the image of the item at the known location.

14. The method of claim 13 further comprising:
retrieving the physical object; and
before capturing the image, placing the physical object at a location adjacent to the item at the known location.

15. The method of claim 13 wherein the item at the known location is a system reference point.

16. The method of claim 13 wherein the operation comprises extracting material from the region of interest with an automated extractor, the method further comprising:
positioning the automated extractor so it extracts material from the known location.

17. The method of claim 13 wherein
the item is on a platform including at least one laser beam; and
the known location of the item is determined by positioning the platform so that the laser beam is broken.

18. The method of claim 1 wherein
the physical object rests on a platform; and
performing the operation comprises sending directives to an automated positioning device to move the platform, thereby positioning the physical object at a location appropriate for performing the operation on the region of interest of the physical object.

19. The method of claim 1 further comprising determining where in physical space the object is positioned with respect to a known position in physical space by capturing an image of the object;
wherein the operation is performed based at least on part on where in physical space the object is positioned with respect to the known position in physical space.

20. The method of claim 1 wherein
the physical object comprises one or more reference points; and
the information indicating the region of interest of the physical object indicates the region of interest with respect to the reference points, the method further comprising:
capturing an image representative of the object;
determining the locations of the reference points on the image of the object; and
reconstructing the region of interest based on the locations of the reference points and the information indicating the region of interest with respect to the reference points;
wherein the operation is performed based on the reconstructed region of interest.

21. The method of claim 20 wherein
the information indicating the region of interest specifies a set of points forming a perimeter of the region of interest via distances from the reference points; and
the information indicating the region of interest further specifies information for resolving ambiguity when one of the reference points cannot be located.

22. The method of claim 20 wherein
the information indicating the region of interest specifies a set of points forming a perimeter of the region of interest; and
the information indicating the region of interest further specifies whether the points are below or above a line connecting sets of two of the reference points.

23. The method of claim 1 further comprising:
with the information indicating the region of interest, generating information specifying a physical location within the region of interest;
wherein the operation is performed via the information specifying the physical location within the region of interest.

24. The method of claim 1 further comprising:
determining a scaling factor for adjusting the size of the region of interest indicated by the information indicating the region of interest; and
applying the scaling factor to adjust the size of the region of interest.

25. The method of claim 24 wherein the information indicating the region of interest indicates a stored distance between two reference points of the physical object, the method further comprising:
capturing an image of the object; and
determining an observed distance between the two reference points; wherein the scaling factor is determined based on the stored distance and the observed distance.

26. The method of claim 1 further comprising:
retrieving the physical object via an automated object retriever.

27. The method of claim 1 wherein
the object is a donor tissue block; and
the operation comprises extracting tissue from the region of interest of the donor tissue block.

28. A computer-readable medium comprising computer-readable instructions for performing the following to process a physical object comprising biological material:
retrieving information indicating at least one region of interest of the physical object comprising biological material; and
based at least on the information indicating the region of interest, performing an operation on a physical location within the region of interest of the physical object comprising biological material.

29. A computer-implemented method for processing an observable feature comprising biological material in a physical object, the method comprising:
capturing a first image depicting the observable feature comprising biological material;
via the first image, denoting at least one region of interest comprising the feature comprising biological material;
storing information indicating the region of interest;
retrieving the information indicating the region of interest;
capturing a second image, wherein the second image depicts an item of known location and the object;
based on the second image and the retrieved information indicating the region of interest, generating information to position the feature comprising biological material at a location appropriate for extracting material from the feature comprising biological material;
sending the information to an automated positioning device to position the feature comprising biological material at a location appropriate for extracting material from the feature; and
extracting material from the feature comprising biological material.

30. The method of claim 29 wherein the first image is of a first magnification and the second image is of a second, different magnification.

31. The method of claim 29 wherein the physical object is a tissue block, and the feature present in the physical object is a region of tissue of a particular tissue type.

32. A computer-implemented method for processing a physical object comprising biological material, the method comprising:
during a first session, capturing a first image representative of the physical object comprising biological material;
during the first session, designating one or more regions of interest for the object comprising biological material via the first captured image;
during the first session, storing information indicating the one or more regions of interest for the physical object comprising biological material;
during a second, subsequent session, retrieving the physical object comprising biological material;
during the second, subsequent session, retrieving the information indicating the one or more regions of interest for the physical object comprising biological material;
during the second, subsequent session, capturing a second image of the physical object comprising biological material;
during the second, subsequent session, based on the second captured image and the retrieved information indicating the one or more regions of interest for the physical object comprising biological material, performing an operation on one or more physical locations within the one or more regions of interest for the physical object comprising biological material.

33. The method of claim 32 further comprising:
reconstructing location and extent of the one or more regions of interest from the information indicating the one or more regions of interest for the physical object;
wherein the operation is performed via the location and extent of the one or more regions of interest.

34. The method of claim 32 further comprising:
reconstructing perimeters of the one or more regions of interest from the information indicating the one or more regions of interest for the physical object;
wherein the operation is performed via the perimeters of the one or more regions of interest.

35. The method of claim 32 further comprising:
correcting error in the information indicating the one or more regions of interest for the physical object based on overlap between regions shown on the first image and regions shown on the second image.

36. A computer-implemented method for processing regions of interest in a set of physical objects comprising biological material, the method comprising:
denoting a plurality of regions of interest for the physical objects comprising biological material;
selecting a list of a subset of the plurality of regions of interest; and
for the regions of interest appearing on the list, performing the following:
automatically retrieving a physical object comprising biological material having the region of interest; and
automatically extracting material from the region of interest of the physical object comprising biological material.

37. The computer-implemented method of claim 36 wherein the selecting comprises performing a database query on a database storing information about the physical objects and the regions of interest.

38. The computer-implemented method of claim 36 wherein the selecting is performed from a location remote from where the automatically retrieving and automatically extracting are performed.

39. A computer-implemented method for processing a physical object comprising biological material, wherein the physical object comprises a plurality of reference points indicated thereon, the method comprising:
retrieving information indicating a region of interest on the physical object comprising biological material with respect to the reference points;
capturing an image representing the physical object comprising biological material, the object's reference points, and one or more system reference points;
finding locations of the object's reference points and the system reference points on the image;
calculating a translation mapping location on the image to absolute locations sufficient to position a robotic arm at a physical location of the physical object corresponding to the locations on the image;
choosing a location within the region of interest;
with the translation, mapping the chosen location to physical location information sufficient to position an automated device at a physical location corresponding to the chosen location;
sending the physical location information to position the automated device at the physical location corresponding to the chosen location; and
with the automated device, performing an operation on the physical location within the region of interest of the physical object comprising biological material.

40. A computer-implemented method for denoting one or more regions of interest for a physical object comprising biological material, wherein the physical object comprises a plurality of reference points, the method comprising:
capturing an image representative of the physical object comprising biological material, wherein the image depicts locations of at least one of the reference points;
via the captured image, denoting one or more regions of interest for the physical object comprising biological material; and
in a computer-readable medium, storing information indicating the one or more regions of interest with respect to the reference points.

41. The method of claim 40 wherein
the image representative of the physical object depicts a slice taken from the physical object; and
the locations of the reference points on the slice are associated with the locations of the reference points on the physical object.

42. The method of claim 40 wherein the information indicating the one or more regions of interest indicates the regions of interest by indicating the location and extent of the regions of interest with respect to the reference points.

43. The method of claim 40 further comprising:
determining the area of at least one of the regions of interest; and
based on the area, storing information indicating an available area for the region of interest;
wherein the information indicating the available area is stored with the information indicating the regions of interest.

44. The method of claim 43 further comprising:
removing material from the region of interest; and
adjusting the stored available area for the region of interest to reflect material has been removed from the region of interest.

45. The method of claim 40 wherein the denoting comprises automated tracing of a perimeter physically appearing on the physical object.

46. The method of claim 40 wherein the denoting comprises tracing by an operator of a perimeter physically appearing on the physical object and depicted on the image.

47. The method of claim 40 further comprising:
collecting information indicating a scale of the reference points; and
based on the information indicating scale, calculating a size of the region of interest.

48. The method of claim 40 wherein
identifiers are assigned to the reference points; and
the reference points are placed at locations on the physical object whereby the assigned identifier can be determined based on the location of the reference points with respect to features of the object.

49. The method of claim 40 wherein the information indicating the region of interest is in a format independent of whether the object is rotated.

50. The method of claim 40 wherein placement of the reference points permits determining the orientation of the physical object based on the location of the reference points, even if the physical object has been rotated or inverted.

51. The method of claim 40 further comprising:
after storing the information, presenting a user interface by which an operator can adjust location and extent of the region of interest.

52. The method of claim 40 wherein the information indicating the region of interest comprises information sufficient to choose between ambiguous results for the region of interest if one of the reference points cannot be located.

53. The method of claim 52 wherein
the information indicating the region of interest specifies a set of points forming a perimeter of the region of interest; and
the information indicating the region of interest further specifies whether the points are below or above a line connecting sets of two of the reference points.

54. The method of claim 40 wherein the information indicating the region of interest indicates a perimeter of the region of interest by designating a set of points, the points designated by specifying distances between the points and the reference points.

55. The method of claim 40 wherein the physical object is a tissue block.

56. A computer-implemented method of translocating tissue from a donor tissue block to a recipient block, the method comprising:
capturing a first image of a slice taken from the donor tissue block;
based on the first image, storing information indicative of a region of interest for the donor tissue block;
capturing an image of the donor tissue block;
based on the second image and the information indicative of a region of interest, regenerating the region of interest for the donor tissue block; and
via automated means, directing a tissue punch to a location appropriate for punching tissue from the region of interest of the donor tissue block;
with the tissue punch, punching tissue from the region of interest of the donor tissue block;
via automated means, directing the tissue punch to a location appropriate for depositing the tissue into the recipient block; and
with the tissue punch, depositing the tissue from the region of interest of the donor tissue block into the recipient block.

57. A computer-readable medium comprising a data structure indicating a region of interest on a physical object comprising biological material, the data structure comprising:
information indicating locations of a plurality of reference points on the physical object comprising biological material; and
information indicating a location and extent of a region of interest with respect to the reference points;
whereby the data structure, when processed by an automated system, causes regeneration of the region of interest.

58. The computer-readable medium of claim 57 wherein the location of the region of interest with respect to the reference points is indicated by specifying points on a border of the region of interest according to their distances from the reference points.

59. The computer-readable medium of claim 58 further comprising:
information to differentiate between plural possible locations of a point on the border when the distances from the reference points are ambiguous.

60. A computer-implemented method for processing a plurality of tissue types, the method comprising:
for a plurality of donor tissue blocks, denoting regions of interest on captured images of the donor tissue blocks, wherein the regions of interest comprise tissue of interest of a particular tissue type;
submitting a list of a subset of the regions of interest to an automated arrayer, wherein the list represents a plurality of tissue types; and
with the automated arrayer, based on the list, extracting tissue from the regions of interest and collecting them into a recipient tissue block to produce a recipient tissue block having each tissue type represented on the list.

61. The method of claim 60 wherein software chooses a location within the region of interest from which tissue is to be extracted.

62. The method of claim 60 further comprising:
generating the list by querying a database for regions of interest having characteristics satisfying specified criteria.

63. The method of claim 62 wherein the criteria include a requirement that at least a certain amount of tissue is available.

64. The method of claim 62 wherein the criteria include a requirement that the region of interest be at least a certain distance from a specified feature.

65. An automated tissue microarray construction system comprising:
an image capturing device operable to capture an image;
an automated tissue block retriever operable to retrieve one of a plurality of tissue blocks; and
a computer system operable to receive a captured image from the image capturing device;
wherein the computer system is further operable to accept a list of regions of interest from which material is to be extracted, retrieve the tissue blocks corresponding to the regions of interest, capture images of the retrieved blocks, and based on the images, extract tissue from the regions of interest appearing on the list.

66. The system of claim 65 wherein the computer system comprises a database storing information indicating information for the blocks, the regions of interest, and relationships between the blocks and the regions of interest.

67. An automated tissue microarray construction system comprising:
automated means for accepting designation of one or more regions of interest for a plurality of donor objects comprising tissue to be arrayed on one or more recipient objects; and
automated means for retrieving tissue from within the regions of interest of a plurality of donor objects and placing the tissue within one of the recipient objects.

68. The automated tissue microarray construction system of claim 67 further comprising:
storage means for tracking an amount of tissue available within the regions of interest for the plurality of donor objects.

69. (New) A computer-readable medium comprising computer-executable instructions for performing the method of claim 4.

70. (New) A computer-readable medium comprising computer-executable instructions for performing the method of claim 19.

71. (New) A computer-readable medium comprising computer-executable instructions for performing the method of claim 20.

72. (New) The computer-readable medium of claim 28 wherein performing an operation comprises sending directives to an automated positioning device.
